(19) United States
(12) Patent Application Publication
(10) Pub. No.: US 2012/0269051 A1
(43) Pub. Date: Oct. 25, 2012

(54) Objective Lens for Optical Pickup Device and Optical Pickup Device

(76) Inventors: Tohru Kimura, Hachioji-shi (JP); Yuki Ono, Hachioji-shi (JP)

(21) Appl. No.: 13/512,273

(22) PCT Filed: Nov. 18, 2010
(86) PCT No.: PCT/JP2010/070552

§ 371 Date: May 25, 2012

(30) Foreign Application Priority Data
Nov. 30, 2009 (JP) 2009-272538

(51) Int. Cl. G11B 7/1374

(52) U.S. Cl. 369/112.23; G9B/7.121

(57) ABSTRACT

Disclosed are an objective lens for optical pickup device and an optical pickup device that are capable of recording/reproducing information for an optical disc having multilayered information recording surfaces with achieving compactness and reduced cost. In the objective lens and the optical pickup device, under the assumption that T_{MAX} (mm) is a maximum transparent substrate thickness among transparent substrate thicknesses of the optical disc, magnification M under the condition that the spherical aberration (λrms) is minimized at transparent substrate thickness T (mm) satisfying the following expression (1), satisfies the following expression (2), and an offense against the sine condition has a positive maximum value in an area between 70 percent and 90 percent of the radius of the effective aperture at the magnification M: T_{MAX}×0.85≦T≦T_{MAX}×1.1 (1), −0.003≦M≦0.003 (2).

### TECHNICAL FIELD

The present invention relates to and objective lens for an optical pickup device and an optical pickup device which are capable of recording and/or reproducing information for an optical disc having three or more information recording surfaces arranged in the thickness direction.

### BACKGROUND ART

There are known high-density optical disc systems recording and/or reproducing (hereinafter, “recording and/or reproducing” will be represented as “recoding/reproducing”) information by using a blue-violet semiconductor laser of wavelength of about 400 nm. For an example, as for an optical disc on which information is recorded/reproduced according to the specifications of a NA of 0.85 and a light-source wavelength of 405 nm, namely a Blu-ray Disc (hereinafter, represented as BD), information of about 25 GB per layer can be recorded in an optical disc with a diameter of 12 cm which is the same size as a DVD (NA: 0.6, light-source wavelength: 650 nm, storage capacity: 4.7 GB).

Many of conventional BDs include one or two layered information recording surfaces. For responding to the market's needs, a study aiming to put BDs with three or more layered information recording surface also to practical use, are being advanced. However, the NA of a light flux when information is recorded/reproduced is as large as 0.85, thereby, trying to add the minimum spherical aberration to one information recording surface in a BD having plural information recording surfaces, causes a problem that spherical aberration increases for other information recording surfaces with different transparent-substrate thickness and information recording/reproducing is hardly conducted properly. Such the problem in spherical aberration is more actualized as the number of information recording surfaces becomes greater (in other words, as a distance between the information recording surface at minimum distance from the top surface and the information recording surface at maximum distance flour the top surface becomes larger).

To solve that, Patent Literature 1 discloses an optical pickup device wherein a coupling lens arranged at a position between a light source and an objective lens is moved along the optical axis direction to change the magnification of the objective lens, which enables to converge a light flux with reduced third-order spherical aberration onto a selected information recording surface. Patent Literature 2 discloses a plastic objective lens for BDs including two-layered information recording surfaces. In the present specification, an operation to change in an information recording surface on which information is to be recorded/reproduced changes from one information recording surface to another information recording surface, is sometimes called as “focus jump”.

### CITATION LIST

### Patent Literature

Patent Literature 1: JP-B No. 4144763

Patent Literature 2: JP-A No. 2009-211775

### SUMMARY OF INVENTION

### Technical Problem

However, in order to record/reproduce information in an optical disc having, for example, three or more layered information recording surfaces with the optical pickup device described in the above Patent Literature 1, long movement distance of a coupling lens is required when any one of information recording surfaces is selected. When the movement distance of the coupling lens becomes long, the optical path length from the light source to the objective lens also becomes long, which causes, for example, a problem that the optical pickup device is hardly downsized. Further, it requires a large actuator for driving the coupling lens, and the cost is increased, which is another problem. Especially, a thin optical pickup device for which downsizing is demanded has a restriction that the optical path length from the light source to the objective lens is not allowed to be enlarged, which actualizes the problem that BDs having three or more layered information recording surfaces are hardly handled.

Generally, in an optical pickup device, when information is recorded/reproduced for an optical disc, coma is generated by tilting the objective lens along a radial direction or a tangential direction of the optical disc (which is called as lens tilt in the present specification). By using this type of the coma, coma generated due to a warp or tilt of the optical disc (which is called as disc tilt in the present specification) can be cancelled out. Therefore, when the amount of coma generated due to the lens tilt is small, the amount of lens tilt required for correcting coma generated clue to the disc tilt becomes great, which requires securing a sufficient amount of dynamic range of the amount of lens tilt and causes problems that the size of the optical pickup device becomes large and that electricity consumption of the actuator increases. However, in an optical pickup device for BDs, when information is recorded/reproduced for information recording surface L0 at thicker transparent substrate thickness (100 μm), the coupling lens is moved along the optical axis to make a divergent light flux enter into the objective lens. Therefore, the amount of coma decreases in comparison with the condition that a parallel light flux enters the objective lens. Further, when it is tried to achieve a high NA in an objective lens made of a plastic material, spherical aberration in a beam spot is significantly generated due to a temperature change (which is called as temperature aberration in the present invention). For example, the amount of spherical aberration change in an objective lens formed of a plastic material with a focal length of 1.41 mm at a temperature change of 30° C. is about 100 mλ rms, which exceeds the Marechial criterion of 70 mλ rms. In a lens for conventional DVDs, because its NA is about 0.60 to 0.67, the amount of spherical aberration change corning from a temperature change is relatively small and it is not needed to correct the spherical aberration. In an objective lens for BDs, the amount of spherical aberration change coming from a temperature change is great, because spherical aberration is proportional to the fourth power of its NA. Therefore, in an optical pickup device for BDs equipped with an objective lens made of a plastic material, temperature aberration is required to be corrected by movement of the coupling lens in the optical axis direction. From the above matters, in an optical pickup device for BDs, when the environmental temperature goes up while information is recorded/reproduced for information recording surface L0 with an objective lens formed of a plastic material, the degree of divergence of an incident light to the objective lens becomes furthermore great. Therefore, the amount of coma coming from lens tilt becomes furthermore small and coma coming from disc tilt is hardly corrected in an excellent condition.

As for the problem, Patent Literature 2 discloses an objective lens formed of a plastic material for BDs, having two-layer information recording surfaces. In this objective lens, with consideration that an environmental temperature can go up (to 55 degrees) when information is recorded/reproduced for information recording surface L0 at the thicker transparent substrate thickness (100 μm), the thickness of a cover glass on which spherical aberration is corrected to be zero is increased to be thicker than L0 and the magnification (design magnification) at the situation is set to be negative (incident light is divergent) in order that the ratio of the sensitivity of lens tilt to the sensitivity of disc tilt is not to be excessively small. Further, the sine condition at the design magnification is corrected within the whole area of the effective radius. Herein, when it is considered that the objective lens of Patent Literature 2 is applied to an optical pickup device for BDs having three or more layer information recording surfaces, the following problems can be caused.

(1) When the objective lens of Patent Literature 2 is used, it makes a trend that residual high-order spherical aberration becomes great when a focus jump occurs, because the sine condition at the design magnification is corrected over the whole area within the effective radius. In other words, since the ratio “the third-order spherical aberration”:“the fifth-order spherical aberration” caused when the magnification changes grows widely different from the ratio “the third-order spherical aberration”:“the fifth-order spherical aberration” (about 5:1) caused when a cover glass thickness changes. Therefore, the objective lens of Patent Literature 2 is not suitable for converging light on an information recording surface of a three-or-more-layered BD, because the maximum difference of the transparent substrate thicknesses of the three-or-more-layered BD is greater than that of a two-layered BD.
(2) Since the change amount of third-order spherical aberration generated when the magnification changes is small, a great movement amount of the coupling lens is required when a focus jump occurs in the objective lens of Patent Literature 2. Therefore, this type of objective lens is not suitable for a thin optical pickup device.

The present invention has been achieved in view of the above problems, and is aimed to provide an objective lens for an optical pickup device and an optical pickup device, which are capable of reducing the movement amount of the coupling lens without high-order spherical aberration such as fifth-order spherical aberration being remained even when the focus jump occurs, and of recording/reproducing information of an optical disc having multilayered information recording surfaces with achieving compactness and reduced cost.

In the present specification, “transparent substrate thickness” represents a distance from a light-entering surface of an optical disc to an information recording surface. In an optical disc having plural information recording surfaces arranged in the thickness direction, a transparent substrate thickness of each information recording surface is different from others.

Generally, in an objective lens for an optical pickup device, the condition of spherical aberration correction is determined such that spherical aberration (λrms) is minimized in combination with a transparent substrate of a predetermined thickness. In the present specification, the transparent substrate of the predetermined thickness is called as a cover glass, and the predetermined thickness of the transparent substrate is called as cover-glass thickness or design cover-glass thickness. There can be a situation that the cover-glass thickness in a designing step is same as the transparent substrate thickness of any one of information recording surfaces of the optical disc and a situation that the cover-glass thickness in a designing step is different from the thicknesses of information recording surfaces of the optical disc. Since the property of the objective lens changes corresponding to a change of the cover glass thickness, the property of an objective lens for an optical pickup device is required to be discussed in combination with the consideration of the cover glass thickness.

Therefore, in the present specification, the word “cover glass” is used when the property of the objective lens is described, to be distinguished from a “transparent substrate” of an optical disc. Herein, the word “cover glass” is used, but the cover-glass thickness can be used not only for glass but also for resin.

### Solution to Problem

The above objects are achieved by the following structures.

The objective lens descried in claim 1 is an objective lens for an optical pickup device including a light source for emitting a light flux with a wavelength λ1 (390 nm<λ1<415 nm) and an objective lens. The optical pickup device records and/or reproduces information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other. The objective lens is characterized by being a single lens, having a numerical aperture (NA) at an image side which is 0.8 or more and is 0.95 or less, and being formed of a plastic material, wherein a magnification M which is a magnification under a condition that a spherical aberration (λrms) is minimized at a normal temperature (25±3 C.°) and at a cover glass thickness T (mm) satisfying the expression (1), satisfies the expression (2), where T_{MAX} (mm) is a maximum transparent substrate thickness among the transparent substrate thicknesses:

T_{MAX}×0.85≦T≦T_{MAX}×1.1 (1),

−0.003≦M≦0.003 (2),

wherein, at the magnification M, an offence against a sine condition has a positive maximum value at a position in an area between 70% and 90% of a radius of an effective aperture.

At least the following three matters are properties required for an objective lens suitable for BDs having three or more layered information recording surfaces.

### (Property 1)

Residual high-order spherical aberration caused under the condition of the focus jump is small.

### (Property 2)

Movement amount of the coupling lens under the condition of the focus jump is small.

### (Property 3)

Tilt sensitivity of the objective lens under the condition that information is recorded/reproduced for an information recording surface with a thicker transparent substrate thickness does not become excessively small. Especially when an objective lens made of a plastic material is used, it is required that the lens-tilt sensitivity under the condition that the environmental temperature goes up during recording/reproducing information for an information recording surface with a thicker transparent substrate thickness, is not excessively small.

The inventors of the present invention have found, as a result of earnest study, an objective lens which is suitable for BDs having three or more layered information recording surfaces (hereinafter, represented as three or more layered BDs) and has all the properties of the above (Property 1) through (Property 3) at a level fit for practical use.

### (Property 1)

The inventors of the present invention have studied whether the problem of the prior arts can be solved by intentionally worsening the sine condition apart form the conventional common practice that the sine condition should be satisfied in designs of objective lenses. However, it has found that, as disclosed in Patent Literature 2, under the condition that the design magnification is set to negative (incident light is divergent) and the condition of coma correction is set to satisfy the sine condition at the design magnification over the whole area within the effective radius, the residual high-order spherical aberration becomes excessively large when the focus jumps, and the ratio “the third-order spherical aberration”:“the fifth order spherical aberration” under the magnification change grows widely different from the ratio “the third-order spherical aberration”:“the fifth order spherical aberration” under the change of cover-glass thickness (about the ratio 5:1). According to the knowledge, the present inventors have found that the high-order spherical aberration caused when the focus jumps can be controlled effectively by setting the offence against the sine condition to have a maximum positive value in an area between 70% and 90% of the effective radius, at the above magnification M satisfying the expression (2).

### (Property 2)

In order to reduce the amount of the coupling lens movement when the focus jumps, it is required that the amount of spherical aberration change corresponding to the magnification change makes large. The inventors of the present invention, as the result of their study, have found that not only the high-order spherical aberration caused when the focus jumps, but also the change amount of the third-order spherical aberration corresponding to the magnification change can be controlled effectively by setting the offence against the sine condition to have a maximum positive value in an area between 70% and 90% of the effective radius, at the above magnification M satisfying the expression (2).

### (Property 3)

Further, the present inventors have studied the target value to be satisfied by an objective lens formed of a plastic material for three or more layered BDs, relating to the coma generated under the condition of lens tilt. Currently, there is provided an optical pickup apparatus equipped with an objective lens formed of a plastic material, for recording/reproducing information for two-layered BDs, and such the objective lens is designed to have the minimum amount of spherical aberration at the combination of the cover glass thickness of 87.5 μm which is between the information recording surface L0 at the thicker transparent substrate thickness (100 μm) and the information recording surface L1 at the thinner transparent substrate thickness (75 μm) and the magnification of zero (corresponding to the condition that a parallel light flux enters therein). In the plastic objective lens designed as the above, the amount of coma generated in lens tilt is minimized under the condition that the environment temperature becomes high temperature during information is recorded/reproduced for information recording surface L0. In this condition, the amount of third-order coma coming from tilting lens (lens tilt) is defined as CM (LT). Inversely, it can be described that an objective lens formed of a plastic material for three-or-more layered BDs is fit for practical use if the objective lens is designed such that the minimum value of the amount of coma generated in lens tilt is greater than value of CM (LT). As it will be described later as a comparative example, when information is recorded/reproduced for information recording surface L0, the generation amount of coma CM (LT) of the objective lens formed of a plastic material for two-layered information recording surfaces under the condition that the lens is tilted at 0.5 degrees at a high temperature (55 degrees) is about 0.02 rms. The ratio of third-order coma CM (DT) and the value of CM (LT) generated when the objective lens is tilted at the same degree under the same condition is about 0.36. The inventors of the present invention have studied, with considering those values as target values, an objective lens formed of a plastic material suitable for three-or-more-layered BDs. As the result, the inventors have found that the target value of CM (LT) is satisfied by setting the condition of spherical aberration correction such that cover glass thickness T under the condition that the spherical aberration is minimized is the lower limit of the expression (1) or more, at the normal temperature (25±3° C.) and the magnification satisfying the expression (2). The value of CM (LT) can be more increased as the cover glass thickness T is thicker. However, when cover glass thickness T exceeds the upper limit of the expression (1), the convergent degree of a light flux entering the objective lens when information is recorder/reproduced for the information recording surface with the thinnest transparent substrate, becomes excessively great. It causes problems that the lens shift property (which represents the generation amount of aberration when the objective lens performs a tracking operation in the optical pickup device) is greatly deteriorated and that residual high-order spherical aberration when the focus jumps to the information recording surface with the thinnest transparent substrate becomes great, which is not preferable.

As described above, the objective lens described in claim 1 includes all the following properties at a level fit for practical use: (Property 1) the residual high-order spherical aberration when the focus jumps is small, (Property 2) the movement amount of the coupling lens when the focus jumps is small, and (Property 3) though objective lens is made of a plastic material, the sensitivity of lens tilt is not excessively small even when the environmental temperature becomes high temperature during recording/reproducing information for the information recording surface with a thicker transparent substrate. Therefore, by using the objective lens of the present invention, there can be provided an optical pickup device for an optical disc having three or more information recording surfaces, wherein the optical pickup device is reduced in size and cost and advantageous in recording/reproducing properties.

The objective lens described in claim 2 is an objective lens of claim 1, characterized in that the cover glass thickness T (mm) satisfies the following conditional expression (3):

T_{MAX}×0.85≦T≦T_{MAX}×1.0 (3).

By avoiding thickness T of the cover glass on which spherical aberration is corrected to be zero from making greater than T_{MAX}, the convergent degree of a light flux entering the objective lens when information is recorded/reproduced for the information recording surface with a thinner transparent substrate can be avoided from being large. Therefore, when information is recorded/reproduced for the information recording surface with the thinner transparent substrate, an increase of coma generated when the objective lens is shifted can be further more avoided. In three-or-more-layer BDs wherein the maximum difference in transparent substrate thickness is larger than that of two-layer BDs, the divergent degree of a light flux entering the objective lens when information is recorded/reproduced for the information recording surface with the thinnest transparent substrate becomes excessively great and the lens shift property is easily deteriorated. Therefore, the invention relating to the present claim can solve such the great problem which is characteristic of three-or-more layer BDs. In other words, the condition that cover glass thickness T satisfies the upper limit of the expression (3) more preferably restricts that the convergent degree of a light flux entering the objective lens when information is recorder/reproduced for the information recording surface with the thinnest transparent substrate becomes excessively large. As the result, the lens-shift property is furthermore enhanced and the residual high-order spherical aberration caused when the focus jumps to the information recording surface corresponding to the thinnest transparent substrate can be furthermore reduced, which is preferable. Thereby, the objective lens can exhibit more excellent effect in comparison with Examples of Patent Literature 2.

The objective lens describer in claim 3 is an objective lens for an optical pickup device including a light source for emitting a light flux with a wavelength λ1 (390 nm<λ1<415 nm) and an objective lens. The optical pickup device records and/or reproduces information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other. The objective lens is characterized by being a single lens, having a numerical aperture (NA) at an image side which is 0.8 or more and is 0.95 or less, and being formed of a glass material, wherein a magnification M which is a magnification under a condition that a spherical aberration (λrms) is minimized at a normal temperature (25±3 C.°) and at a cover glass thickness T (mm) satisfying the expression (4), satisfies the expression (2), where T_{MAX} (mm) is a maximum transparent substrate thickness among the transparent substrate thicknesses:

T_{MAX}×0.75≦T≦T_{MAX}×1.0 (4),

−0.003≦M≦0.003 (2),

wherein, at the magnification M, an offence against a sine condition has a positive maximum value at a position in an area between 70% and 90% of a radius of an effective aperture.

As described above, the present inventors have found that the high-order spherical aberration caused when the focus jumps can be controlled effectively by setting the offence against the sine condition a maximum positive value in an area between 70% and 90% of the effective radius, at the above magnification M satisfying the expression (2).

Further, as described above, the inventors of the present invention, as the result of their study, have found that not only the high-order spherical aberration caused when the focus jumps, but also the change amount of the third-order spherical aberration corresponding to the magnification change can be controlled effectively by setting the offence against the sine condition a maximum positive value in an area between 70% and 90% of the effective radius, at the above magnification M satisfying the expression (2).

Further, the present inventors have studied the target value to be satisfied by an objective lens formed of a glass material for three or more layered BDs, relating to the coma generated under the condition of lens tilt. In an objective lens formed of glass, the effect of temperature change can be ignored. Therefore, the degree of divergence of light entering the objective lens does not become excessively large in comparison with a case using an objective lens formed of plastic. The inventors have found that a cover-glass thickness under the condition that spherical aberration (λrms) is minimized at a normal temperature (25±3 C.°) at the magnification satisfying the expression (2) becomes thinner. As the result, the inventors have found that by setting the condition of correcting spherical aberration so as to be the lower limit of the expression (4) or more, the target value of the generation amount of third-order coma coming from lens tilt CN(LT) can be satisfied. Further, when cover-glass thickness T is set not to exceeds the upper limit of the expression (4), it can restrict that the degree of convergent of light entering the objective lens when information is recorded/reproduced on the information recording surface at the thinnest transparent substrate thickness becomes excessively large, and avoid the situation that lens-shift property is deteriorated and a residual high-order spherical aberration caused when the focus jumps to the information recording surface at the thinnest transparent substrate becomes large.

As described above, the objective lens described in claim 3 includes all the following properties at a level fit for practical use: (Property 1) the residual high-order spherical aberration when the focus jumps is small, (Property 2) the movement amount of the coupling lens when the focus jumps is small, and (Property 3) the sensitivity of lens shift is not excessively small and the lens-shift property can be preferably secured even when the environmental temperature becomes high temperature during recording/reproducing information for the information recording surface at a thicker transparent substrate thickness in a objective lens made of a glass material. Therefore, by using the objective lens of the present invention, there can be provided an optical pickup device for an optical disc having three or more information recording surfaces, wherein the optical pickup device is reduced in size and cost and advantageous in recording/reproducing properties.

The objective lens described in claim 4 is an objective lens of claim 3, characterized in that the cover glass thickness T (mm) satisfies the following expression (5):

T_{MAX}×0.8≦T≦T_{MAX}×0.95 (5).

The condition that the objective lens satisfies the expression (5) enhances the lens-shift property more excellently and can reduce the residual high-order spherical aberration caused when the focus jumps to the information recording surface at the thinnest transparent substrate.

The objective lens described in claim 5 is an objective lens for an optical pickup device including a light source for emitting a light flux with a wavelength λ1(390 nm<λ1<415 nm) and an objective lens. The optical pickup device records and/or reproduces information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other. The objective lens is characterized by being a single lens, having a numerical aperture (NA) at an image side which is 0.8 or more and is 0.95 or less, wherein a value of ΔSA3/(ΔM×(λrms/mm) which is a change rate of a third-order spherical aberration to a product of a focal length f of the objective lens and a magnification change ΔM at normal temperature (25±3 C.°) and at a transparent substrate thickness T, satisfies the expression (6), where T (mm) is a cover glass thickness under a condition that a spherical aberration (λrms) is minimized at a normal temperature (25±3 C.°) and at a magnification M satisfying the expression (2), and f (mm) is a focal length for the wavelength λ1 at the normal temperature (25±3 C.°):

−0.003≦M≦0.003 (2),

21≦|ΔSA3/(ΔM×f)|<25 (6).

The invention described in claim 5 is provided by establishing a condition for achieving both of a reduction of the residual high-order spherical aberration when the focus jumps and a reduction of the movement amount of the coupling lens, from a different point of view. When the value of the expression (6) exceeds the lower limit, the change amount of the third-order spherical aberration corresponding to the magnification change becomes sufficiently great and the movement amount of the coupling lens can be reduced. Further, when the value of the expression (6) becomes below the upper limit, the change amount of the third-order spherical aberration to the magnification change is prevented from being excessively large, thereby, the high-order spherical aberration generated when the focus jumps can be prevented from being over-corrected. In other words, satisfying the expression (6) enables to achieve both of reducing the residual high-order spherical aberration when the focus jumps and reducing the movement amount of the coupling lens.

The invention descried in claim 6 is an objective lens for an optical pickup device including a light source for emitting a light flux with a wavelength λ1 (390 nm<λ1<415 nm) and an objective lens. The optical pickup device records and/or reproduces information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other. The objective lens is characterized by being a single lens, having a numerical aperture at an image side (NA) which is 0.8 or more and is 0.95 or less, wherein a third-order spherical aberration ΔSA3 and a fifth-order spherical aberration ΔSA5 which are generated when a magnification of the objective lens is changed at a normal temperature (25±3 C.°) and at a cover glass thickness T, satisfy the expression (7), where T (mm) is a cover glass thickness under a condition that a spherical aberration (λrms) is minimized at the normal temperature (25±3 C.°) and at a magnification M satisfying the expression (2):

−0.003≦M≦0.003 (2),

4.2≦ΔSA3/ΔSA5<5.2 (7).

The invention described in claim 6 is provided by establishing a condition for achieving both of a reduction of the residual high-order spherical aberration when the focus jumps and a reduction of the movement amount of the coupling lens, from a different point of view. When the value of the expression (7) exceeds the lower limit, the ratio of the change amount of the third-order spherical aberration and the fifth-order spherical aberration when the magnification changes is avoided from being excessively small, the high-order spherical aberration generated when the focus jumps is prevented from being over-corrected, and the residual high-order spherical aberration can be reduced. Further, when the value of the expression (7) becomes below the upper limit, the ratio of the change amount of the third-order spherical aberration and the fifth-order spherical aberration when the magnification changes is prevented from being excessively large, the change amount of the third-order spherical aberration corresponding to the magnification change does not become excessively small, the movement amount of the coupling lens can be reduced, and the high-order spherical aberration generated when the focus jumps is prevented from being under-corrected. In other words, satisfying the expression (7) enables to achieve both of reducing the residual high-order spherical aberration when the focus jumps and reducing the movement amount of the coupling lens.

The objective lens described in claim 7 is an objective lens of any one of claims 1 to 6, characterized in that, at the magnification M, an offence against a sine condition has a positive maximum value at a position in an area between 70% and 90% of a radius of an effective aperture, and does not have a negative maximum value within the radius of the effective aperture.

By employing such the structure, the following matters are realized: (Property 1) the residual high-order spherical aberration when the focus jumps is small, (Property 2) the movement amount of the coupling lens when the focus jumps is small, and (Property 3) the deterioration of the sensitivity of lens tilt can be restricted even when the environmental temperature becomes high temperature during recording/reproducing information for the information recording surface at a thicker transparent substrate thickness.

The objective lens described in claim 8 is an objective lens of any one of claims 1 to 6, characterized in that, at the magnification M, an offence against a sine condition which has a positive maximum value at a position in an area between 70% and 90% of a radius of an effective aperture, and has a negative maximum value at a position closer to an optical axis than the position of the positive maximum value.

By employing such the structure, the following matters are realized: (Property 1) the residual high-order spherical aberration when the focus jumps is small, (Property 2) the movement amount of the coupling lens when the focus jumps is small, and (Property 3) the deterioration of the sensitivity of lens tilt can be restricted even when the environmental temperature becomes high temperature during recording/reproducing information for the information recording surface at a thicker transparent substrate thickness. Additionally, the following matters are also realized: (Property 4) the amount of aberration generated when two optical surfaces facing each other is shifted in the direction perpendicular to the optical axis because of a manufacturing error, and (Property 5) the amount of aberration generated when two optical surfaces facing each other is shifted in the direction of the optical axis because of a manufacturing error. Thereby, there can be provided an objective lens which is more easily manufactured.

The objective lens described in claim 9 is an objective lens of any one of clans 1 to 8, characterized in that a fifth-order coma CMS (λrms) which is generated when an oblique light flux whose half angle of view is 1 degree enters the objective lens at a normal temperature (25±3 C.°), the cover glass thickness T and the magnification M, satisfies the expression (8):

0.02<|CM5|<0.05 (8).

The objective lens described in claim 10 is an objective lens of claim 9, characterized in that a third-order coma CM3 (λrms) which is generated when an oblique light flux whose half angle of view is 1 degree enters the objective lens at a normal temperature (25±3 C.°), the cover glass thickness T and the magnification M satisfies the expression (9):

0≦|CM3|<0.02 (9).

The objective lens described in claim 11 is an objective lens for an optical pickup device including a light source for emitting a light flux with a wavelength λ1 (390 nm<λ1<415 nm) and an objective lens. The optical pickup device records and/or reproduces information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other. The objective lens is characterized by being a single lens, having a numerical aperture at an image side (NA) which is 0.8 or more and is 0.95 or less, wherein a fifth-order coma CM5 (λrms) which is generated when an oblique light flux whose half angle of view is 1 degree enters the objective lens at a normal temperature (25±3 C.°), a cover glass thickness T and a magnification M satisfying the expression (2), satisfies the expression (8), where T (mm) is a cover glass thickness under a condition that a spherical aberration (λrms) is minimized at the normal temperature (25±3 C.°) and at the magnification M satisfying the expression (2):

−0.003≦M≦0.003 (2),

0.02<|CM5|<0.05 (8).

The invention described in claim 11 is provided by establishing a condition for achieving both of a reduction of the residual high-order spherical aberration when the focus jumps and a reduction of the movement amount of the coupling lens, from a different point of view. Satisfying the expression (8) at the magnification M satisfying the expression (2), enables to achieve both of reducing the residual high-order spherical aberration when the focus jumps and reducing the movement amount of the coupling lens.

The objective lens described in claim 12 is an objective lens of claim 11, characterized in that a third-order coma CM3 (λrms) which is generated when an oblique light flux whose half angle of view is 1 degree enters the objective lens at the normal temperature (25±3 C.°), the cover glass thickness T and the magnification M, satisfies the expression (9):

0≦|CM3|<0.02 (9).

The invention described in claim 12 prevents the lens-tilt sensitivity from being excessively small even when information is recorded/reproduced for the information recording surface of the thicker transparent substrate. Further, when the objective lens is made of plastic, it prevents the lens-tilt sensitivity from being excessively small under the condition that information is recorded/reproduced for the information recording surface of the thicker transparent substrate, which is preferable.

The objective lens described in claim 13 is an objective lens of any one of claims 5 to 12, characterized in that the objective lens is formed of a plastic material.

The objective lens described in claim 14 is an objective lens of claim 13, characterized in that, the cover glass thickness T satisfies the expression (1), where T_{MAX} (mm) is a maximum transparent substrate thickness among the transparent substrate thicknesses.

T_{MAX}×0.85≦T≦T_{MAX}×1.1 (1)

The objective lens described in claim 15 is an objective lens of claim 14, characterized in that the cover glass thickness T and the magnification M satisfy the expression (3) and the expression (10):

T_{MAX}×0.85<T≦T_{MAX}×1.0 (3),

M=0 (10).

The objective lens described in claim 16 is an objective lens of any one of claims 5 to 12, characterized in that the objective lens is formed of a glass material.

By forming the objective lens out of a glass material, the movement amount of the coupling lens when the temperature changes can be reduced. Therefore, the movement amount of the coupling lens can be reduced to be small. Further, (Property 3) the sensitivity of lens tilt is not excessively small even when the temperature goes up during recording/reproducing information for the information recording surface corresponding to thicker transparent substrate, which is preferable. Most of optical pickup devices capable of not only reproducing information for BDs but also recording information for BDs use laser light sources with high output power because of their strong demand on achieving higher speed. Because a glass material has high durability for the blue-violet wavelength, it is preferable used for an objective lens for an optical pickup device.

The objective lens described in claim 17 is an objective lens of claim 16, characterized in that the cover glass thickness T satisfies the expression (4), where T_{MAX} (mm) is a maximum transparent substrate thickness among the transparent substrate thicknesses:

T_{MAX}×0.75≦T≦T_{MAX}×1.0 (4).

The objective lens described in claim 18 is an objective lens of claim 17, characterized in that the cover glass thickness T and the magnification M satisfy the expression (5) and the expression (10):

T_{MAX}×0.8≦T≦T_{MAX}×0.95 (5),

M=0 (10).

The objective lens described in claim 19 is an objective lens of any one of claims 1 to 18, characterized in that the objective lens satisfies the expression (11), where OSC_{MAX} (mm) is the positive maximum value of the offence against the sine condition, and f(mm) is a focal length for the wavelength λ1 at the normal temperature (25±3C.°):

0.003<OSC_{MAX}/f<0.022 (11).

The objective lens described in claim 20 is an objective lens of any one of claims 1 to 3, 5 to 17, and 19 characterized in that, under a condition that a non-parallel light flux enters the objective lens such that a third-order spherical aberration of a spot converged by the objective lens is corrected at a high temperature (55±3C.°) and at a cover glass thickness which is equal to the maximum transparent substrate thickness T_{MAX}, a third-order coma CM(LT) (λrms) which is generated when the objective lens is tilted and a third-order coma CM (DT) (λrms) which is generated when a cover glass is tilted at the same angle as that of the objective lens for the third-order coma CM(LT) satisfy the expression (12):

0.3≦|CM(LT)/CM(DT)|≦0.8 (12).

The invention described in claim 20 prevents the lens-tilt sensitivity from being excessively small even when information is recorded/reproduced for the information recording surface at the thicker transparent substrate thickness. Further, when the objective lens is made of plastic, it prevents the lens-tilt sensitivity from being excessively small under the condition that information is recorded/reproduced for the information recording surface at the thicker transparent substrate thickness, which is preferable.

The objective lens described in claim 21 is an objective lens of any one of claims 1 to 3, 5 to 17, 19 and 20 characterized in that a magnification M1 and a magnification M2 satisfy the expression (13), where the magnification M1 is a magnification under a condition that a non-parallel light flux enters the objective lens such that a third-order spherical aberration of a spot converged by the objective lens is corrected at the normal temperature (25±3C.°) and at a cover glass thickness which is equal to the maximum transparent substrate thickness T_{MAX}, and the magnification M2 is a magnification under a condition that a non-parallel light flux enters the objective lens such that a third-order spherical aberration of a spot converged by the objective lens is corrected at the normal temperature (25±3C.°) and at a cover glass thickness which is equal to a minimum transparent substrate thickness T_{MIN} among the transparent substrate thicknesses:

0≦M1/M2<0.92 (13).

It is preferable that the cover glass thickness T has a value closer to T_{MAX} among the values of T_{MAX} and T_{MIN}, in order to prevent the lens-tilt sensitivity from being excessively small when information is recorded/reproduced for the information recording surface at the thicker transparent substrate thickness. The preferable range established in the view point of magnification is the expression (13).

The objective lens described in claim 22 is an objective lens of any one of claims 1 to 21 characterized in that a refractive index N of the objective lens for the wavelength λ1 at the normal temperature (25±3C.°), and an inclination angle θ (degree) of at a most periphery of an effective aperture of an optical surface facing the light source satisfy the expression (14):

−59.8×N+162<θ<−59.8×N+166 (14).

The inventors of the present invention have found, as a result of earnest study, that the lens refractive indexes N and the inclination angles θ of the object-side optical surface measured at a most periphery of an effective aperture of the optical surface in the examples of the present invention fall in the predetermined condition, as shown in FIG. 39. The condition wherein the objective lens of the present invention is defined from the view point of preferable shape from this knowledge, is the expression (14).

The objective lens described in claim 23 is an objective lens of any one of claims 1 to 22 characterized in that the objective lens satisfies the expression (15), where T_{MIN} is a minimum transparent substrate thickness among the transparent substrate thicknesses and T_{MAX} is a maximum transparent substrate thickness among the transparent substrate thicknesses:

0.03 (mm)<T_{MAX}−T_{MIN}<0.06 (mm) (15).

In an optical disc having three-or-more-layered information recording surfaces and satisfying the expression (15), as described above, the following problems is easily enlarged: (Property 1) the residual high-order spherical aberration when the focus jumps becomes easily great, (Property 2) the movement amount of the coupling lens when the focus jumps becomes easily great, and (Property 3) the sensitivity of lens tilt becomes easily small when the environmental temperature becomes high temperature during recording/reproducing information for the information recording surface at a thicker transparent substrate thickness. The present invention is provided for solving such the great problems.

The objective lens described in claim 24 is an objective lens of any one of claims 1 to 23 characterized in that, the objective lens satisfies the expression (16), where N is a refractive index of the objective lens for the wavelength λ1 at the normal temperature (25±3C.°) and H (mm) is a radius height at which a first-order derivative X′(h) of a deformation amount of an aspheric surface X(h) of an optical surface facing the optical disc changes from a negative value to a positive value:

−2.8×N+5.1<H<−2.8×N+5.4 (16),

wherein the deformation amount of an aspheric surface X(h) is defined by a distance in a direction of an optical axis from a plane tangent to a top of the optical surface facing the optical disc to the aspheric surface, and is assumed to have a negative value when the aspheric surface deforms from the plane toward the light source and have a positive value when the aspheric surface deforms from the plane toward the optical disc, and H is a relative value under an assumption that a radius of an effective aperture is defined as 1.

The inventors of the present invention have found, as a result of earnest study, that the lens refractive indexes N and height H(mm) along a radius at which a first-order derivative X′(h) of a deformation amount of an aspheric surface X(h) of an optical surface thereof facing the optical disc switches from a negative value to a positive value fall in the predetermined condition, as shown in FIG. 40. In the expression (16), the objective lens of the present invention is defined from the view point of preferable shape from this knowledge.

The objective lens described in claim 25 is an optical pickup device characterize by comprising: the objective lens of any one of claims 1 to 24 and a coupling lens which is movable in an optical axis direction, wherein any one of information recording surfaces of an optical disc is selected by moving the coupling lens in the optical axis direction.

In an optical pickup device handling an optical disc having three-or-more-layered information recording surfaces, the following problems are easily enlarged: (Problem 1) the residual high-order spherical aberration when the focus jumps becomes easily great, (Problem 2) the movement amount of the coupling lens when the focus jumps becomes easily great, and (Problem 3) the sensitivity of lens tilt becomes easily small when the environmental temperature becomes high temperature during recording/reproducing information for the information recording surface at a thicker transparent substrate thickness. However, when the optical pickup device is equipped with the objective lens of the present invention and the coupling lens is moved in the optical axis direction to select any one of the information recording surfaces, the following matters are realized: (Property 1) the residual high-order spherical aberration when the focus jumps is small, (Property 2) the movement amount of the coupling lens when the focus jumps is small, and (Property 3) the sensitivity of lens tilt is not excessively small even when the environmental temperature becomes high temperature during recording/reproducing information for the information recording surface at a thicker transparent substrate thickness. Even under the condition that a plastic objective lens is used, the transparent substrate is thick, and the temperature is high, the lens-tilt sensitivity does not become excessively small. Therefore, by using the objective lens of the present invention, there can be provided an optical pickup device for an optical disc having three or more information recording surfaces, wherein the optical pickup device is reduced in size and cost and advantageous in recording/reproducing properties.

The objective lens described in claim 26 is an optical pickup device of claim 25, characterized in that the coupling lens consists of a single lens.

The objective lens described in claim 27 is an optical pickup device of claim 25, characterized in that the coupling lens has a two-group structure consisting of a positive lens group and a negative lens group, and any one of the information recording surfaces of the optical disc is selected by moving at least one lens in the positive lens group in the optical axis direction.

The present invention furthermore reduces the movement amount of the coupling lens to be small and provides an optical pickup device furthermore reduced in size.

An optical pickup device relating to the present invention includes at least one light source (a first light source). The optical pickup device may include plural types of light sources for handling plural types of optical discs. Further, the optical pickup device relating to the present invention includes a light converging optical system at least for converging the first light flux onto an information recording surface of the first optical disc. In an optical pickup device capable of handling plural types of optical discs, the light converging optical system is configured to converge the first light flux onto an information recording surface of the first optical disc, converge the second light flux onto an information recording surface of the second optical disc and converge the third light flux onto an information recording surface of the third optical disc. The optical pickup device relating to the present invention further includes a light-receiving element for receiving a reflection light flux coming from an information recording surface of the first optical disc. In an optical pickup device capable of handling plural types of optical discs, the light-receiving element may be configured to receive a reflection light flux coming from an information recording surface of the second optical disc and receive a reflection light flux coming from an information recording surface of the third optical disc. In the present specification, “the object side” represents a side of the light source and “the image side” represents a side of the optical disc.

The first optical disc includes a protective substrate with a thickness of t1 and an information recording surface. The second optical disc includes a protective substrate with a thickness of t2 (t1<t2) and an information recording surface. The third optical disc includes a protective substrate with a thickness of t3 (t2<t3) and an information recording surface. It is preferable that the first optical disc is a BD, the second optical disc is a DVD and the third optical disc is a CD. However, the first to third optical discs do not limited to those.

The first optical disc is a disc including three or more information recording surfaces which are layered in the thickness direction. In other words, the first optical disc is an optical disc including three or more information recording surfaces arranged in the thickness direction and a distance (which is represented as a “transparent substrate thickness” in the present specification) from the incident surface of the optical disc where a light flux enters to each of the information recording surfaces is different from others. The optical disc may include four or more information recording surfaces. Further, each of the second optical disc and the third optical disc may include plural information recording surfaces. Herein, the “maximum transparent substrate thickness” represents the transparent substrate thickness of the information recording surface which is most distant from the incident surface of the optical disc where a light flux enters, among the plural information recording surfaces. The “minimum transparent substrate thickness” represents the transparent substrate thickness of the information recording surface which is closest to the incident surface of the optical disc where a light flux enters, among the plural information recording surfaces.

Assuming that T_{MIN} is the minimum transparent substrate thickness among thicknesses of the plural information recording surfaces, and T_{MAX} is the maximum transparent substrate thickness among thicknesses if the plural information recording surfaces, the expression (15) is preferably satisfied.

0.03 (mm)<T_{MAX}−T_{MIN}<0.06 (mm) (15)

In an optical disc having three or more information recording surfaces and satisfying the expression (15), as described above, the following problems are easily enlarged: (Problem 1) the residual high-order spherical aberration when the focus jumps becomes easily great, (Problem 2) the movement amount of the coupling lens when the focus jumps becomes easily great, and (Problem 3) the sensitivity of lens tilt becomes easily small when the environmental temperature becomes high temperature during recording/reproducing information for the information recording surface at a thicker transparent substrate thickness. The present invention solves such the great problems.

Accordingly, the optical pickup device records and/or reproduces information by selecting any one of plural information recording surfaces of the first optical disc and by converging a light flux emitted from the light source onto the selected information recording surface with the objective lens.

In the present specification, a BD represents a generic name of optical discs in a group of BDs wherein information is recorded/reproduced by using a light flux with a wavelength in the range of about 390 nm to 415 nm and an objective lens with NA in the range of about 0.8 to about 0.9 and the thickness of the protective substrate is about 0.05 mm to 0.125 mm. The BDs involve a BD including only a single information recording surface and a BD including two information recording surfaces. Further in the present specification, a DVD represents a generic name of optical discs in a group of DVDs wherein information is recorded/reproduced by using an objective lens with NA in the range of about 0.60 to about 0.67 and the thickness of the protective substrate is about 0.6 mm. The DVDs involve DVD-ROM, DVD-Video, DVD-Audio, DVD-RAM, DVD-R, DVD-RW, DVD+R and DVD+RW. In the present specification, a CD represents a generic name of optical discs in a groups of CDs wherein information is recorded and/or reproduced by an objective lens with NA in the range of about 0.45 to 0.51 and the protective layer has the thickness about 1.2 mm. The CDs involve CD-ROM, CD-Audio, CD-Video, CD-R and CD-RW. As for a recording density, a BD has the highest recording density, and a DVD and CD have lower recording densities in this order.

Thicknesses t1, t2, and t3 of the protective substrates preferably satisfy the following conditional expressions (17), (18), and (19). However, the thicknesses are not limited to them.

0.050mm≦t1≦0.125 mm (17)

0.5mm≦t1≦0.7 (18)

1.0 mm≦t3≦1.3 mm (19)

In the present specification, each of the first light source, the second light source, and the third light source is preferably a laser light source. Lasers such as a semiconductor laser and a silicon laser are preferably used for the laser light source. The first wavelength λ1 of the first light flux emitted from the first light source, the second wavelength λ2 (λ2>λ1) of the second light flux emitted from the second light source, and the third wavelength λ3(λ3>λ2) of the third light flux emitted from the third light source preferably satisfies the following conditional expressions (20) and (21).

1.5·λ1<λ2<1.7·λ1 (20)

1.8·λ1<λ3<λ2.0·λ1 (21)

When a BD, DVD, and CD are employed as the first optical disc, the second optical disc, and the third optical disc, respectively, the wavelength λ1 of the first light source is preferably 350 nm or more, and 440 nm or less, and is more preferably 390 nm or more, and 415 nm or less; the second wavelength λ2 of the second light source is preferably 570 nm or more, and 680 nm or less, and is more preferably 630 nm or more, and 670 nm or less; and the third wavelength 73 of the third light source is preferably 750 nm or more, and 880 nm or less, and is more preferably 760 nm or more, and 820 nm or less.

Further, at least two light sources of the first light source, the second light source, and the third light source may be unitized. The unitization means fixing and housing, for example, the first light source and the second light source into one package. Further, in addition to the light sources, the light-receiving elements which will be described later may also be provided as one package.

As the light-receiving element, a photo detector such as a photo diode is preferably used. Light reflected on an information recording surface of an optical disc enters into the light-receiving element, and signal outputted from the light-receiving element is used for obtaining signal obtained by reading the information recorded in each optical disc. Further, a change in the light amount caused with a change in shape and a change in position of the spot on the light-receiving element, are detected to conduct the focus detection and the tracking detection. Based on these detections, the objective lens can be moved for focusing and tracking operations. The light-receiving element may be composed of a plurality of photo detectors. The light-receiving element may also have a main photo detector and secondary photo detector. For example, the light-receiving element is provided with a main photo detector which receives the main light used for recording and reproducing information, and two secondary photo detectors positioned on both sides of the main photo detector so as to receive secondary light for tracking adjustment by the two secondary photo detectors. Further, the light-receiving element may also comprise a plurality of light-receiving elements corresponding to respective light sources.

The light-converging optical system comprises a coupling lens and an objective lens. A coupling lens represents a lens group which is arranged between the objective lens and the light source and changes a divergent angle of a light flux. A collimation lens is a kind of coupling lens and a coupling lens which receives an incident light flux and emits a parallel light or an almost parallel light flux. A coupling lens can be composed of only a positive lens group, or can be composed of a positive lens group and a negative lens group. The positive lens group includes at least one positive lens. The positive lens may be composed of one positive lens or plural lenses. When the coupling lens includes a negative lens group, the negative lens group includes at least one negative lens. The negative lens group may be composed of only one negative lens or plural lenses. Preferable examples of coupling lenses are a coupling lens composed of only a single positive lens and a coupling lens composed of a combination of a single positive lens and a single negative lens.

In the present specification, a lens arranged in a coupling lens to be movable in the optical axis direction can be called as a “movable lens”. In the present specification, the word “a movement amount of a coupling lens” is used as the same mean to the word “a movement amount of a movable lens”.

Incidentally, when the focus jumps, it is considered to enlarge power of the lens group which is moved in the optical axis direction among the lens groups forming the coupling lens (in other words, to reduce the focal length of the lens group which is moved in the optical axis direction among the lens groups forming the coupling lens), as a method to restrict the movement amount of the coupling lens. The reason is that the movement amount of the lens group moved in the optical axis direction becomes smaller as the lens group has greater power (in other words, as the lens group has a shorted focal length). Therefore, when the coupling lens is provided as a single-lens-group structure, a reduction of the focal length of the lens group moved in the optical axis (that is, which is equals to the focal length of the coupling lens) makes a spot converged by the objective lens a oval shape, which causes a possibility to affect recording and or reproducing information for BDs. The mason will be described below.

Generally, a light flux emitted by a semiconductor laser used in an optical pickup device as a light source has an oval shape. Therefore, the distribution of light amount in the direction of the major axis of the oval is different from that in the direction of the minor axis of the oval. When the focal length of the coupling lens becomes excessively short, asymmetry of the distribution of the amount of light which is introduced in to the coupling lens becomes significant. Therefore, the spot converged by the objective lens has an oval shape, which causes a possibility to affect recording and/or reproducing information for a BD. Accordingly, when the coupling lens has a single-lens-group structure, it is difficult to achieve both of reducing the movement amount of the coupling lens which is required for the focus jump and providing asymmetry of the distribution of the amount of light which is introduced into the coupling lens.

In order to achieve both of them, it is preferable that the coupling lens is configured to have a two-lens-group structure composed of a positive lens group and a negative lens group and form a structure that at least one lens in the positive lens group us moved in the optical axis direction to select which information recording surface in the objective lens is used for converging light thereon.

To simplify the description, it is assumed that the coupling lens is a thin-lens optical system having a two-lens-group structure composed of a positive lens and a negative lens, and that the positive lens is moved in the optical axis direction when the focus jumps. The power of the whole system of the coupling lens P_{C} and the focal length fc of the whole system of the coupling lens are represented by the following expressions (22), where P_{P} is power of the positive lens, f_{P} is the focal length of the positive lens, P_{N} is power of the negative lens, f_{N} is the focal length of the negative lens, and L is a distance between the positive lens and the negative lens.

P_{C}=P_{P}+P_{N}−L·P_{P}·P_{N}

P_{C}=1/f_{C}

P_{C}=1/f_{P}+1/f_{N}−L/(f_{P}·f_{B}) (22)

The magnification M of a light-converging optical system composed of the coupling lens and the objective lens satisfy the following expression (23), where f_{O} is the focal length of the objective lens:

M=−f_{O}/f_{C}

In order to make the asymmetry of the distribution of the amount of light introduced into the coupling lens into an excellent condition and to form the shape of a spot converged by the objective lens into a circular shape, it is required that the value of magnification M of the optical system is preferably set with respect to the ellipticity of a light flux emitted from a semiconductor laser used as a light source. In an optical pickup device for BDs, the preferable value of the magnification of the optical system is about −0.1. From the view point of a space where optical elements such as a polarization beam splitter arranged between the light source and the coupling lens to be arranged, focal length f_{C} of the whole system of the coupling lens cannot be extremely reduced. Further, in order to achieve the condition that a distance between the objective lens and a BD (which is also called as “a working distance”) does not become excessively short when information is recorded and/or reproduced for a BD, and that the optical pickup device is reduced in thickness, the proper range of the focal length f_{O} of the objective lens is naturally defined. Therefore, the expression (23) shows that, as for the coupling lens for an optical pickup device for BDs, a range of the focal length of the whole system is required to be a predetermined range, and that focal length f_{C} of the whole system of the coupling lens cannot be reduced excessively under the consideration of only the movement amount of the coupling lens required when the focus jumps.

Herein, it is preferable to enlarge the power P_{P} of the positive lens in order to reduce the movement amount when the focus jumps and to enlarge the absolute value of the power P_{N} of the negative lens so as not to make the focal length f_{C} of the whole system of the coupling lens excessively short (see the expression (22)).

According to the above descriptions, in the coupling lens composed of two lens groups of a positive lens group and a negative lens group, moving the positive lens group in the optical axis direction, allows to achieve both of reducing the movement amount of the positive lens group require when the focus jumps and providing asymmetry of the distribution of the amount of light introduced into the coupling lens.

Further, as for the arrangement of the positive lens group and the negative lens group, the negative lens and the positive lens may be arranged in this order from the light-source side. Alternatively, the positive lens and the negative lens may be arranged in this order from the light-source side. The preferable arrangement is the former one.

According to the above descriptions, from the view point to reduce the movement amount of the coupling lens, the most preferable example of the coupling lens in an optical pickup device is that the coupling lens is composed of the combination of one positive lens and one negative lens, which are arranged in order of the negative lens and the positive lens from the light-source side. However, the scope of the present invention is not limited to that. From the view point to simplify the structure of the coupling lens as much as possible, there can be provided another option that the coupling lens is composed of one positive lens.

From the above reason, it is preferable that at least one lens (preferably a positive lens) in the positive lens group is movable in the optical axis direction in order to correct spherical aberration generated on the selected information recording surface of the first optical disc. For example, when information is recorded and/or reproduced on one information recording surface of the first optical disc, and then, information is recorded and/or reproduced on another information recording surface of the first optical disc, at least one lens in the positive lens group of the coupling lens groups is moved in the optical axis direction to change the divergent degree of a light flux and change the magnification of the objective lens, which corrects spherical aberration generated when the focus jumps to another information recording surface of the first optical disc.

FIG. 1 is a figure showing a result of the study carried out by the inventors. The inventors have found the following matters, based on an objective lens which is made of plastic, has a focal length f of 1.18 mm and a numerical aperture at the image side of 0.85 and includes an optical surface being an aspheric surface or a diffractive surface, as an example: maximum difference A (λrms) of spherical aberration generated when a light-convergent spot is properly formed on each of the information recording surfaces arranged at the maximum distance from each other, maximum difference B (λrms) of spherical aberration generated when the environment temperature changes by ±30C.°, and maximum difference C (λrms) of spherical aberration generated when the wavelength of the light source changes by ±5 nm, each generated on the first optical disc (BD) having plural information recording surfaces. Those are shown in FIG. 1 by bar charts. Those spherical aberrations can be corrected by moving the coupling lens in the optical axis direction to change the magnification of the objective lens. If a same coupling lens is used for the corrections, the movement amount of the coupling lens corresponds to the total sum of the spherical aberrations.

When an objective lens including two information recording surfaces is used as shown in FIGS. 1a and 1b, the total amount of spherical aberration is about 410 mλrms to 430 λrms in each of the objective lens including an optical surface being an aspheric refractive surface and the objective lens including an optical surface being a diffractive surface, which suggests that the movement amount of the coupling lens is relatively small. On the other hand, when an objective lens including four information recording surfaces is used as shown in FIG. 1c, the total amount of spherical aberration is 680 mλrms in an objective lens including an optical surface being a spherical refractive surface, which requires about 1.5 times as much the movement amount of the coupling lens as that required in the objective lens including two information recording surfaces. Further, when an objective lens including four information recording surfaces is used as shown in FIG. 1d, in the objective lens including an optical surface being a diffractive surface, the spherical aberration generated with a temperature change is reduced as an effect of the diffractive surface. However, the spherical aberration generated with a wavelength change increases. As the result, the total amount of spherical aberration is 660 mλrms, which requires about 1.5 times as much the movement amount of the coupling lens as that required in the objective lens including two information recording surfaces.

Under the assumption that the objective lens is formed of glass and its optical surfaces are aspheric refractive surfaces, the spherical aberration B (=140 mλrms) coming from an environmental temperature change is almost zero. Therefore, the movement amount of the coupling lens becomes furthermore small (corresponding to the correction amount of 540 mλrms in FIG. 1c). Alternatively, under the assumption that the objective lens is formed of glass and includes an optical surface being a diffractive surface which corrects spherical aberration generated with a wavelength change, the spherical aberration C coming from a change in the wavelength of the light source can be reduced by a function of the diffractive surface. Therefore, the movement amount of the coupling lens becomes furthermore small (corresponding to the correction amount of 500 mλrms in FIG. 1c). That is, it is preferable that the objective lens is formed of a glass material in order to reduce the movement amount of the coupling lens. However, even when the objective lens is improved as described above, the movement amount of the coupling lens required when an optical disc including four information recording surfaces are used is still about twice as much as the movement amount of the coupling lens required when an optical disc including two information recording surfaces are used. Therefore, further improvement is preferable in order to restrict the movement amount of the coupling lens. The same may be said of the movement amount of the coupling lens required when an optical disc including three information recording surfaces or five information recording surfaces are used. Therefore, in the present invention, worsening the sine condition of the objective lens enables the movement amount of the coupling lens to be more reduced.

In the above study, as the objective lens including two information recording surfaces (wherein the information recording surface at a smaller distance from the surface where a light flux enters of the optical disc is represented as RL1, and the information recording surface at a larger distance from the surface where a light flux enters of the optical disc is represented as RL2), an objective lens such that the distance from the surface where a light flux enters of the optical disc to RL1 is 75 μm and the distance from the surface where a light flux enters of the optical disc to RL2 is 100 μm has been assumed. Further, as the objective lens including four information recording surfaces (wherein the information recording surface at the minimum distance from the surface where a light flux enters of the optical disc is represented as RL1, and the information recording surface at the maximum distance from the surface where a light flux enters of the optical disc is represented as RL4), an objective lens such that the distance from the surface where a light flux enters of the optical disc to RL1 is 50 μm and the distance from the surface where a light flux enters of the optical disc to RL4 is 100 μm has been assumed.

In the present specification, an objective lens represents an optical system arranged at a position facing an optical disc in an optical pickup device, having a function of converging light onto an information recording surface. The objective lens is a plastic or glass lens formed of a single lens. Preferably, the objective lens is formed of a single convex lens. The objective lens may be composed of only refractive surfaces or may include an optical path difference providing structure. Alternatively, the objective lens may be a hybrid lens in which an optical path difference providing structure formed of a material such as photo-curable resin, UV-curable resin and thermosetting resin is formed on the glass lens. Further, the objective lens preferably has an aspheric base surface on which an optical path difference providing structure is provided. The optical surface facing the light source side in the objective lens is sometimes called as an object-side optical surface and the optical surface facing the optical disc side is sometimes called as an image-side optical surface. In an objective lens, it is preferable that the absolute value of the curvature radius of the optical surface facing the light source side is smaller than the absolute value of the curvature radius of the image-side optical surface.

When the objective lens is a glass lens, as above-described with referring FIG. 1, it is not required that the coupling lens is moved for correcting spherical aberration generated with a temperature change. Therefore, the movement amount of the coupling lens can be reduced and the optical pickup apparatus can be downsized, which is preferable.

Further, when the objective optical element is a glass lens, it is preferable that a glass material with glass transition point Tg of 500° C. or less, more preferably of 400° C. or less, is used. By using the glass material whose glass transition point Tg is 500° C. or less, the material can be molded at a comparatively low temperature. Therefore, the life of the mold can be prolonged. As an example of the glass material whose glass transition point Tg is low, there are cited K-PG325 and K-PG375 (both are trade names) made by SUMITA Optical glass, Inc.

Additionally, linear expansion coefficient α is one of physical properties which are important when a glass lens is molded and produced. If a material with Tg of 400° C. or less is selected, the temperature difference of Tg and the room temperature is still greater in comparison with plastic materials. When a lens is molded by using a material with large linear expansion coefficient α, the lens easily cracks when a temperature falls down. Linear expansion coefficient α of a lens material is preferably 200 (10E-7/K) or less, and is more preferably 120 or less.

Hereupon, a glass lens has generally larger specific gravity than a resin lens. Therefore, the objective lens made of glass has larger weight and applies a larger burden to an actuator which drives the objective lens. Therefore, when a glass lens is employed for the objective lens, a glass material having small specific gravity is preferably used for the objective lens. Specifically, the specific gravity is preferably 4.0 or less, and is more preferably 3.0 or less.

Further, when the objective lens is a plastic lens, it is preferable that alicyclic hydrocarbon polymers such as a resin material in a cyclic olefin group are used for the objective lens. As the resin materials, there is more preferably used a resin material having: a refractive index at the temperature 25° C. for wavelength 405 nm, which is within the range of 1.54 to 1.60; and a ratio of refractive index change dN/dT (° C.⁻¹) caused by a temperature change within the temperature range of −5° C. to 70° C. for the wavelength 405 ran, which is within the range of −20×10⁻⁵ to −5×10⁻⁵ (more preferably, −10×10⁻⁵ to −8×10⁻⁵). Further, when a plastic lens is employed for the objective lens, it is preferable that a plastic lens is also employed for the coupling lens.

Preferable examples of alicyclic hydrocarbon polymers will be described below.

The first preferable example is a resin composition comprising block copolymer including polymer block [A] containing a repeating unit [1] represented by the following Formula (1), and polymer block [B] containing the repeating unit [1] represented by the Formula (1) and a repeating unit [2] represented by the following Formula (2), and/or a repeating unit [3] represented by the Formula (3). The block copolymer satisfies a relationship of a>b, where a is a mol fraction (mol %) of the repeating unit [1] in the polymer block [A] and b is a mol fraction (mol %) of the repeating unit [1] in the polymer block [B].

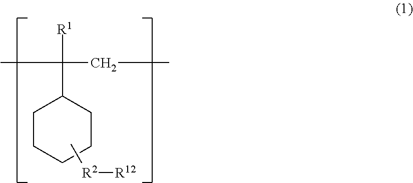

(In the above formula, R¹ represents a hydrogen atom or an alkyl group having a carbon number of 1-20, R²-R¹² each independently represent a hydrogen atom, an alkyl group having a carbon number of 1-20, hydroxyl group, an alkoxy group having a carbon number of 1-20 or a halogen group.)

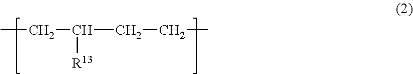

(In the above formula, R¹³ represents a hydrogen atom or an alkyl group having a carbon number of 1-20.)

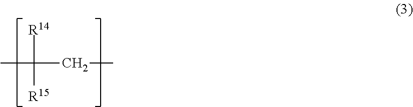

(In the above formula, R¹⁴ and R¹⁵ each independently represents a hydrogen atom or an alkyl group having a carbon number of 1-20.)

The second preferable example is a resin composition containing polymer (A) obtained by an addition polymerization at least of α-olefin with 2-20 carbon atoms and monomer composition consisting of cyclic olefin represented by the following general formula (1), and containing polymer (B) obtained by an addition polymerization of α-olefin with 2-20 carbon atoms and monomer composition containing cyclic olefin represented by following general formula (2).

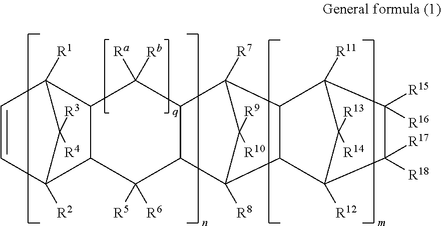

(In the above formula, n is 0 or l, m is 0 or a positive integer, and q is 0 or 1. R¹ to R¹⁸ and R^{a} and R^{b} each independently represent a hydrogen atom, a halogen atom or a hydrocarbon group. As for R¹⁵-R¹⁸, each may be bonded to another to form a monocyclic or polycyclic group, and the monocyclic or polycyclic group formed in this manner may have double bonds. Also an alkylidene group may also be formed with R¹⁵ and R¹⁶ or R¹⁷ and R¹⁸.)

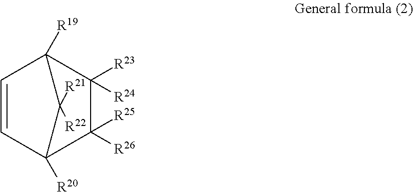

(In the above formula, R¹⁹-R²⁶ each independently represents a hydrogen atom, a halogen atom or a hydrocarbon group.)

The following additives may be added to the resin material in order to add an extra property to the resin material.

### (Additives)

It is preferable to add at least one type of additive selected from the group of phenol type stabilizer, hindered amine type stabilizer, phosphor type stabilizer, and sulfur type stabilizer. By properly selecting and adding these stabilizers, cloudiness caused when the material is continuously irradiated with a light flux with a short wavelength such as 405 nm, and fluctuation of optical property such as fluctuation of refractive index, can be controlled more properly.

For preferable phenol type stabilizer, usually known ones can be employed. For example, the followings are cited: acrylate compounds described in JP-A Nos. 63479953 and 1-168643 such as 2-t-butyl-6-(3-t-butyl-2-hydroxy-5-methylbenzyl)-4-methylphenyl acrylate and 2,4-di-t-amyl-6-(1-(3,5-di-t-amyl-2-hydroxyphenyl)ethyl)phenyl acrylate; an alkyl-substituted phenol compound such as oetadecyl-3-(3,5-di-t-butyl-4-hydroxyphenyl) propionate, 2,2′-methylene-bis(4-methyl-6-t-butylphenol), 1,1,3-tris(2-methyl-4-hydroxy-5-t-butylphenyl)butane, 1,3,5-trimethyl-2,4,6-tris (3,5-di-t-butyl-4-hydroxybenzyl)benzene, tetrakis(methylene-3-(3′,5′-di-t-butyl-4′-hydroxyphenylpropionate)methane, namely pentaerythrimethyl-tetrakis(3-(3,5-di-t-butyl-4-hydroxyphenylpropionate) and triethylene glycol bis-(3-(3-t-butyl-4-hydroxy-5-methylphenyl)-propionate; and a triazine group-containing phenol compound such as 6-(4-hydroxy-3,5-di-t-butylanilino)-2,4-bisoctyl-1,3,5-triazine, 4-bisoctylthio-1,3,5-triazine and 2-octylthio-4,6-bis-(3,5-di-t-butyl-4-oxyanilino)-1,3,5-triazine.

For preferable hindered amine type stabilizer, the following samples are cited: bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(N-octoxy-2,2,6,6-tetramethyl-4-piperidyl)sebacate, bis(N-benzyloxy-2,2,6,6-tetramethyl-4-piperidyl)sebacate, bis(N-cyclohexyloxy-2,2,6,6-tetramethyl-4-piperidyl)sebacate, bis(1,2,2,6,6-pentamethyl-4-piperidyl)-2-(3,5-di-t-butyl-4-hydroxybenzyl)-2-butylmalonate, bis(1-acroyl-2,2,6,6-tetramethyl-4-piperidyl)2,2-bis(3,5-di-t-butyl-4-hyd-roxybenzyl)-2-butylmalonate, bis(1,2,2,6,6-pentamethyl-4-piperidyl decanedioate, 2,2,6,6-tetramethyl-4-piperidyl methacrylate, 4-[3-(3,5-di-t-butyl-4-hydroxyphenyl)propionyloxy]-1-[2-(3-(3,5-di-t-buty-1-4-hydroxyphenyl)propionyloxy)ethyl]-2,2,6,6-tetramethyl piperidine, 2-methyl-2-(2,2,6,6-tetramethyl-4-piperidyl)amino-N-(2,2,6,6-tetramethyl-4-piperidyl)propionamide, tetrakis(2,2,6,6-tetramethyl-4-piperidyl)1,2,3,4-butanetetracarboxylate, tetrakis(1,2,2,6,6-pentamethyl-4-piperidyl)1,2,3,4-butanetetracarboxylate.

As for preferable phosphor type stabilizer, ones usually employed in the field of resin industry can be employed without any limitation. For example, the followings are cited: monophosphite compounds such as triphenyl phosphate, diphenylisodecyl phosphate, phenylisodecyl phosphate, tris(nonylphenyl) phosphate, tris(dinonylphenyl) phosphate, tris(dinonylphenyl) phosphate, tris(2,4-di-t-butylphenyl) phosphate, and 10-(3,5-di-t-butyl-4-hydroxybenzyl)-9,10-dihydro-9-oxa-10-Phosphaphenanthrene-10-oxide; and diphosphite compounds such as 4,4′-butylidene-bis(3-methyl-6-t-butylphenyl-di-tridecyl phosphate and 4,4′-isopropyridene-bis(phenyl-di-alkyl(C₁₂ to C₁₅) phosphate). Among them, the monophosphite compounds are preferable and tris(nonylphenyl) phosphate, tris(dinonylphenyl) phosphate and tris(2,4,-di-t-butylphenyl) phosphate are particularly preferable.

As for preferable sulfur type stabilizer, the following examples are cited: dilauryl 3,3-thiodipropionate, dimyrystyl 3,3′-thiodipropionate, distearyl 3,3-thiodipropionate, laurystearyl 3,3-dithiopropionate, pentaerythrytol-tetrakis-(β-laurylstearyl-thio-propionate and 3,9-bis-(2-dodecylthioethyl)-2,4,8,10-tetrakispiro[5,5]undecane.

The adding amount of each stabilizer is optionally decided within the range in which the object of the invention is not vitiated; it is usually from 0.01 to 2 parts by weight and preferably from 0.01 to 1 part by weight to 100 parts by weight of the alicyclic hydrocarbon polymer.

### (Surfactant)

Surfactant is a compound having a hydrophilic group and a hydrophobic group in the identical molecule. The surfactant inhibits cloudiness of resin composition by adjusting the speed of moisture adhesion to the resin surface and of moisture vaporization from the foregoing surface.

Specific examples of the hydrophilic group in the surfactant include a hydroxy group, a hydroxyalkyl group having at least one carbon atom, a hydroxyl group, a carbonyl group, an ester group, an amino group, an amide group, an ammonium salt, thiol, sulfate, phosphate, and a polyalkyleneglycol group. Herein, the amino group may be any of a primary amino group, a secondary amino group and a tertiary amino group. Specific examples of the hydrophobic group in the surfactant include an alkyl group having six carbon atoms, a silyl group including an alkyl group having six carbon atoms, and a fluoroalkyl group having six carbon atoms. Herein, the alkyl group having six carbon atoms may possess an aromatic ring as a substituent. Specific examples of the alkyl group include hexyl, heptyl, octyl, nonyl, decyl, undecenyl, dodecyl, tridecyl, tetradecyl, myristyl, stearyl, lauryl, palmityl, and cyclohexyl. As the aromatic ring, a phenyl group can be provided. This surfactant may possess at least one hydrophilic group and one hydrophobic group each in the identical molecule, or may possess two hydrophilic groups and two hydrophobic groups.

Further specific examples of such the surfactant include myristyl diethanolamine, 2-hydroxyethyl-2-hydroxyldodexylamine, 2-hydroxyethyl-2-hydroxytridecylamine, 2-hydroxyethyl-2-hydroxytetradecylamine, pentaerythritolmonostearate, pentaerythritoldistearate, pentaerythritoltristearate, di-2-hydroxyethyl-2-hydroxydodecylarnine, alkyl (8-18 carbon atoms) benzyldimethylammonium chloride, ethylene bis alkyl (8-18 carbon atoms) amide, stearyl diethanolamide, lauryl diethanolamide, myristyl diethanolamide, and palmityl diethanolamide. Of these, amine compounds and amide compounds having a hydroxyalkyl group are preferably used. In the present embodiment, these compounds may be used in combination of at least two kinds.

The adding amount of surfactant is preferably from 0.01 to 10 parts by weight to 100 parts by weight of the alicyclic hydrocarbon polymer from the viewpoint of efficient restriction of cloudiness of a product caused by fluctuation of temperature and humidity and the viewpoint of maintain the high light transmittance of the product. The addition amount of the surfactant is more preferably 0.05-5 parts by weight, with respect to 100 parts by weight of the alicyclic hydrocarbon based polymer, and further more preferably 0.3-3 parts by weight.

### (Plasticizer)

Plasticizer is added as in need to adjust the melt index of the copolymer.

As for plasticizer, usually known ones can be employed. For example, the followings are cited: bis(2-ethylhexyl)adipate, bis(2-budoxyethyl)adipate, bis(2-ethylhexyl)azelate, dipropyleneglycol dibenzoate, tri-n-butyl citrate, tri-n-butylacetyl citrate, epoxidized soybean oil, 2-ethylhexyl epoxidized tall oil, chlorinated paraffin, tri-2-ethylhexyl phosphate, tricresyl phosphate, t-butylphenyl phosphate, tri-2-ethylhexyldiphenyl phosphate, dibutyl phtalate, diisohexyl phthalate, diheptyl phthalate, dinonyl phthalate, diundecyl phthalate, di-2-ethylhexyl phthalate, diisononyl phthalate, diisodecyl phthalate, ditridecyl phthalate, butylbenzyl phthalate, disyclohexyl phthalate, bis(2-ethylhexyl)sebacate, (tri-2-ethylhexyl)trimellitic acid, Santicizer 278, Paraplex 040, Drapex 334F, Plastolein 9720, Mesamoll, DNODP-610, and HB-40. Selection of plasticizer and its amount of addition can be determined arbitrarily so long as transmittance and durability against change in the environment of the copolymer am not degraded.

As the resin, cycloolefin resin is employed suitably. Specifically, ZEONEX by ZEON CORPORATION, APEL by Mitsui Chemicals, Inc., TOPAS made from TOPAS Advanced Polymers, ARTON by JSR Corporation, are cited as preferable examples.

Further, it is preferable that a material which forms the objective lens has the Abbe number of 50 or more.

Under the condition that the objective lens is a single lens formed of a plastic material with the numerical aperture (NA) at the image side which is 0.8 or more and is 0.95 or less, the magnification M obtained when spherical aberration (λrms) is minimized at the normal temperature (25±3° C.) with cover glass thickness T (mm) satisfying the following expression (1) preferably satisfies the expression (2), where T_{MAX} (mm) is the maximum transparent substrate thickness (the distance between the information recording surface at the deepest position and the top surface of the optical disc) among the transparent substrate thicknesses of the optical disc:

T_{MAX}×0.85≦T≦T_{MAX}×1.1 (1)

−0.003≦M<0.003 (2)

As for the coma generated with a lens tilt, the target value which is to be satisfied by a plastic objective lens for three-or-more-layer BDs has been studied, and the ratio of the-third order coma CM(DT) generated when the optical disc is tilted when the environment temperature goes up during information is recorded/reproduced for the information recording surface arranged at the most distant position from the surface where a light flux enters to CM(LT) is set to be about 0.36. The value of the ratio is the same as the ratio of the third-order coma CM(DT) generated when the objective lens is tilted and the third-order coma CM(LT) generated when the optical disc is tilted under the condition that the environment temperature goes up during information is recorded/reproduced for the information recording surface L0 (100 μm) at a thicker transparent substrate thickness in an optical pickup device equipped with a plastic objective lens, for recording/reproducing information for two-layer BDs.

The inventors have studied a plastic objective lens suitable for three-or-more-layer BDs with setting those values as target values. As the result, the inventors have found that the target value of CM(LT) is satisfied by setting the condition of the spherical aberration correction such that cover glass thickness T becomes the value of the lower limit of the expression (1) or more, under the condition that spherical aberration is minimized at the normal temperature (25±3° C.) and the magnification satisfying the expression (2). The value of CM(LT) can be enlarged as the cover glass thickness T is thicker. However, when cover glass thickness exceeds the upper limit of the expression (1), the degree of the convergence of a light flux entering the objective lens when information is recorded/reproduced on the information recording surface at the thinnest transparent substrate thickness becomes excessively large, resulting in deteriorated the lens-shift characteristics and enlarged residual high-order spherical aberration when the focus jumps to the information recording surface with the thinnest transparent substrate thickness, which are not preferable.

More preferably, the following expression (3) is satisfied.

T_{MAX}×0.85≦T≦T_{MAX}×1.0 (3)

Herein, it is especially preferable that M=0 holds.

When cover glass thickness T satisfies the upper limit of the expression (3), it restricts that the degree of the convergence of a light flux entering the objective lens when information is recorded/reproduced on the information recording surface with the thinnest transparent substrate thickness becomes excessively large. As the result, the lens-shift property can be enhanced more properly and the residual high-order spherical aberration when the focus jumps to the information recording surface with the thinnest transparent substrate thickness can be more reduce, which are preferable.

More preferably, the following expression (3)′ is satisfied.

T_{MAX}×0.9≦T≦T_{MAX}×0.95 (3)′

Herein, it is especially preferable that M=0 holds.

Next, under the condition that the objective lens is a single lens formed of a glass material with the numerical aperture (NA) at the image side which is 0.8 or more and is 0.95 or less, the magnification M obtained when spherical aberration (λrms) is minimized at the normal temperature (25±3° C.) with cover glass thickness T (mm) satisfying the following expression (4) preferably satisfies the expression (2), where T_{MAX} (mm) is the maximum transparent substrate thickness (the distance between the information recording surface at the deepest position and the top surface of the optical disc) among the transparent substrate thicknesses of the optical disc:

T_{MAX}×0.75≦T≦T_{MAX}×1.0 (4),

−0.003≦M≦0.003 (2),

Since the influence of a temperature change can be almost ignored in an objective lens formed of a glass material, the degree of the divergence of an incident light into the objective lens does not become so large in comparison with the case that a plastic objective lens is used. Therefore, the inventors have found that, at the normal temperature (25±3° C.) and the magnification satisfying the expression (2), the cover glass thickness T under the condition that the spherical aberration is minimized becomes thinner, and that the target value of the generation amount of the third-order coma coming from a lens shift and tilt is satisfied by setting the condition of correcting the spherical aberration so as to have the value of the lower limit of the expression (4) or more as the result. Further, when the cover glass thickness T is set not to exceed the upper limit of the expression (4), it is restricted that the degree of the convergence of a light flux entering the objective lens when information is recorded/reproduced on the information recording surface at the thinnest transparent substrate thickness becomes excessively large. Further, it can be restricted that the lens-shift characteristics is restricted and that the residual high-order spherical aberration when the focus jumps to the information recording surface at the thinnest transparent substrate thickness is enlarged, which are preferable.

More preferably, the following expression (5) is satisfied.

T_{MAX}×0.8≦T≦T_{MAX}×0.95 (5).

Herein, it is especially preferable that M=0 holds.

Next, a preferable condition of a sine condition of the objective lens will be described. The sine condition means a condition that, as showing in FIG. 2, when a ray at height h₁ from the optical axis enters a lens parallel with the optical axis, the value of h₁/sin U is constant, where U is an outgoing angle of the ray emitted from the lens. When the value is constant regardless the height form height h₁ from the optical axis, the lens is considered to satisfy the sine condition and a lateral magnification of each ray in the effective aperture is considered to have a constant value. The sine condition is a value calculated on the optical axis but it is effective for correcting an off-axis lateral magnification error (namely, off-axis coma).

On the other hand, when the value of h₁/sin U is not constant, OSC=h₁/sin U−f is defined as an offence against the sine condition. FIG. 3 shows graphs with the offence against the sine condition in the objective lens as the horizontal axis and height from the optical axis as the vertical axis. As for an objective lens satisfying the sine condition, the graph fits with the vertical axis. As for an objective lens not satisfying the sine condition, the graph forms a curve extending away from the vertical axis in the positive direction and/or the negative direction, as shown in FIG. 3. When the objective lens not satisfying the sine condition is configured not to satisfy the sine condition around the optical axis and the effective aperture, the offence against the sine condition always has a maximum value. Herein, it is assumed that OSCmax is a maximum value at the positive side and OSCmin is a maximum value at the negative side.

An objective lens having a characteristic shown in FIG. 3a is provided as an example that the offence against the sine condition has one negative maximum value OSCmin and does not have a positive maximum value OSCmax. Such the lens is easily manufactured but has characteristics that high-order spherical aberration is increased with a movement of the coupling lens and a change of spherical aberration corning from a magnification change is small because the surface shift sensitivity is small and sensitivity of an axial thickness error is small. Therefore, when the coupling lens is moved for selecting an information recording surface of a three-or-more-layer optical disc, a required movement can be increased.

On the other hand, in an objective lens having a characteristic shown in FIG. 3b and FIG. 3c as the objective lens of the present invention, the offence against the sine condition has at least one (preferably only one) positive maximum value OSCmax in an area between 70% and 90% of the radius of the effective aperture of the objective lens. As for the objective lens in which the offence against the sine condition has at least one (preferably only one) positive maximum value OSCmax in an area between 70% and 90% of the radius of the effective aperture of the objective lens, as shown in FIGS. 3b and 3c, the objective lens has characteristics that the high-order spherical aberration generated with the movement of the coupling lens is reduced and the change of spherical aberration coming from a magnification change. Therefore, when the coupling lens is moved for selecting an information recording surface of a three-or-more-layer optical disc, a necessary movement amount can be reduced.

In the example shown in FIG. 3b, the offence against the sine condition has one negative maximum value at a position closer to the optical axis than the position of the positive maximum value. In the example shown in FIG. 3c, the offence against the sine condition has only a positive maximum value and does not have a negative maximum value. In each of the example of FIG. 3b and the example of FIG. 3c, the offence against the sine condition reduced monotonously in an area from the position of the maximum value to the periphery.

As shown in FIG. 3b, when the offence against the sine condition has a positive maximum value at a position in an area from 70% to 90% of the radius of the effective aperture and further has a negative maximum value, at magnification M, the following matters are realized: (Property 1) the residual high-order spherical aberration when the focus jumps is small, (Property 2) the movement amount of the coupling lens when the focus jumps is small, and (Property 3) the sensitivity of lens tilt is not excessively small even when the environmental temperature becomes high temperature during recording/reproducing information for the information recording surface at a thicker transparent substrate thickness. Additionally, the following matters are also realized: (Property 4) the amount of aberration generated when two optical surfaces facing each other is shifted in the direction perpendicular to the optical axis because of a manufacturing error, and (Property 5) the amount of aberration generated when two optical surfaces facing each other is shifted in the direction of the optical axis because of a manufacturing error. Thereby, there can be provided an objective lens which is more easily manufactured.

On the other hand, as shown in FIG. 3c, when the offence against the sine condition has a positive maximum value at a position in an area from 70% to 90% of the radius of the effective aperture and does not have a negative maximum value, at magnification M, the following matters are realized: (Property 1) the residual high-order spherical aberration when the focus jumps is small, (Property 2) the movement amount of the coupling lens when the focus jumps is small, and (Property 3) the sensitivity of lens tilt is not excessively small even when the environmental temperature becomes high temperature during recording/reproducing information for the information recording surface at a thicker transparent substrate thickness.

Further, for furthermore restricting the high-order spherical aberration, it is preferable that the positive maximum value of the offence against the sine condition is set such that the changes of the third-order spherical aberration and the high-order spherical aberration generated in the objective lens corresponding to a change of the degree of divergence of the incident light have almost similar figures to the changes of the third-order spherical aberration and the high-order spherical aberration generated when the focus jumps.

In the objective lens, the form of the offence against the sine condition may be configured with placing priority on reducing the movement amount of the coupling lens, or the form of the offence against the sine condition may be configured with placing priority on reducing the residual aberrations caused when the focus jumps.

It is preferable that the value of ΔSA3/(ΔM×f) (λrms/mm) which is a change rate of a third-order spherical aberration to the focal length f of the objective lens and a magnification change ΔM satisfies the expression (2) at the normal temperature (25±3C.°) with the cover glass thickness T, where T (mm) is a cover glass thickness under a condition that a spherical aberration (λrms) is minimized at a normal temperature (25±3C.°) and a magnification M satisfying the expression (2), and that f (mm) is a focal length for the wavelength λ1 at the normal temperature (25±3C.°).

21≦|ΔSA3/(ΔM×f)|<25 (6).

Setting the change rate of the third-order spherical aberration to the change in magnification of the objective lens so as to satisfy the expression (6), allows achieving both of restriction of the residual high-order spherical aberration caused when the focus jumps and restriction of the movement amount of the coupling lens.

It is more preferable that the following conditional expression (6)′ is satisfied.

21.5<|ΔSA3/(ΔM×f)|<24.5 (6)′

It is preferable that a third-order spherical aberration ΔSA3 and a fifth-order spherical aberration ΔSA5 which are generated when a magnification of the objective lens is changed at a normal temperature (25±3C.°) with the cover glass thickness T satisfy the expression (7), at the normal temperature (25±3C.°) with the cover glass thickness T.

4.2≦ΔSA3/ΔSA5<5.2 (7).

When the expression (7) is satisfied, the ratio of the change of the third-order spherical aberration ΔSA3 and the change of the fifth-order spherical aberration ΔSA5 which are generated when a magnification of the objective lens is changed comes closer to the ratio of the third-order spherical aberration ΔSA3 and the fifth-order spherical aberration ΔSA5 which are generated when the cover glass thickness changes. Therefore, it allows achieving both of restriction of the residual high-order spherical aberration caused when the focus jumps and restriction of the movement amount of the coupling lens.

It is more preferable that the conditional expression (7)′ is satisfied.

4.3<ΔSA3/ΔSA5<4.9 (7)′

Further, it is preferable that a fifth-order coma CM5 (λrms) generated when an oblique light flux whose half angle of view is 1 degree enters the objective lens satisfies the expression (8) at a normal temperature (25±3 C.°) and the magnification M with the cover glass thickness T.

0.02<|CM5|<0.05 (8).

The conditional expression (8) is a condition which is established for achieving both of a reduction of the residual high-order spherical aberration when the focus jumps and a reduction of the movement amount of the coupling lens, from a dial ent point of view. Satisfying the expression (8) is satisfied at the magnification M satisfying the expression (2), enables to achieve both of reducing the residual high-order spherical aberration when the focus jumps and reducing the movement amount of the coupling lens.

It is preferable that a third-order coma CM3 (λrms) generated when an oblique light flux whose half angle of view is 1 degree enters the objective lens satisfies the expression (9) at a normal temperature (25±3 C.°) and the magnification M with the cover glass thickness T.

0≦|CM3|<0.02 (9).

Satisfying the expression (9) prevents the lens-tilt sensitivity from being excessively small even when information is recorded/reproduced for the information recording surface at the thicker transparent substrate thickness. Further, when the objective lens is made of plastic, it prevents the lens-tilt sensitivity from being excessively small under the condition that information is recorded/reproduced for the information recording surface at the thicker transparent substrate thickness, which is preferable.

It is preferable that the objective lens satisfies the expression (11) where OSC_{MAX} (mm) is the offence against the sine condition which has a positive maximum value, and f(mm) is a focal length for the wavelength λ1 at a normal temperature (25±3C.°).

0.003<OSC_{MAX}/f<0.022 (11).

When the condition of correction of coma generated when an oblique light flux enters the objective lens such that the offence against the sine condition become larger than the lower limit of the expression (11), the high-order spherical aberration generated when the focus jumps does not become under-corrected. When the condition of correction of coma generated when an oblique light flux enters the objective lens such that the offence against the sine condition become smaller than the upper limit of the expression (11), the high-order spherical aberration generated when the focus jumps does not become over-corrected. Therefore, the high-order spherical aberration generated when the focus jumps can be restricted effectively.

It is more preferable that the following expression is satisfied.

0.003<OSC_{MAX}/f<0.015 (11).

Under the condition that the objective lens can be tilted along a radial direction or a tangential direction of the optical disc (which is called as lens tilt in the present specification) when information is recorded/reproduced for an optical disc, coma is generated by tilting the objective lens along a radial direction or a tangential direction of the optical disc (which is called as lens tilt in the present specification). By using this type of the coma, coma generated due to a warp or tilt of the optical disc (which is called as disc tilt) can be cancelled out. Therefore, information can be recorded and/or reproduced stably for the optical disc.

When the coma generated with the lens tilt is excessively smaller with respect to the coma generated with the disc tilt, the amount of the lens tilt necessary for correcting the coma generated with the disc tilt becomes great, which causes problems that electricity consumption increases and that the objective lens touches with the optical disc when the lens tilt is carried out.

The coma generated with lent tilt changes depending on the offence against the sine condition of the objective lens, and the offence against the sine condition changes depending on the magnification of the objective lens under the condition that information is recorded/reproduced for an optical disc. Concretely, in the objective lens in which the offence against the sine condition is corrected under the condition that a parallel light flux enters the objective lens, the offence against the sine condition changes in the minus direction under the condition that a divergent light flux enters the objective lens and the amount of coma generated with lens tilt becomes small. Such the amount of coma becomes smaller as the degree of divergence of a light flux entering the objective lens.

The degree of divergence of a light flux entering the objective lens in an optical pickup device for BDs is maximized when information is recorded and/or reproduced for the information recording surface located at the most distant position from the surface where the light flux enters. Further, when the objective lens is made of a plastic material, the degree of divergence of the light flux becomes greater for correcting spherical aberration generated because of a change of environmental temperature.

To solve that, it is preferable to set the offence against the sine condition of the objective lens under the condition that information is recorded and/or reproduced for the information recording surface located at the most distant position from the surface where the light flux enters such that the absolute value of the ratio of third-order coma CM(LT) which is generated when the objective lens is tilted and a third-order coma CM (DT) which is generated when a cover glass is tilted at the same angle as that of the objective lens for the third-order coma CM(LT), under a condition that a non-parallel light flux enters the objective lens such that a third-order spherical aberration of a spot converged by the objective lens is corrected at a high temperature (55±3 C.°) with a cover glass thickness which is equal to the maximum transparent substrate thickness T_{MAX}, to be 03 or more. Thereby, even under the condition that information is recorded and/or reproduced for the information recording surface located at the most distant position from the surface where the light flux enters, the coma coming from lens tilt can be corrected excellently by lens tilt and excellent recording/reproducing characteristics can be obtained for each of information recording surfaces in an optical disc.

In other words, when the following expression (12) is satisfied, the lens tilt sensitivity is prevented from being excessively small even under the condition that information is recorded and/or reproduced for the information recording surface located at the most distant position from the surface where the light flux enters. Further, even under the condition that the objective lens is formed of a plastic material, he lens tilt sensitivity is prevented from being excessively small even when the environmental temperature goes up durgin recording/reproducing information for the information recording surface with a thicker transparent substrate, which is preferable.

0.3≦|CM(LT)/CM(DT)|≦0.8 (12).

It is more preferable that the following conditional expression (12)′ is satisfied.

0.3≦|CM(LT)/CM(DT)|≦0.8 (12)′.

Further, for exhibiting the above effect more greatly, it is more preferable to set the offence against the sine condition of the objective lens and the condition of correction of spherical aberration as the followings.

The correction condition of the spherical aberration of the objective lens is set such that, under the condition that a light flux enters the objective lens at magnification M satisfying the expression (2), the absolute value of spherical aberration of a spot which is converged through a cover glass with a thickness same as the minimum transparent substrate thickness T_{MIN} is smaller than the absolute value of spherical aberration of a spot which is converged through a cover glass with a thickness same as the maximum transparent substrate thickness T_{MAX}.

That has the same mean as the followings. In an optical pickup device, the following expression (24) holds, where T0 is a position of a movable lens under the condition that a light flux enters the objective lens at the magnification M, T1 is a position of a movable lens under the condition that information is recorded and/or reproduced for an information recording surface at transparent substrate thickness T_{MAX}, and T2 is a position of a movable lens under the condition that information is recorded and/or reproduced for an information recording surface at transparent substrate thickness T_{Min}.

|T1−T0|</T2−T0| (24)

Further, it is preferable that magnification M1 and magnification M2 satisfy the expression (13), where the magnification M1 is a magnification under a condition that a non-parallel light flux enters the objective lens such that a third-order spherical aberration of a spot converged by the objective lens is corrected at a normal temperature (25±3C.°) with a cover glass thickness which is equal to the maximum transparent substrate thickness T_{MAX}, and the magnification M2 is a magnification under a condition that a non-parallel light flux enters the objective lens such that a third-order spherical aberration of a spot converged by the objective lens is corrected at a normal temperature (25±3 C.°) with a cover glass thickness which is equal to a minimum transparent substrate thickness T_{MIN} among the transparent substrate thicknesses.

0≦M1/M2<0.92 (13)

In order to prevent the lens tilt sensitivity from being excessively small when information is recorded/reproduced for an information recording surface at a thicker transparent substrate thickness, it is preferable that T has a value being closer to T_{MAX} out of T_{MAX} and T_{MIN}. The expression (13) defines the preferable region from the view point of magnification.

It is more preferable that the following expression is satisfied:

0≦M1/M2<0.8 (13)′

From the view point of lens form, it is preferable that a refractive index N of the objective lens for the wavelength λ1 at a normal temperature (25±3 C.°), and an inclination angle θ (degree) of an optical surface thereof facing the light source measured at a most periphery of an effective aperture of the optical surface satisfy the expression (14).

−59.8×N+162<θ<−59.8×N+166 (14)

As shown in FIG. 39, by using the example of the present invention, it has been found that refractive index N of the lens and inclination angle θ at a most periphery of an effective aperture of the optical surface facing the object side fall within the region defined by a certain condition. The expression (14) defines the objective lens of the present invention from the view point of preferable lens form from this knowledge. Herein, FIG. 39 shows a graph wherein comparative examples which will be described later and Examples 1 to 16 are plotted with refractive index N for wavelength λ1 at a normal temperature (25±3C.°) as the horizontal axis and inclination angle θ (degree) of an optical surface facing the light source measured at a most periphery of an effective aperture of the optical surface as the vertical axis.

From the view point of lens form, the objective lens is characterized in that the objective lens satisfies the expression (16), where N is a refractive index of the objective lens for the wavelength λ1 at a normal temperature (25±3C.°) and H (mm) is a height along a radius at which a first-order derivative X′(h) of a deformation amount of an aspheric surface X(h) of an optical surface thereof facing the optical disc switches from a negative value to a positive value.

−2.8×N+5.1<H<−2.8×N+5.4 (16)

In the expression, the deformation amount of an aspheric surface X(h) is defined by a distance in a direction of an optical axis from a plane tangent to a top of the optical surface facing the optical disc to the aspheric surface, and has a negative value when the aspheric surface deforms from the plane toward the light source and has a positive value when the aspheric surface deforms from the plane toward the optical disc, and H is represented as a relative value under a condition that a radius of an effective aperture is defined as 1.

As shown in FIG. 40, by using the example of the present invention, it has been found that refractive index N and height H along a radius at which a first-order derivative X′(h) of a deformation amount of an aspheric surface X(h) of an optical surface thereof facing the optical disc switches from a negative value to a positive value fall within the region defined by a certain condition. The expression (16) defines the objective lens of the present invention from the view point of preferable lens form from this knowledge. Herein, FIG. 40 shows a graph wherein Examples 1 to 16 which will be described below are plotted with refractive index N for wavelength λ1 at a normal temperature (25±3C.°) as the horizontal axis and inclination angle height H along a radius at which a first-order derivative X′(h) of a deformation amount of an aspheric surface X(h) of an optical surface thereof facing the optical disc switches from a negative value to a positive value as the vertical axis, which shows the correlation among Examples.

A numerical aperture of the objective lens on the image side that is needed for reproducing and/or recording of information for the first optical disc is represented by NA1, a numerical aperture of the objective lens on the image side that is needed for reproducing and/or recording of information for the second optical disc is represented by NA2 (NA1>NA2) and a numerical aperture of the objective lens on the image side that is needed for reproducing and/or recording of information for the third optical disc is represented by NA3 (NA2>NA3). NA1 is preferably 0.75 or more and is 0.9 or less, and it is 0.8 or more and is 0.9 or less more preferably. It is especially preferable that NA1 is 0.85. NA2 is preferably 0.55 or more and is 0.7 or less. It is especially preferable that NA2 is 0.60 or 0.65. Further, NA3 is preferably 0.4 or more and is 0.55 or less. It is especially preferable that NA3 is 0.45 or 0.53.

It is preferable that the objective lens satisfy the following conditional expression (25).

0.9≦d/f≦1.5 (25)

In the expression, d is an axial thickness (mm) of the objective lens and f is a focal length of the objective lens for the first light flux. It is preferable that f is 1.0 mm or more and is 1.8 mm or less.

In an objective lens handling an optical disc, such as a BD, which has a high NA and using a shorter wavelength, when the ratio of the thickness on the optical axis to the focal length in the objective lens is excessively great, there are caused problems that astigmatism is easily generated when an off-axis light flux enters the objective lens and that the working distance cannot be secured sufficiently. On the other hand, when the ratio of the thickness on the optical axis to the focal length in the objective lens is excessively small, there is caused a problem that the surface-shift sensitivity becomes great Satisfying conditional expression (25) enables the objective lens to realize restriction of astigmatism generation and restriction of the surface-shift sensitivity.

It is preferable that the working distance of the objective lens when the first optical disc is used is 0.15 mm or more and is 1.0 mm or less.

Herein, the optical disc drive apparatus installed in the optical information recording and reproducing device will be described.

There is provided an optical disc drive apparatus employing a system of taking only a tray which can hold an optical disc under the condition that the optical disc is mounted thereon, outside from the main body of the optical information recording and reproducing device in which optical pickup device is housed; and a system of taking out the main body of the optical disc drive apparatus in which the optical pickup device is housed.

The optical information recording and reproducing device using each of the above described systems, is generally provided with the following component members but the members are not limited to them: an optical pickup device housed in a housing; a drive source of the optical pickup device such as seek-motor by which the optical pickup device is moved toward the inner periphery or outer periphery of the optical disc for each housing; traveling means having a guide rail for guiding the optical pickup device toward the inner periphery or outer periphery of the optical disc; and a spindle motor for rotation driving of the optical disc.

The optical information recording and reproducing device employing the former system is provide with, other than these component members, a tray which can hold the optical disc with the optical disc being mounted thereon, and a loading mechanism for slidably moving the tray. The optical information recording and reproducing device employing the latter system does not include the tray and loading mechanism, and it is preferable that each component member is provided in the drawer corresponding to chassis which can be taken out outside.

### Advantageous Effect of Invention

According to the present invention, there can be provide an optical pickup apparatus which can record/reproduce information for an optical disc having plural information recording surface with achieving compactness and reduced cost.

### BRIEF DESCRIPTION OF DRAWINGS

FIG. 1 is a diagram showing the comparison of results of study which has been carried out by the inventors with respect to various spherical aberrations.

FIG. 2 is a diagram for illustrating the sine condition.

FIG. 3 is a diagram showing an example of an offence against the sine condition.

FIG. 4 is a diagram schematically showing the structure of optical pickup device PU1.

FIG. 5 shows a graph of a comparative example with radius of the effective aperture as the vertical axis and spherical aberration and the sine condition as the horizontal axis.

FIG. 6 shows a graph of a comparative example with radius of the effective aperture as the vertical axis and first-order derivative X′(h) of an aspheric surface shape of the optical surface facing the optical disc as the horizontal axis.

FIG. 7 shows a graph of Example 1 with radius of the effective aperture as the vertical axis and spherical aberration and the sine condition as the horizontal axis.

FIG. 8 shows a graph of Example 1 with radius of the effective aperture as the vertical axis and first-order derivative X′(h) of an aspheric surface shape of the optical surface facing the optical disc as the horizontal axis.

FIG. 9 shows a graph of Example 2 with radius of the effective aperture as the vertical axis and spherical aberration and the sine condition as the horizontal axis.

FIG. 10 shows a graph of Example 2 with radius of the effective aperture as the vertical axis and first-order derivative X′(h) of an aspheric surface shape of the optical surface facing the optical disc as the horizontal axis.

FIG. 11 shows a graph of Example 3 with radius of the effective aperture as the vertical axis and spherical aberration and the sine condition as the horizontal axis.

FIG. 12 shows a graph of Example 3 with radius of the effective aperture as the vertical axis and first-order derivative X′(h) of an aspheric surface shape of the optical surface facing the optical disc as the horizontal axis.

FIG. 13 shows a graph of Example 4 with radius of the effective aperture as the vertical axis and spherical aberration and the sine condition as the horizontal axis.

FIG. 14 shows a graph of Example 4 with radius of the effective aperture as the vertical axis and first-order derivative X′(h) of an aspheric surface shape of the optical surface facing the optical disc as the horizontal axis.

FIG. 15 shows a graph of Example 5 with radius of the effective aperture as the vertical axis and spherical aberration and the sine condition as the horizontal axis.

FIG. 16 shows a graph of Example 5 with radius of the effective aperture as the vertical axis and first-order derivative X′ (h) of an aspheric surface shape of the optical surface facing the optical disc as the horizontal axis.

FIG. 17 shows a graph of Example 6 with radius of the effective aperture as the vertical axis and spherical aberration and the sine condition as the horizontal axis.

FIG. 18 shows a graph of Example 6 with radius of the effective aperture as the vertical axis and first-other derivative X′(h) of an aspheric surface shape of the optical surface facing the optical disc as the horizontal axis.

FIG. 19 shows a graph of Example 7 with radius of the effective aperture as the vertical axis and spherical aberration and the sine condition as the horizontal axis.

FIG. 20 shows a graph of Example 7 with radius of the effective aperture as the vertical axis and first-order derivative X′(h) of an aspheric surface shape of the optical surface facing the optical disc as the horizontal axis.

FIG. 21 shows a graph of Example 8 with radius of the effective aperture as the vertical axis and spherical aberration and the sine condition as the horizontal axis.

FIG. 22 shows a graph of Example 8 with radius of the effective aperture as the vertical axis and first-order derivative X′(h) of an aspheric surface shape of the optical surface facing the optical disc as the horizontal axis.

FIG. 23 shows a graph of Example 9 with radius of the effective aperture as the vertical axis and spherical aberration and the sine condition as the horizontal axis.

FIG. 24 shows a graph of Example 9 with radius of the effective aperture as the vertical axis and first-order derivative X′(h) of an aspheric surface shape of the optical surface facing the optical disc as the horizontal axis.

FIG. 25 shows a graph of Example 10 with radius of the effective aperture as the vertical axis and spherical aberration and the sine condition as the horizontal axis.

FIG. 26 shows a graph of Example 10 with radius of the effective aperture as the vertical axis and first-order derivative X′(1) of an aspheric surface shape of the optical surface facing the optical disc as the horizontal axis.

FIG. 27 shows a graph of Example 11 with radius of the effective aperture as the vertical axis and spherical aberration and the sine condition as the horizontal axis.

FIG. 28 shows a graph of Example 11 with radius of the effective aperture as the vertical axis and first-order derivative X′(h) of an aspheric surface shape of the optical surface facing the optical disc as the horizontal axis.

FIG. 29 shows a graph of Example 12 with radius of the effective aperture as the vertical axis and spherical aberration and the sine condition as the horizontal axis.

FIG. 30 shows a graph of Example 12 with radius of the effective aperture as the vertical axis and first-order derivative X′(h) of an aspheric surface shape of the optical surface facing the optical disc as the horizontal axis.

FIG. 31 shows a graph of Example 13 with radius of the effective aperture as the vertical axis and spherical aberration and the sine condition as the horizontal axis.

FIG. 32 shows a graph of Example 13 with radius of the effective aperture as the vertical axis and first-order derivative X′(h) of an aspheric surface shape of the optical surface facing the optical disc as the horizontal axis.

FIG. 33 shows a graph of Example 14 with radius of the effective aperture as the vertical axis and spherical aberration and the sine condition as the horizontal axis.

FIG. 34 shows a graph of Example 14 with radius of the effective aperture as the vertical axis and first-order derivative X′(h) of an aspheric surface shape of the optical surface facing the optical disc as the horizontal axis.

FIG. 35 shows a graph of Example 15 with radius of the effective aperture as the vertical axis and spherical aberration and the sine condition as the horizontal axis.

FIG. 36 shows a graph of Example 15 with radius of the effective aperture as the vertical axis and first-order derivative X′(h) of an aspheric surface shape of the optical surface facing the optical disc as the horizontal axis.

FIG. 37 shows a graph of Example 16 with radius of the effective aperture as the vertical axis and spherical aberration and the sine condition as the horizontal axis.

FIG. 38 shows a graph of Example 16 with radius of the effective aperture as the vertical axis and first-order derivative X′ (h) of an aspheric surface shape of the optical surface facing the optical disc as the horizontal axis.

FIG. 39 shows a diagram in which the comparative example and Examples 1 to 16 are plotted with refractive index N for wavelength λ1 at a normal temperature (25±3C.°) as the horizontal axis and inclination angle 9 (degree) of an optical surface facing the light source measured at a most periphery of an effective aperture of the optical surface as the vertical axis.

FIG. 40 is a diagram in which Examples 1 to 16 are plotted with refractive index N for wavelength λ1 at a normal temperature (25±3C.°) as the horizontal axis and inclination angle height H along a radius at which a first-order derivative X′(h) of a deformation amount of an aspheric surface X(h) of an optical surface thereof facing the optical disc switches from a negative value to a positive value as the vertical axis.

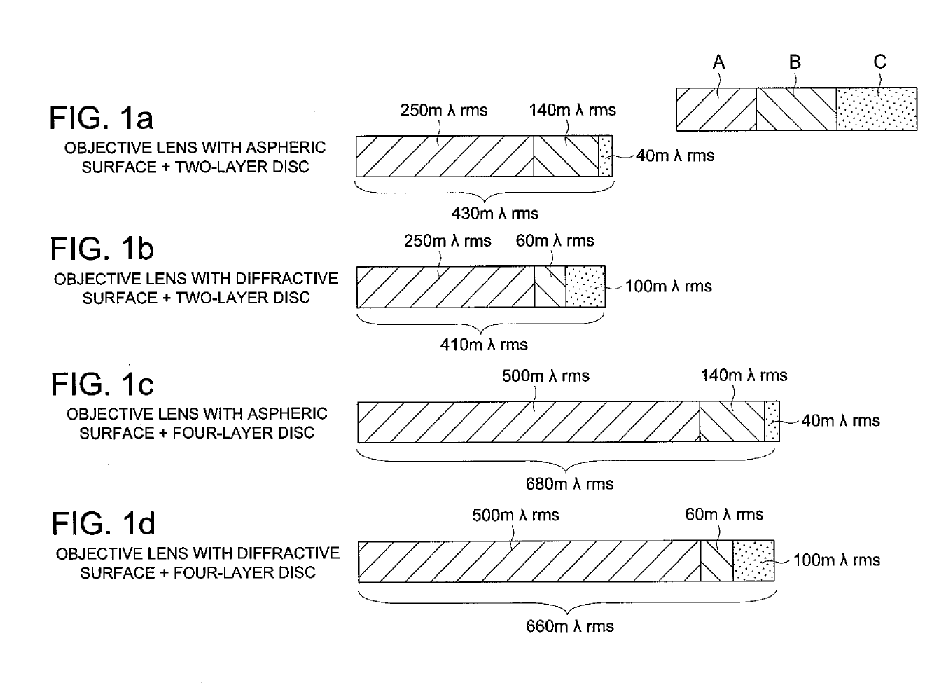

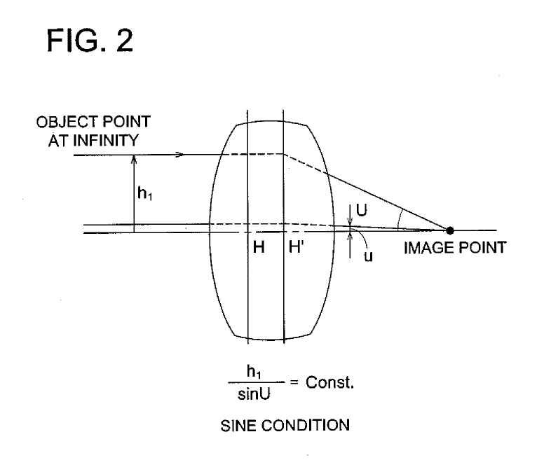

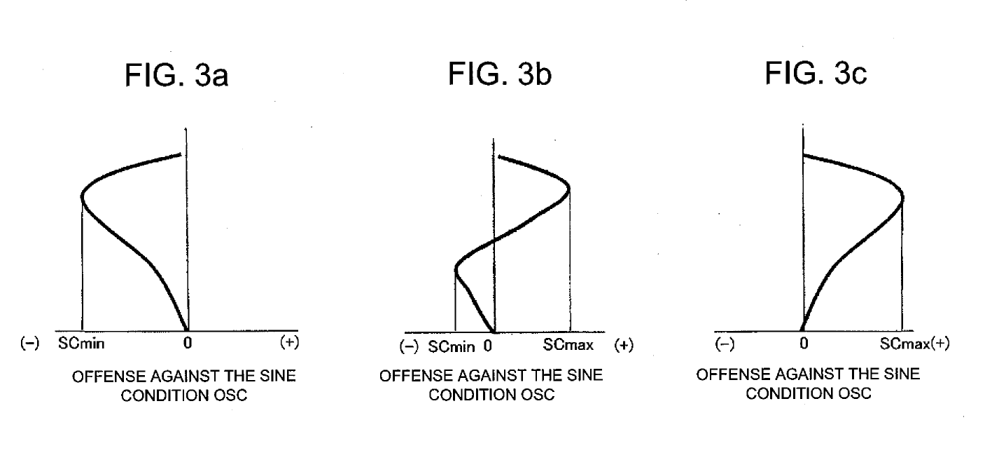

### DESCRIPTION OF EMBODIMENTS

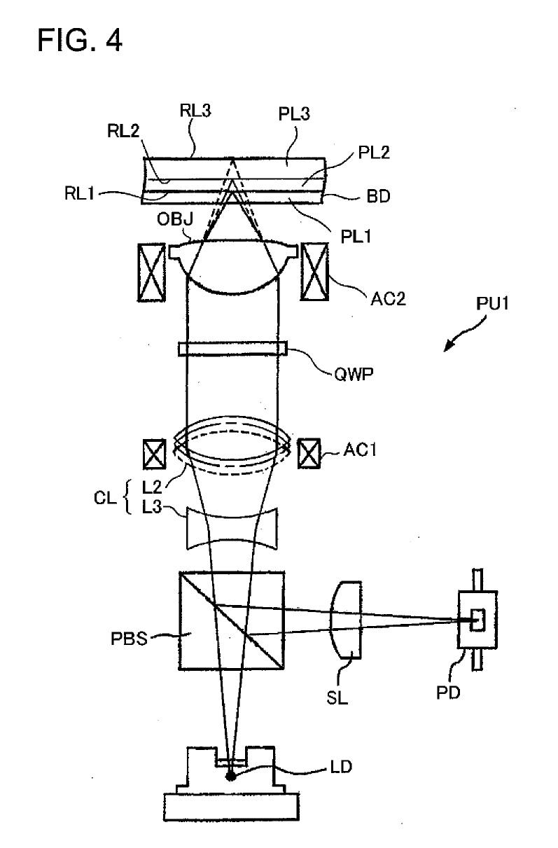

Referring to the drawings, the embodiment of the present invention will be described below. FIG. 4 is a diagram schematically showing a construction of the optical pickup device PU1 of the present embodiment capable of recording and/or reproducing information adequately for a BD which is an optical disc including three information recording surfaces RL1 to RL3 arranged in the thickness direction (where, RL1, RL2 and RL3 are arranged in order of shorter distance from the indent surface where a light flux enters of the optical disc). The optical pickup device PU1 can be mounted in the optical information recording and reproducing device. Hereupon, the present invention is not limited to the present embodiment. For example, FIG. 4 shows an optical pickup device for only BDs, but there can be provided an optical pickup device for a compatible use for BDs, DVDs and CDs by using objective lens OBJ for a compatible use for BDs, DVDs and CDs or using additional objective lens for DVDs and CDs.

Optical pickup device PU1 comprises objective lens OBJ, three-axis actuator AC2 for moving the objective lens OBJ in the focusing direction and the tracking direction and tilt the objective lens in the radial direction and the tangential direction of the optical disc, quarter wavelength plate QWP, coupling lens CL including positive lens group L2 composed of one positive lens with positive refractive power and negative lens group L3 composed of one negative lens with negative refractive power, one-axis actuator AC1 for moving only positive lens group L2 in the optical axis direction, polarization prism PBS, first semiconductor laser LD for emitting a laser light flux with wavelength of 405 nm (light flux), sensor lens SL, and light-receiving element PD as a light-receiving element for receiving a light flux reflected on each of information recording surfaces RL1 to RL3 of a BD. In the present embodiment, coupling lens CL is arranged between polarization prism PBS and quarter wavelength plate QWP. In the present embodiment, objective lens OBJ is a single lens made of plastic or glass.

First, the case that information is recorded/reproduced for first information recording surface RL1 of a BD will be described. In this case, positive lens group L2 of coupling lens CL is moved to the position represented by the solid line with one-axis actuator AC1. A light flux (λ1=405 nm) as a divergent light flux emitted from blue-violet semiconductor laser LD, as illustrated by solid lines, passes through polarization prism PBS. Its divergent angle is increased through negative lens group L3 of collimating lens CL, and the light flux is converted in to a weak-convergent light flux through positive lens group L2. Then, quarter wavelength plate QWP converts the polarization of the collimated light from linear polarization to circular polarization, and the diameter of the resulting light flux is regulated by an unillustrated stop. The resulting light flux is formed into a spot on first information recording surface RL1 as represented by the solid lines with objective lens OBJ through transparent substrate with the first thickness.

The light flux on first information recording surface RL1 is reflected and modulated by information pits on the first information recording surface RL1. The reflected light flux passes through objective lens OBJ and the unillustrated stop again, and quarter wavelength plate QWP converts the polarization of the light flux from circular polarization to linear polarization. Then, the light flux passes through positive lens group L2 and negative lens group L3 of collimation lens CL and is converted into a convergent light flux. The convergent light flux is reflected by polarization prism PBS and is converged on a light-receiving surface of light receiving element PD through sensor lens SN. Then, information recorded in first information recording surface RL1 can be read based on the output signal of light-receiving element PD, by performing focusing and tracking operations for objective lens OBJ using three-axis actuator AC2.

Next, the case that information is recorded/reproduced for second information recording surface RL2 of a BD will be described. In this case, positive lens group L2 of coupling lens CL is moved to the position represented by the long dashed dotted line with one-axis actuator AC1. A light flux (λ1=405 nm) as a divergent light flux emitted from blue-violet semiconductor laser LD, as illustrated by solid lines, passes through polarization prism PBS. Its divergent angle is increased through negative lens group L3 of collimating lens CL, and the light flux is converted in to a weak-convergent light flux through positive lens group L2. Then, quarter wavelength plate QWP converts the polarization of the collimated light from linear polarization to circular polarization, and the diameter of the resulting light flux is regulated by an unillustrated stop. The resulting light flux is formed into a spot on fast information recording surface RL1 as represented by the solid lines with objective lens OBJ through transparent substrate with the second thickness (which is thicker than the first thickness).

The light flux on second information recording surface RL2 is reflected and modulated by information pits on the second information recording surface RL2. The reflected light flux passes through objective lens OBJ and the unillustrated stop again, and quarter wavelength plate QWP converts the polarization of the light flux from circular polarization to linear polarization. Then, the light flux passes through positive lens group L2 and negative lens group L3 of collimation lens CL and is converted into a convergent light flux. The convergent light flux is reflected by polarization prism PBS and is converged on a light-receiving surface of light receiving element PD through sensor lens SN. Then, information recorded in the second information recording surface RL2 can be read based on the output signal of light-receiving element PD, by performing focusing and tracking operations for objective lens OBJ using three-axis actuator AC2.

Next, the case that information is recorded/reproduced for third information recording surface RL3 of a BD will be described. In this case, positive lens group L2 of coupling lens CL is moved to the position represented by the dotted line with one-axis actuator AC1. A light flux (λ1=405 nm) as a divergent light flux emitted from blue-violet semiconductor laser LD, as illustrated by solid lines, passes through polarization prism PBS. Its divergent angle is increased through negative lens group L3 of collimating lens CL, and the light flux is converted in to a weak-convergent light flux through positive lens group L2. Then, quarter wavelength plate QWP converts the polarization of the collimated light from linear polarization to circular polarization, and the diameter of the resulting light flux is regulated by an unillustrated stop. The resulting light flux is formed into a spot on first information recording surface RL1 as represented by the solid lines with objective lens OBJ through transparent substrate with the third thickness (which is thicker than second first thickness).

The light flux on third information recording surface RL3 is reflected and modulated by information pits on the second information recording surface RL3. The reflected light flux passes through objective lens OBJ and the unillustrated stop again, and quarter wavelength plate QWP converts the polarization of the light flux from circular polarization to linear polarization. Then, the light flux passes through positive lens group L2 and negative lens group L3 of collimation lens CL and is converted into a convergent light flux. The convergent light flux is reflected by polarization prism PBS and is converged on a light-receiving surface of light receiving element PD through sensor lens SN. Then, information recorded in the third information recording surface RL3 can be read based on the output signal of light-receiving element PD, by performing focusing and tracking operations for objective lens OBJ using three-axis actuator AC2.

Further, when information is recorded and/or reproduced for an optical disc in the above embodiment, the objective lens OBJ is tilted with three-axis actuator AC2 in the direction of the radial direction and/or the tangential direction of the optical disc in order to correct coma generated because of a warp or tilt of the optical disc. Thereby, information can be recorded and/or reproduced stably for an optical disc with a warp and quality of a spot formed on an information recording surface can be maintained excellently even when the optical disc is tilted during its rotation.

### EXAMPLES

Next, examples which are applicable to the above embodiments will be described. The design wavelength of the objective lens is defined as 405 nm. In the following tables, r represents curvature radius, d represents a distance in the optical axis direction from the i-th surface to the (i+1)-th surface, Nd represents refractive index of each surface at the d-line (587.6 nm), N405 represents refractive index of each surface at the design wavelength 405 nm, and νd represents the Abbe number at the d-line. In the following descriptions (including data of Tables), the power of 10 (for example, 2.5×10⁻⁰³) will be expressed as by using “E” (for example, 2.5E-03). Each of the optical surfaces of the objective lens is formed into an aspheric surface which is axial symmetry with respect to the optical axis and is defined by a mathematical expression forming by substituting values of coefficients shown in Table 1 in the expression Math. 1.

$$X ( h ) = \frac{( {h}^{2} / r )}{1 + ) \overline{1 - ( 1 + κ ) {( h / r )}^{2}}} + {\sum }_{i = 0}^{10} {A}_{2 i} {h}^{2 i} \qquad [ Math . 1 ]$$

In the expression, X(h) represents the axis in the optical axis direction (where the direction that light travels is defined as positive), x represents a conic constant, A₂ᵢ represents an aspheric coefficient, h represents a height from the optical axis, and r represents an paraxial curvature radius.

### Comparative Example

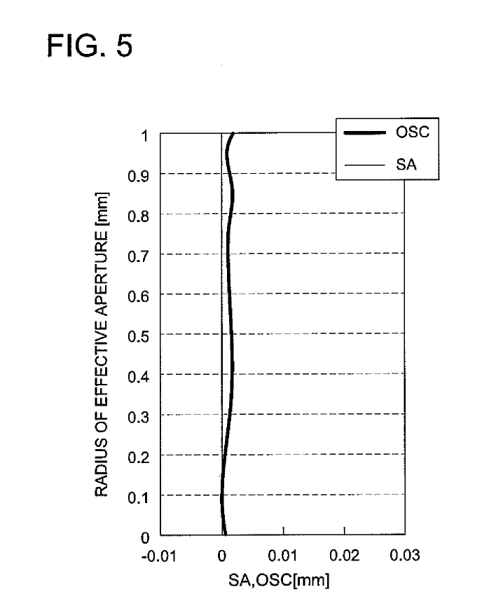

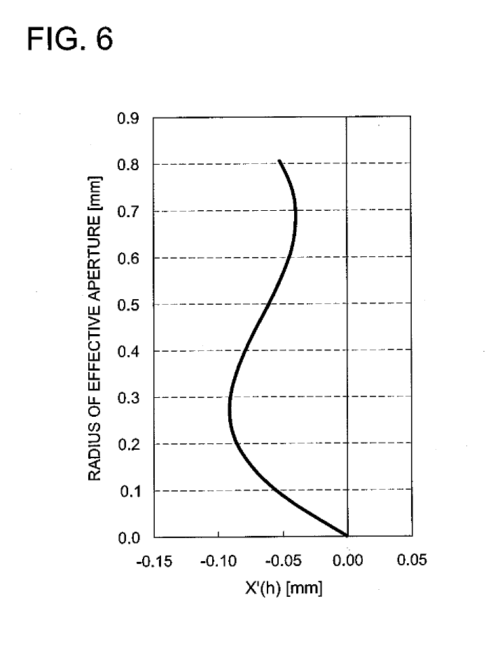

Before the Examples, comparative example will be described. Table 1 shows data of the objective lens of the comparative example. The comparative example provides an objective lens made of a plastic material for handling a two-layer BD having two information recording surfaces (T_{MAX}=0.1 mm, T_{MIN}=0.075 mm). Dependence of refractive index of the plastic material of Comparative example and following Examples on temperature (refractive index change corresponding to temperature change) has been defined as −10×10⁻⁵/° C. FIG. 5 shows curves of the spherical aberration and the sine condition of the comparative example, and FIG. 6 shows a curve of first-order derivative of an aspheric surface shape of the optical surface facing the optical disc of Comparative example. As shown in FIG. 5, in the objective lens of the comparative example, the offence against the sine condition OSC is almost zero, in other words, the objective lens is designed so as to satisfy the sine condition.

TABLE 1
Comparative Example
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94578 | 1.75000 | 1.54500 | N2 | 56 | Objective lens |
| 3 | −1.63827 | 0.41768 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0042 | −0.0074 | 0.0044 |
| Temperature | 25 | 25 | 55 | 25 |
| d0 | ∞ | 335.00000 | 191.50000 | −320.00000 |
| d4 | 0.0875 | 0.100 | 0.100 | 0.075 |
| N2 | 1.561516 | 1.561516 | 1.558517 | 1.561516 |

Aspheric coefficients

| | Second surface | Third surface |
|---|---|---|
| κ | −5.73488E−01 | −4.65899E+01 |
| A4 | 2.20061E−02 | 2.96500E−01 |
| A6 | −2.12576E−02 | −6.21179E−01 |
| A8 | 8.09635E−02 | 9.78657E−01 |
| A10 | −1.17809E−01 | −1.39902E+00 |
| A12 | 6.33199E−02 | 1.41676E+00 |
| A14 | 7.45924E−02 | −8.20375E−01 |
| A16 | −1.41828E−01 | 1.99134E−01 |
| A18 | 8.82576E−02 | 0.00000E+00 |
| A20 | −2.04154E−02 | 0.00000E+00 |

### Example 1

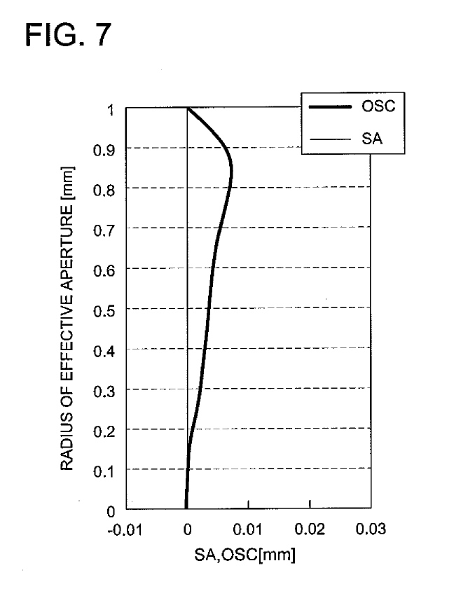

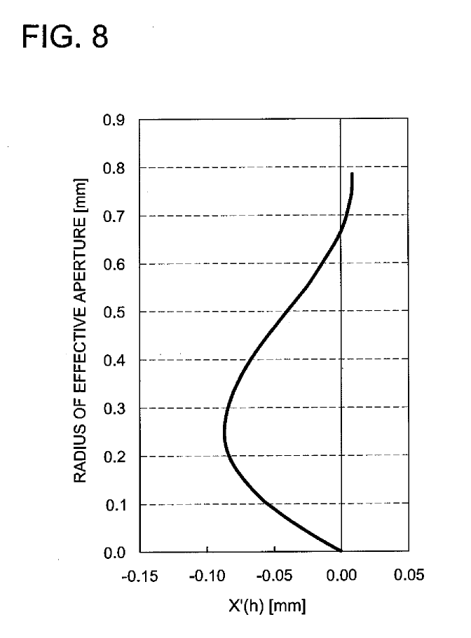

Table 2 shows lens data of Example 1. The present example provides an objective lens made of plastic for handling a multilayered BD having three or more information recording surfaces (T_{MAX}=0.1 mm, T_{MIN}=0.05 mm). It has been defined that T=0.075 mm holds (which corresponds to d4 in the base condition). FIG. 7 shows curves of the spherical aberration and the sine condition of the comparative example, and FIG. 8 shows a curve of first-order derivative of an aspheric surface shape of the optical surface facing the optical disc of Example 1. As shown in FIG. 7, in the objective lens of the comparative example, the offence against the sine condition OSC has the positive maximum value at the position of 84% of the radius of the effective aperture. On the other hand, the sine condition OSC does not have a negative maximum value.

TABLE 2
Example 1
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94308 | 1.75000 | 1.54500 | N2 | 56 | Objective lens |
| 3 | −1.65466 | 0.42286 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0079 | −0.0107 | 0.0086 |
| Temperature | 25 | 25 | 55 | 25 |
| d0 | ∞ | 180.00000 | 133.50000 | −163.00000 |
| d4 | 0.075 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.65145E−01 | −4.88574E+01 |
| A4 | 2.08344E−02 | 3.35199E−01 |
| A6 | −1.87763E−02 | −6.19971E−01 |
| A8 | 7.75569E−02 | 9.59282E−01 |
| A10 | −1.15268E−01 | −1.41848E+00 |
| A12 | 6.49975E−02 | 1.43304E+00 |
| A14 | 7.42839E−02 | −7.67192E−01 |
| A16 | −1.42610E−01 | 1.57412E−01 |
| A18 | 8.82029E−02 | 0.00000E+00 |
| A20 | −1.98053E−02 | 0.00000E+00 |

### Example 2

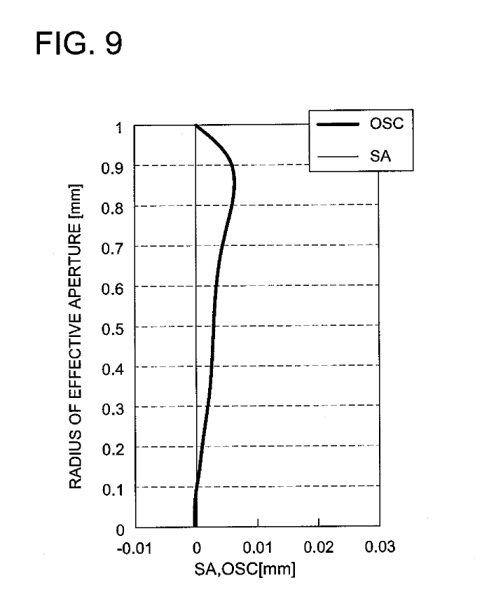

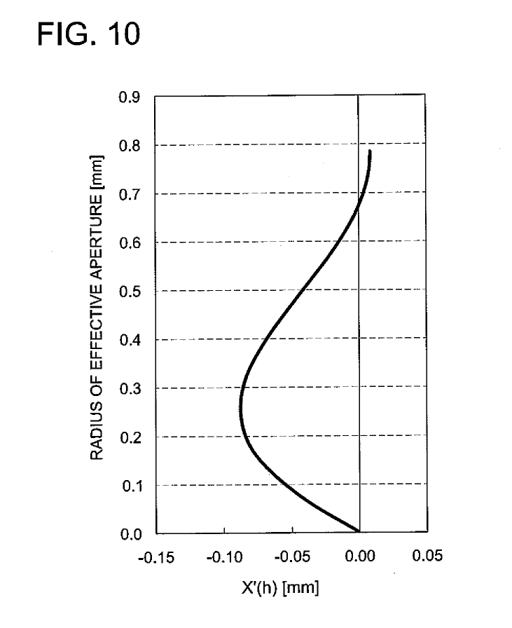

Table 3 shows lens data of Example 2. The present example provides an objective lens made of plastic for handling a multilayered BD having three or more information recording surfaces (T_{MAX}=0.1 mm, T_{MIN}=0.05 mm). It has been defined that T=0.08 mm holds (which corresponds to d4 in the base condition). FIG. 9 shows curves of the spherical aberration and the sine condition of the comparative example, and FIG. 10 shows a curve of first-order derivative of an aspheric surface shape of the optical surface facing the optical disc of Example 2. As shown in FIG. 9, in the objective lens of the comparative example, the offence against the sine condition OSC has the positive maximum value at the position of 85% of the radius of the effective aperture. On the other hand, the sine condition OSC does not have a negative maximum value.

TABLE 3
Example 2
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94318 | 1.75000 | 1.54500 | N2 | 56 | Objective lens |
| 3 | −1.65343 | 0.41987 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0064 | −0.0094 | 0.0106 |
| Temperature | 25 | 25 | 55 | 25 |
| d0 | ∞ | 220.00000 | 151.50000 | −132.50000 |
| d4 | 0.080 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.67213E−01 | −4.82773E+01 |
| A4 | 2.09249E−02 | 3.26774E−01 |
| A6 | −1.86919E−02 | −6.03647E−01 |
| A8 | 7.75877E−02 | 9.53021E−01 |
| A10 | −1.15107E−01 | −1.42657E+00 |
| A12 | 6.37551E−02 | 1.43774E+00 |
| A14 | 7.59267E−02 | −7.63612E−01 |
| A16 | −1.43291E−01 | 1.55035E−01 |
| A18 | 8.80306E−02 | 0.00000E+00 |
| A20 | −1.96556E−02 | 0.00000E+00 |

### Example 3

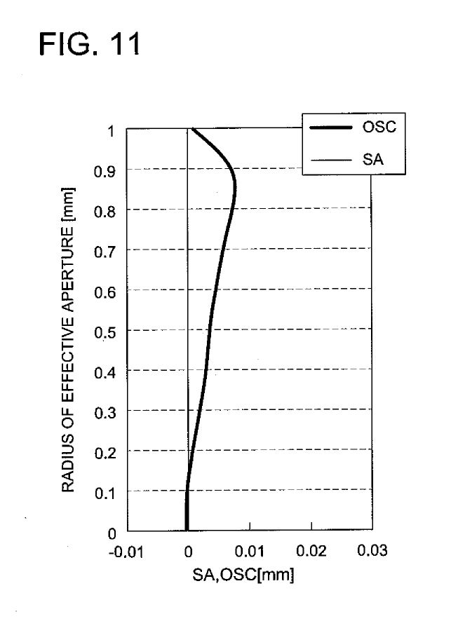

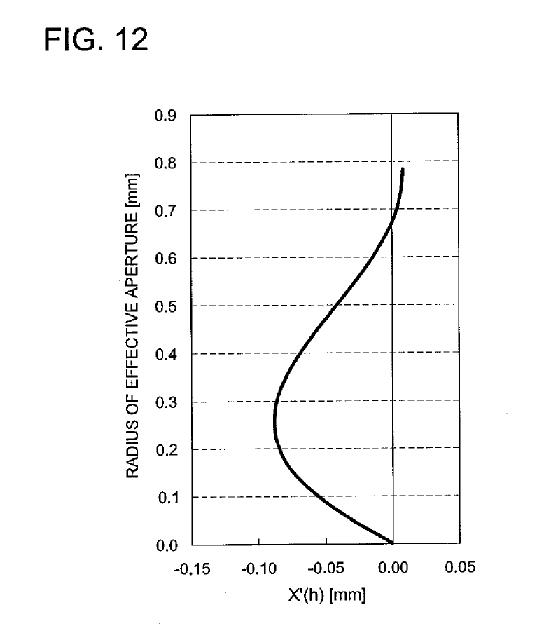

Table 4 shows lens data of Example 3. The present example provides an objective lens made of plastic for handling a multilayered BD having three or more information recording surfaces (T_{MAX}=0.1 mm, T_{MIN}=0.05 mm). It has been defined that T=0.085 mm holds (which corresponds to d4 in the base condition). FIG. 11 shows curves of the spherical aberration and the sine condition of Example 3, and FIG. 12 shows a curve of first-order derivative of an aspheric surface shape of the optical surface facing the optical disc of Example 3. As shown in FIG. 11, in the objective lens of the comparative example, the offence against the sine condition OSC has the positive maximum value at the position of 85% of the radius of the effective aperture. On the other hand, the sine condition OSC does not have a negative maximum value.

TABLE 4
Example 3
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94462 | 1.75000 | 1.54500 | N2 | 56 | Objective lens |
| 3 | −1.63993 | 0.41794 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0048 | −0.0078 | 0.0123 |
| Temperature | 25 | 25 | 55 | 25 |
| d0 | ∞ | 293.00000 | 183.00000 | −113.50000 |
| d4 | 0.085 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.65139E−01 | −4.73530E+01 |
| A4 | 2.08386E−02 | 3.35233E−01 |
| A6 | −1.87762E−02 | −6.19827E−01 |
| A8 | 7.75555E−02 | 9.59079E−01 |
| A10 | −1.15261E−01 | −1.41873E+00 |
| A12 | 6.49999E−02 | 1.43296E+00 |
| A14 | 7.42792E−02 | −7.66994E−01 |
| A16 | −1.42617E−01 | 1.57402E−01 |
| A18 | 8.81987E−02 | 0.00000E+00 |
| A20 | −1.98069E−02 | 0.00000E+00 |

### Example 4

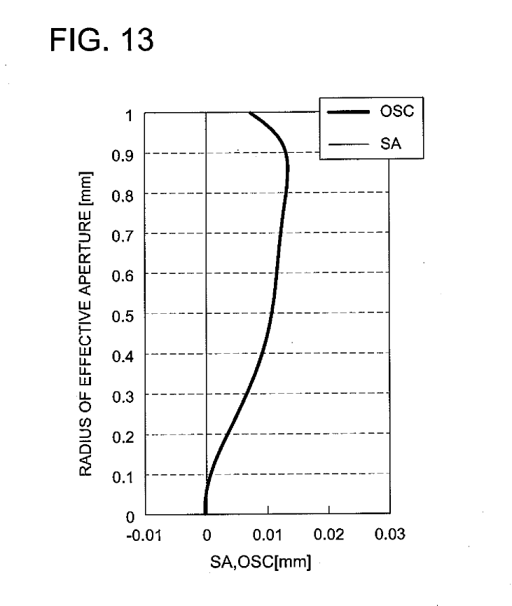

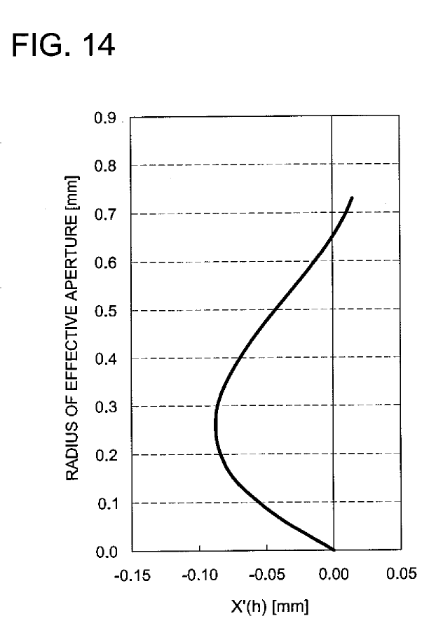

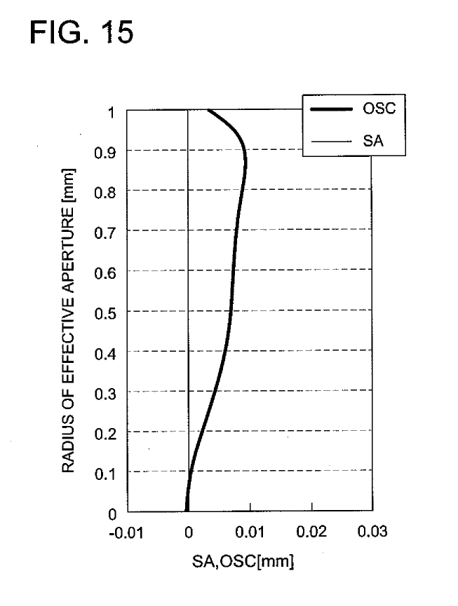

Table 5 shows lens data of Example 4. The present example provides an objective lens made of plastic for handling a multilayered BD having three or more information recording surfaces (T_{MAX}=0.1 mm, T=0.05 mm). It has been defined that T=0.090 mm holds (which corresponds to d4 in the base condition). FIG. 13 shows curves of the spherical aberration and the sine condition of Example 4, and FIG. 14 shows a curve of first-order derivative of an aspheric surface shape of the optical surface facing the optical disc of Example 4. As shown in FIG. 13, in the objective lens of the comparative example, the offence against the sine condition OSC has the positive maximum value at the position of 85% of the radius of the effective aperture. On the other hand, the sine condition OSC does not have a negative maximum value.

TABLE 5
Example 4
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94677 | 1.75000 | 1.54500 | N2 | 56 | Objective lens |
| 3 | −1.59534 | 0.41576 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0032 | −0.0063 | 0.0142 |
| Temperature | 25 | 25 | 55 | 25 |
| d0 | ∞ | 437.00000 | 225.00000 | −98.00000 |
| d4 | 0.090 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.65139E−01 | −4.73530E+01 |
| A4 | 2.08386E−02 | 3.35233E−01 |
| A6 | −1.87762E−02 | −6.19827E−01 |
| A8 | 7.75555E−02 | 9.59079E−01 |
| A10 | −1.15261E−01 | −1.41873E+00 |
| A12 | 6.49999E−02 | 1.43296E+00 |
| A14 | 7.42792E−02 | −7.66994E−01 |
| A16 | −1.42617E−01 | 1.57402E−01 |
| A18 | 8.81987E−02 | 0.00000E+00 |
| A20 | −1.98069E−02 | 0.00000E+00 |

### Example 5

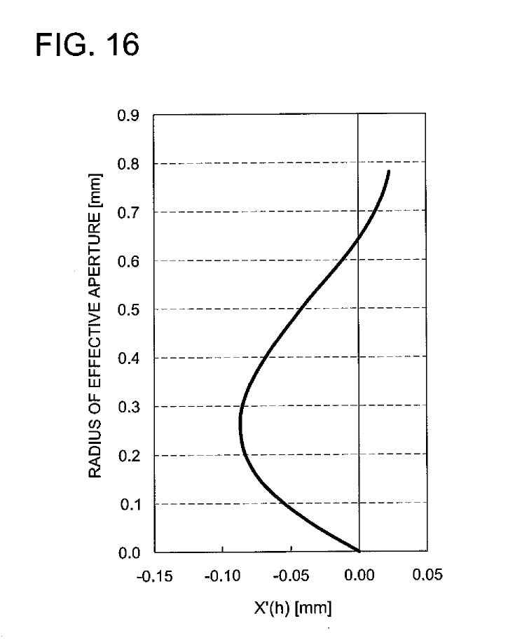

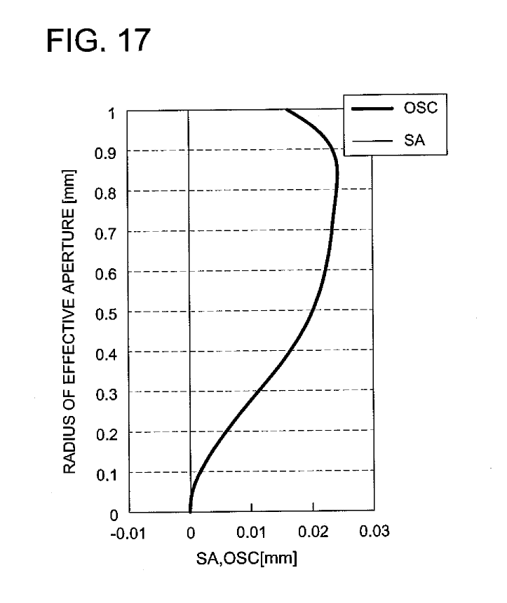

Table 6 shows lens data of Example 5. The present example provides an objective lens made of plastic for handling a multilayered BD having three or more information recording surfaces (T_{MAX}=0.1 mm, T_{MIN}=0.05 mm). It has been defined that T=0.095 mm holds (which corresponds to d4 in the base condition). FIG. 16 shows curves of the spherical aberration and the sine condition of Example 5, and FIG. 17 shows a curve of first-order derivative of an aspheric surface shape of the optical surface facing the optical disc of Example 5. As shown in FIG. 16, in the objective lens of the comparative example, the offence against the sine condition OSC has the positive maximum value at the position of 86% of the radius of the effective aperture. On the other hand, the sine condition OSC does not have a negative maximum value.

TABLE 6
Example 5
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94584 | 1.75000 | 1.54500 | N2 | 56 | Objective lens |
| 3 | −1.61717 | 0.41243 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0016 | −0.0048 | 0.0164 |
| Temperature | 25 | 25 | 55 | 25 |
| d0 | ∞ | 860.00000 | 293.00000 | −85.00000 |
| d4 | 0.095 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.50735E−01 | −5.23155E+01 |
| A4 | 1.98626E−02 | 3.04136E−01 |
| A6 | −1.83819E−02 | −5.74706E−01 |
| A8 | 7.45802E−02 | 1.02686E+00 |
| A10 | −1.15913E−01 | −1.51875E+00 |
| A12 | 6.69122E−02 | 1.29063E+00 |
| A14 | 7.44058E−02 | −4.67646E−01 |
| A16 | −1.43644E−01 | 2.09089E−02 |
| A18 | 8.77657E−02 | 0.00000E+00 |
| A20 | −1.92058E−02 | 0.00000E+00 |

### Example 6

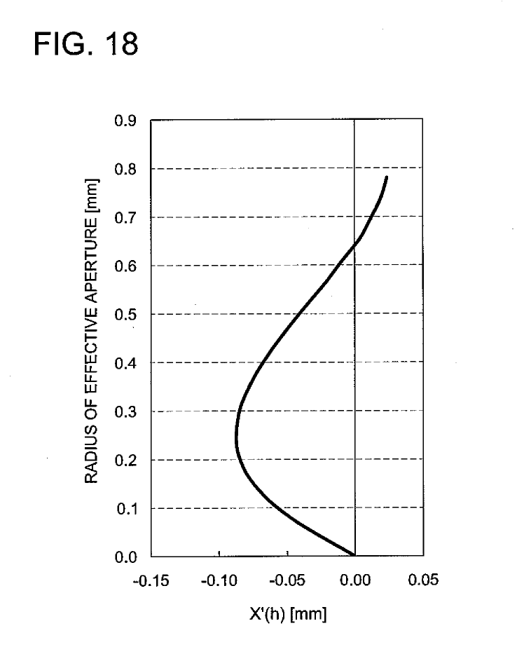

Table 7 shows lens data of Example 6. The present example provides an objective lens made of plastic for handling a multilayered BD having three or more information recording surfaces (T_{MAX}=0.1 min, T_{MIN}=0.05 mm). It has been defined that T=0.1 mm holds (which corresponds to d4 in the base condition). FIG. 17 shows curves of the spherical aberration and the sine condition of Example 6, and FIG. 18 shows a curve of first-order derivative of an aspheric surface shape of the optical surface facing the optical disc of Example 6. As shown in FIG. 17, in the objective lens of the comparative example, the offence against the sine condition OSC has the positive maximum value at the position of 83% of the radius of the effective aperture. On the other hand, the sine condition OSC does not have a negative maximum value.

TABLE 7
Example 6
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.95247 | 1.75000 | 1.54500 | N2 | 56 | Objective lens |
| 3 | −1.51938 | 0.41273 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | 0.0000 | −0.0031 | 0.0175 |
| Temperature | 25 | 25 | 55 | 25 |
| d0 | ∞ | ∞ | 455.00000 | −79.30000 |
| d4 | 0.100 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.49501E−01 | −5.78177E+01 |
| A4 | 2.41171E−02 | 2.99760E−01 |
| A6 | −2.03344E−02 | −5.74646E−01 |
| A8 | 7.54780E−02 | 1.03104E+00 |
| A10 | −1.15291E−01 | −1.52077E+00 |
| A12 | 6.68640E−02 | 1.28869E+00 |
| A14 | 7.42181E−02 | −4.64461E−01 |
| A16 | −1.43705E−01 | 1.91846E−02 |
| A18 | 8.77731E−02 | 0.00000E+00 |
| A20 | −1.91631E−02 | 0.00000E+00 |

### Example 7

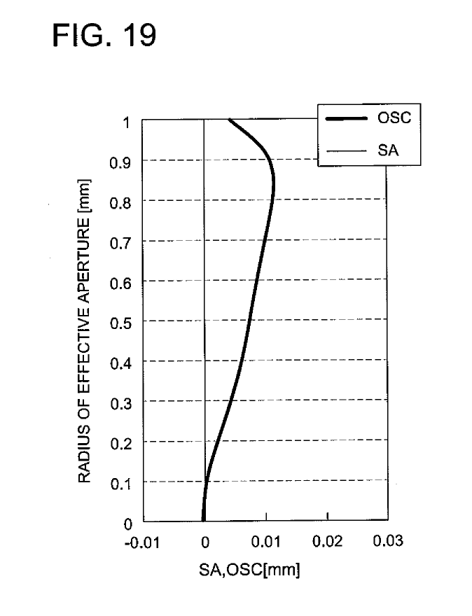

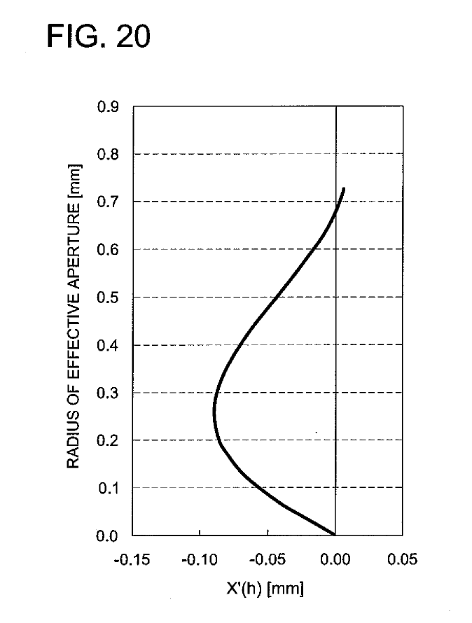

Table 8 shows lens data of Example 7. The present example provides an objective lens made of plastic for handling a multilayered BD having three or more information recording surfaces (T_{MAX}=0.1 mm, T_{MIN}=0.05 mm). It has been defined that T=0.11 mm holds (which corresponds to d4 in the base condition). FIG. 19 shows curves of the spherical aberration and the sine condition of Example 7, and FIG. 20 shows a curve of first-order derivative of an aspheric surface shape of the optical surface facing the optical disc of Example 7. As shown in FIG. 19, in the objective lens of the comparative example, the offence against the sine condition OSC has the positive maximum value at the position of 84% of the radius of the effective aperture. On the other hand, the sine condition OSC does not have a negative maximum value.

TABLE 8
Example 7
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94862 | 1.75000 | 1.54500 | N2 | 56 | Objective lens |
| 3 | −1.59585 | 0.40559 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | 0.0034 | 0.0001 | 0.0223 |
| Temperature | 25 | 25 | 55 | 25 |
| d0 | ∞ | −420.00000 | −15000.00000 | −62.20000 |
| d4 | 0.110 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.68149E−01 | −4.76123E+01 |
| A4 | 2.19891E−02 | 3.23686E−01 |
| A6 | −1.73397E−02 | −5.95837E−01 |
| A8 | 7.64665E−02 | 9.54365E−01 |
| A10 | −1.15858E−01 | −1.43084E+00 |
| A12 | 6.64423E−02 | 1.41428E+00 |
| A14 | 7.44510E−02 | −7.22526E−01 |
| A16 | −1.43163E−01 | 1.36400E−01 |
| A18 | 8.78955E−02 | 0.00000E+00 |
| A20 | −1.94937E−02 | 0.00000E+00 |

### Example 8

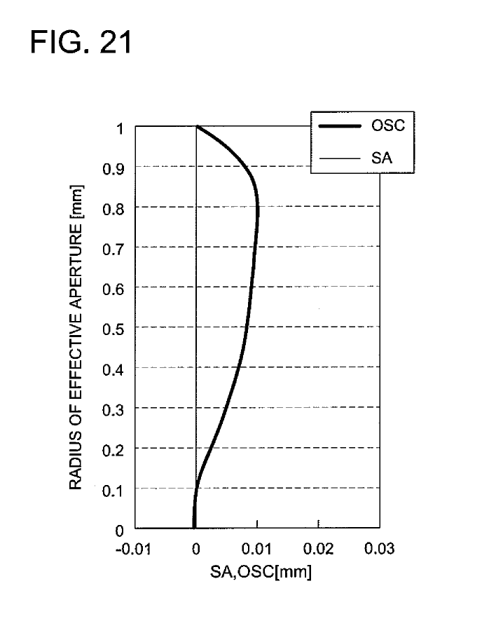

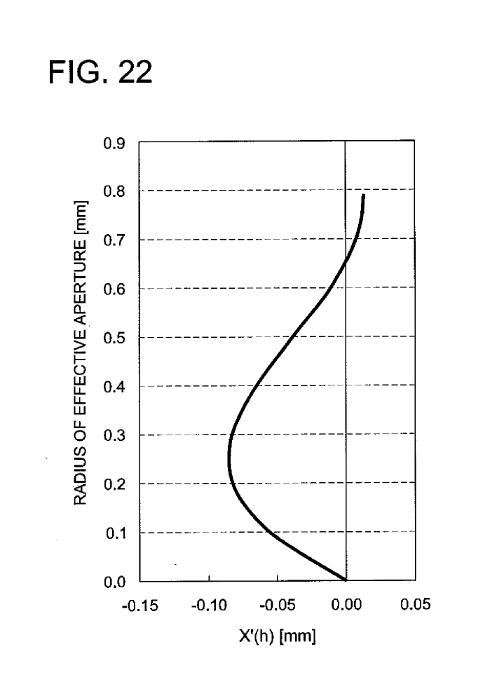

Table 9 shows lens data of Example 8. The present example provides an objective lens made of plastic for handling a multilayered BD having three or more information recording surfaces (T_{MAX}=0.1 mm, T_{MIN}=0.05 mm). It has been defined that T=0.090 mm holds (which corresponds to d4 in the base condition). FIG. 21 shows curves of the spherical aberration and the sine condition of Example 8, and FIG. 22 shows a curve of first-order derivative of an aspheric surface shape of the optical surface facing the optical disc of Example 8. As shown in FIG. 21, in the objective lens of the comparative example, the offence against the sine condition OSC has the positive maximum value at the position of 79% of the radius of the effective aperture. On the other hand, the sine condition OSC does not have a negative maximum value.

TABLE 9
Example 8
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94623 | 1.75000 | 1.54500 | N2 | 56 | Objective lens |
| 3 | −1.63661 | 0.41692 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0031 | −0.0059 | 0.0137 |
| Temperature | 25 | 25 | 55 | 25 |
| d0 | ∞ | 455.00000 | 240.00000 | −102.50000 |
| d4 | 0.090 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.60704E−01 | −5.36575E+01 |
| A4 | 2.17147E−02 | 3.26612E−01 |
| A6 | −1.76702E−02 | −6.16966E−01 |
| A8 | 7.56906E−02 | 9.76306E−01 |
| A10 | −1.14870E−01 | −1.42425E+00 |
| A12 | 6.58213E−02 | 1.40733E+00 |
| A14 | 7.42896E−02 | −7.43465E−01 |
| A16 | −1.43050E−01 | 1.52794E−01 |
| A18 | 8.79719E−02 | 0.00000E+00 |
| A20 | −1.95525E−02 | 0.00000E+00 |

### Example 9

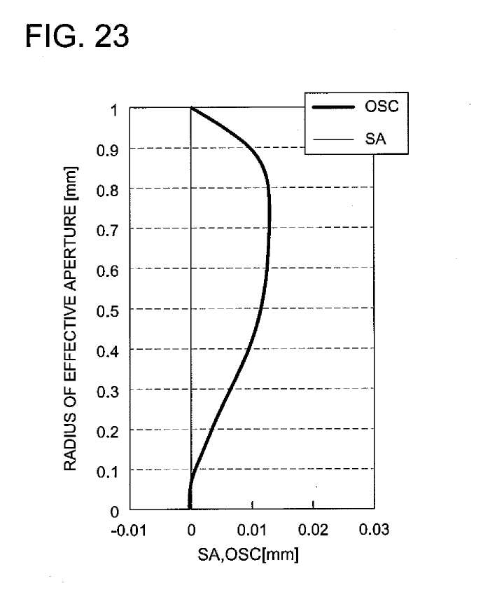

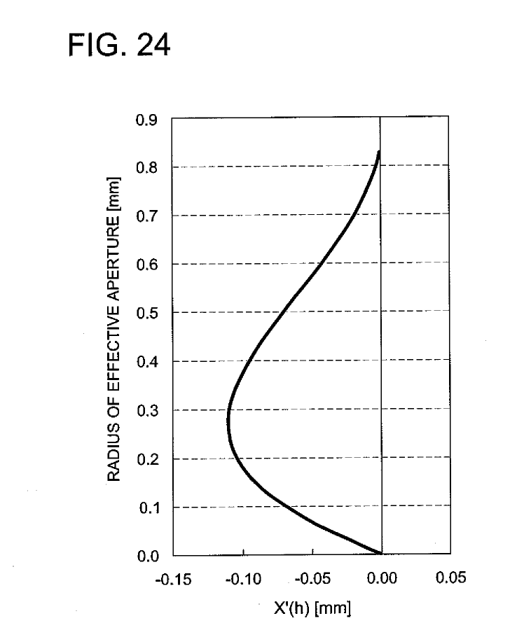

Table 10 shows lens data of Example 9. The present example provides an objective lens made of plastic for handling a multilayered BD having three or more information recording surfaces (T_{MAX}=0.1 mm, T_{MIN}=0.05 mm). It has been defined that T=0.090 mm holds (which corresponds to d4 in the base condition). In the present example, the value of off-axis coma is larger than that of Example 8. FIG. 23 shows curves of the spherical aberration and the sine condition of Example 9, and FIG. 24 shows a curve of first-order derivative of an aspheric surface shape of the optical surface facing the optical disc of Example 9. As shown in FIG. 23, in the objective lens of Example 9, the offence against the sine condition OSC has the positive maximum value at the position of 72% of the radius of the effective aperture. On the other hand, the sine condition OSC does not have a negative maximum value.

TABLE 10
Example 9
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.91651 | 1.75000 | 1.51000 | N2 | 56 | Objective lens |
| 3 | −1.33231 | 0.42740 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0030 | −0.0064 | 0.0132 |
| Temperature | 25 | 25 | 55 | 25 |
| d0 | ∞ | 468.00000 | 224.00000 | −106.00000 |
| d4 | 0.090 | 0.100 | 0.100 | 0.050 |
| N2 | 1.525455 | 1.525455 | 1.522457 | 1.525455 |

Aspheric coefficients

| | Second surface | Third surface |
|---|---|---|
| κ | −5.52843E−01 | −3.56957E+01 |
| A4 | 2.00035E−02 | 3.09574E−01 |
| A6 | −1.94092E−02 | −5.91256E−01 |
| A8 | 7.49836E−02 | 9.86079E−01 |
| A10 | −1.14901E−01 | −1.43138E+00 |
| A12 | 6.58817E−02 | 1.40638E+00 |
| A14 | 7.42531E−02 | −7.71792E−01 |
| A16 | −1.43125E−01 | 1.77365E−01 |
| A18 | 8.79626E−02 | 0.00000E+00 |
| A20 | −1.94632E−02 | 0.00000E+00 |

### Example 10

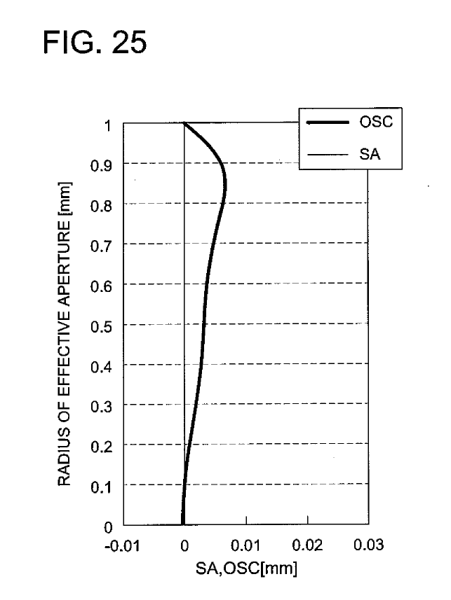

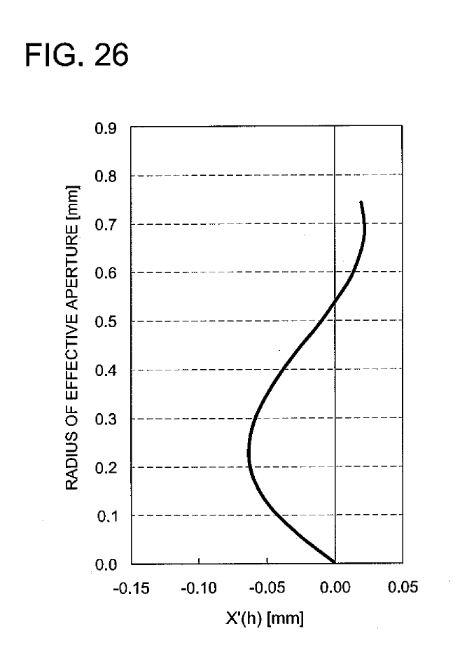

Table 11 shows lens data of Example 10. The present example provides an objective lens made of glass for handling a multilayered BD having three or more information recording surfaces (T_{MAX}=0.1 mm, T=0.05 mm). The material is SK5 (a product of OHARA INC.). It has been defined that T=0.075 mm holds (which corresponds to d4 in the base condition). FIG. 25 shows curves of the spherical aberration and the sine condition of Example 10, and FIG. 26 shows a curve of first-order derivative of an aspheric surface shape of the optical surface facing the optical disc of Example 10. As shown in FIG. 26, in the objective lens of Example 10, the offence against the sine condition OSC has the positive maximum value at the position of 85% of the radius of the effective aperture. On the other hand, the sine condition OSC does not have a negative maximum value.

TABLE 11
Example 10
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.97882 | 1.75000 | 1.58913 | N2 | 61.3 | Objective lens |
| 3 | −2.19100 | 0.41326 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0080 | −0.0080 | 0.0087 |
| Temperature | 25 | 25 | 55 | 25 |
| d0 | ∞ | 178.00000 | 178.00000 | −161.00000 |
| d4 | 0.075 | 0.100 | 0.100 | 0.050 |
| N2 | 1.605245 | 1.605245 | 1.605245 | 1.605245 |

Aspheric coefficients

| | Second surface | Third surface |
|---|---|---|
| κ | −5.62680E−01 | −9.03961E+01 |
| A4 | 2.11247E−02 | 3.44234E−01 |
| A6 | −1.72536E−02 | −6.38672E−01 |
| A8 | 7.63079E−02 | 9.24875E−01 |
| A10 | −1.15316E−01 | −1.42073E+00 |
| A12 | 6.51910E−02 | 1.45887E+00 |
| A14 | 7.42755E−02 | −6.81554E−01 |
| A16 | −1.42782E−01 | 6.60546E−02 |
| A18 | 8.81008E−02 | 0.00000E+00 |
| A20 | −1.98441E−02 | 0.00000E+00 |

### Example 11

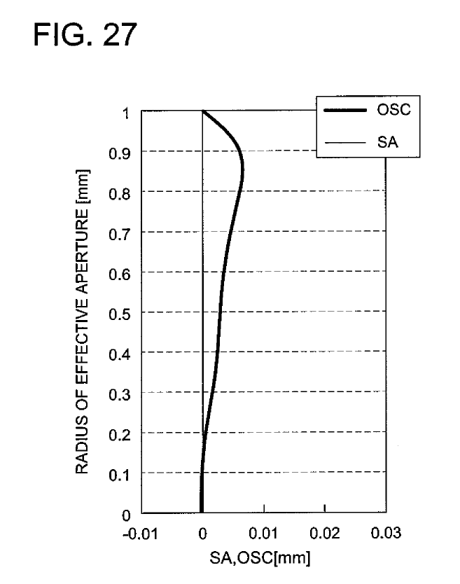

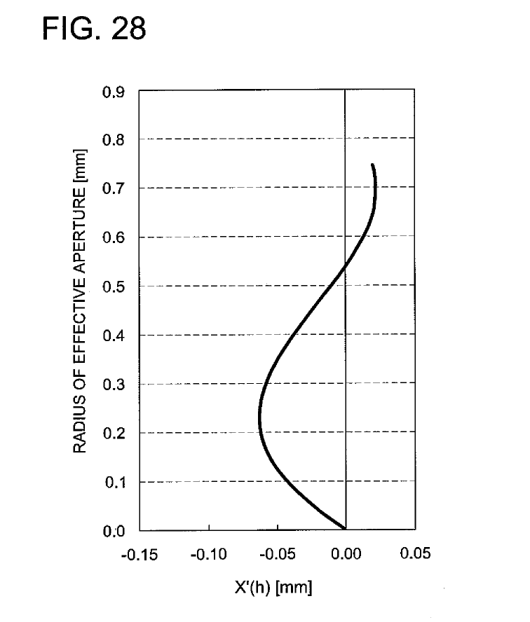

Table 12 shows lens data of Example 11. The present example provides an objective lens made of glass for handling a multilayered BD having three or more information recording surfaces (T_{MAX}=0.1 mm, T_{MIN}=0.05 mm). The material is SK5 (a product of OHARA INC.). It has been defined that T=0.08 mm holds (which corresponds to d4 in the base condition). FIG. 27 shows curves of the spherical aberration and the sine condition of Example 11, and FIG. 28 shows a curve of first-order derivative of an aspheric surface shape of the optical surface facing the optical disc of Example 11. As shown in FIG. 28, in the objective lens of Example 11, the offence against the sine condition OSC has the positive maximum value at the position of 85% of the radius of the effective aperture. On the other hand, the sine condition OSC does not have a negative maximum value.

TABLE 12
Example 11
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.97485 | 1.75000 | 1.58313 | N2 | 59.5 | Objective lens |
| 3 | −2.10457 | 0.41186 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0064 | −0.0064 | 0.0105 |
| Temperature | 25 | 25 | 55 | 25 |
| d0 | ∞ | 221.00000 | 221.00000 | −133.00000 |
| d4 | 0.080 | 0.100 | 0.100 | 0.050 |
| N2 | 1.599656 | 1.599656 | 1.599656 | 1.599656 |

Aspheric coefficients

| | Second surface | Third surface |
|---|---|---|
| κ | −5.62442E−01 | −8.17989E+01 |
| A4 | 2.09677E−02 | 3.43973E−01 |
| A6 | −1.71893E−02 | −6.32914E−01 |
| A8 | 7.62026E−02 | 9.29716E−01 |
| A10 | −1.15214E−01 | −1.42730E+00 |
| A12 | 6.52881E−02 | 1.44789E+00 |
| A14 | 7.42810E−02 | −6.66392E−01 |
| A16 | −1.42819E−01 | 6.32131E−02 |
| A18 | 8.80981E−02 | 0.00000E+00 |
| A20 | −1.98051E−02 | 0.00000E+00 |

### Example 12

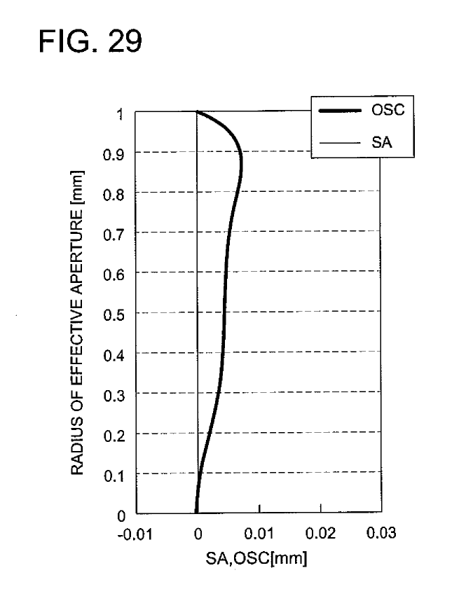

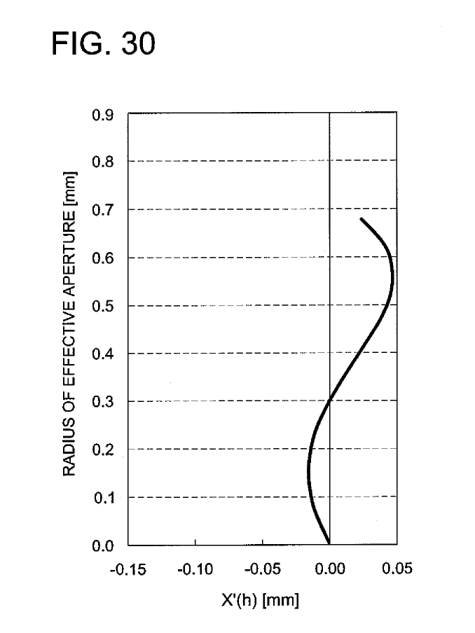

Table 13 shows lens data of Example 12. The present example provides an objective lens made of glass for handling a multilayered BD having three or more information recording surfaces (T_{MAX}=0.1 mm, T_{MIN}=0.05 mm). The material is LAC13 (a product of OHARA INC.). It has been defined that T=0.095 mm holds (which corresponds to d4 in the base condition). FIG. 29 shows curves of the spherical aberration and the sine condition of Example 12, and FIG. 30 shows a curve of first-order derivative of an aspheric surface shape of the optical surface facing the optical disc of Example 12. As shown in FIG. 29, in the objective lens of Example 12, the offence against the sine condition OSC has the positive maximum value at the position of 87% of the radius of the effective aperture. On the other hand, the sine condition OSC does not have a negative maximum value.

TABLE 13
Example 12
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 1.07068 | 1.75000 | 1.69350 | N2 | 53.3 | Objective lens |
| 3 | −5.69046 | 0.39059 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | −0.0016 | −0.0016 | 0.0164 |
| Temperature | 25 | 25 | 55 | 25 |
| d0 | ∞ | 865.00000 | 865.00000 | −85.00000 |
| d4 | 0.095 | 0.100 | 0.100 | 0.050 |
| N2 | 1.715566 | 1.715566 | 1.715566 | 1.715566 |

Aspheric coefficients

| | Second surface | Third surface |
|---|---|---|
| κ | −5.55756E−01 | −1.05631E+03 |
| A4 | 2.03701E−02 | 3.25386E−01 |
| A6 | −1.48228E−02 | −6.51690E−01 |
| A8 | 7.07854E−02 | 8.58592E−01 |
| A10 | −1.15355E−01 | −1.59492E+00 |
| A12 | 6.68912E−02 | 1.67898E+00 |
| A14 | 7.44352E−02 | −2.39287E−01 |
| A16 | −1.44017E−01 | −4.47459E−01 |
| A18 | 8.73158E−02 | 0.00000E+00 |
| A20 | −1.92999E−02 | 0.00000E+00 |

### Example 13

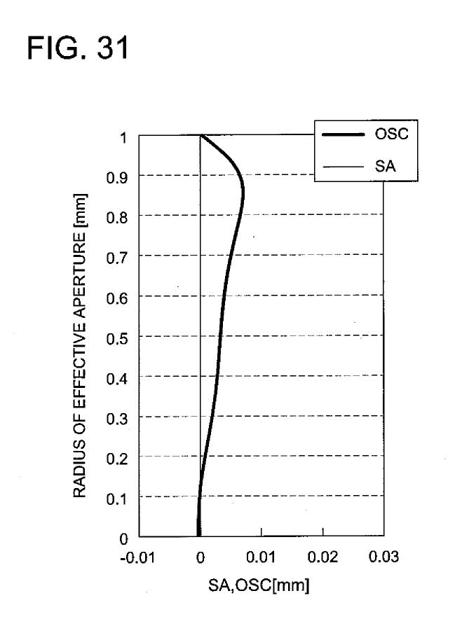

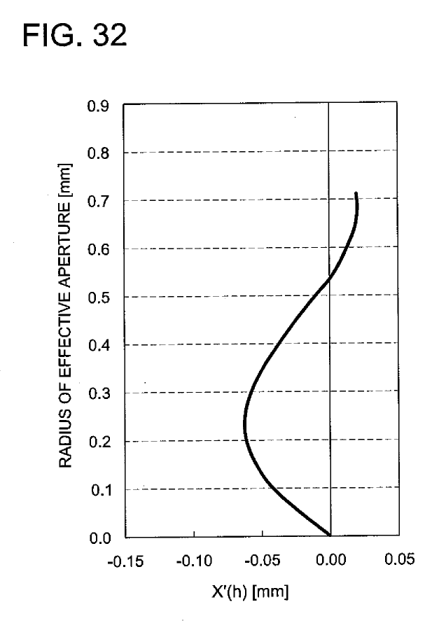

Table 14 shows lens data of Example 13. The present example provides an objective lens made of glass for handling a multilayered BD having three or more information recording surfaces (T_{MAX}=0.1 mm, T_{MIN}=0.05 mm). The material is SK3 (a product of OHARA INC.). It has been defined that T=0.1 mm holds (which corresponds to d4 in the base condition). FIG. 31 shows curves of the spherical aberration and the sine condition of Example 13, and FIG. 32 shows a curve of first-order derivative of an aspheric surface shape of the optical surface facing the optical disc of Example 13. As shown in FIG. 31, in the objective lens of Example 13, the offence against the sine condition OSC has the positive maximum value at the position of 85% of the radius of the effective aperture. On the other hand, the sine condition OSC does not have a negative maximum value.

TABLE 14
Example 13
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.98257 | 1.75000 | 1.58913 | N2 | 61.3 | Objective lens |
| 3 | −2.15207 | 0.40149 | | | | |
| 4 | ∞ | d4 | 1.58546 | 1.62230 | 30 | Cover glass |
| 5 | ∞ | | | | | |

Variables

| | | | At maximum | |
|---|---|---|---|---|
| | | | transparent | |
| | | At maximum | substrate | At minimum |
| | | transparent | thickness + | transparent |
| | Base | substrate | High | substrate |
| | condition | thickness | temperature | thickness |
| Magnification | 0.0000 | 0.0000 | 0.0000 | 0.0183 |
| Temperature | 25 | 25 | 55 | 25 |
| d0 | ∞ | ∞ | ∞ | −76.00000 |
| d4 | 0.100 | 0.100 | 0.100 | 0.050 |
| N2 | 1.605245 | 1.605245 | 1.605245 | 1.605245 |

Aspheric coefficients

| | Second surface | Third surface |
|---|---|---|
| κ | −5.62315E−01 | −8.39712E+01 |
| A4 | 2.10652E−02 | 3.43537E−01 |
| A6 | −1.68332E−02 | −6.32843E−01 |
| A8 | 7.58334E−02 | 9.25875E−01 |
| A10 | −1.15135E−01 | −1.43184E+00 |
| A12 | 6.54287E−02 | 1.45616E+00 |
| A14 | 7.42432E−02 | −6.61910E−01 |
| A16 | −1.42935E−01 | 5.53348E−02 |
| A18 | 8.80811E−02 | 0.00000E+00 |
| A20 | −1.97763E−02 | 0.00000E+00 |

### Example 14

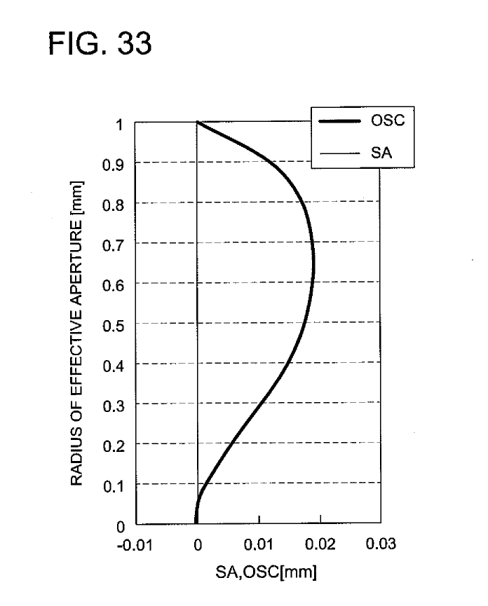

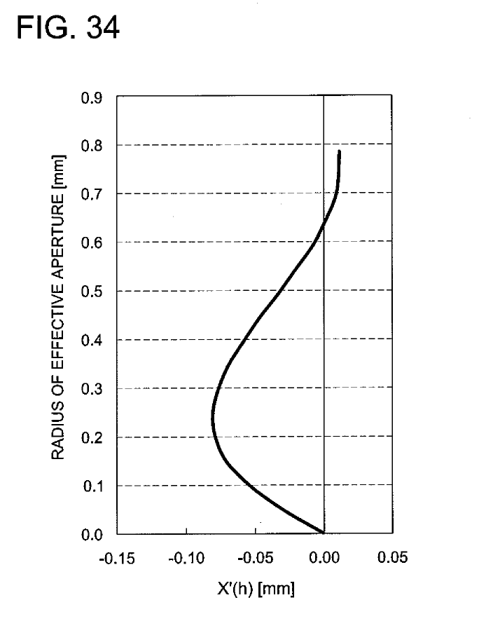

Table 15 shows lens data of Example 14. The present example provides an objective lens made of plastic for handling a multilayered BD having three or more information recording surfaces (T_{MAX}=0.1 mm, T_{MIN}=0.05 mat). It has been defined that T=0.09 mm holds (which corresponds to d4 in the base condition), FIG. 33 shows curves of the spherical aberration and the sine condition of Example 14, and FIG. 34 shows a curve of first-order derivative of an aspheric surface shape of the optical surface facing the optical disc of Example 14. As shown in FIG. 33, in the objective lens of Example 14, the offence against the sine condition OSC has the positive maximum value at the position of 85% of the radius of the effective aperture. On the other hand, the sine condition OSC does not have a negative maximum value.

TABLE 15
Example 14
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94958 | 1.75000 | 1.54500 | N2 | 61.3 | Objective lens |
| 3 | −1.61970 | 0.42021 | | | | |
| 4 | ∞ | d4 | 1.58546 | 1.62230 | 30 | Cover glass |
| 5 | ∞ | | | | | |

Variables

| | | At maximum | At maximum trans- | At minimum |
|---|---|---|---|---|
| | Base | transparent | parent substrate | transparent |
| | condi- | substrate | thickness + | substrate |
| | tion | thickness | High temperature | thickness |
| Magnifi- | 0.0000 | −0.0029 | −0.0052 | 0.0125 |
| cation | | | | |
| Temper- | 25 | 25 | 55 | 25 |
| ature | | | | |
| d0 | ∞ | 493.00000 | 272.50000 | −112.40000 |
| d4 | 0.090 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.61765E−01 | −6.46852E+01 |
| A4 | 2.68682E−02 | 3.26465E−01 |
| A6 | −2.25585E−02 | −6.28336E−01 |
| A8 | 8.22989E−02 | 9.72062E−01 |
| A10 | −1.17005E−01 | −1.41271E+00 |
| A12 | 6.46146E−02 | 1.42260E+00 |
| A14 | 7.48481E−02 | −7.67242E−01 |
| A16 | −1.42545E−01 | 1.59300E−01 |
| A18 | 8.80873E−02 | 0.00000E+00 |
| A20 | −1.98062E−02 | 0.00000E+00 |

### Example 15

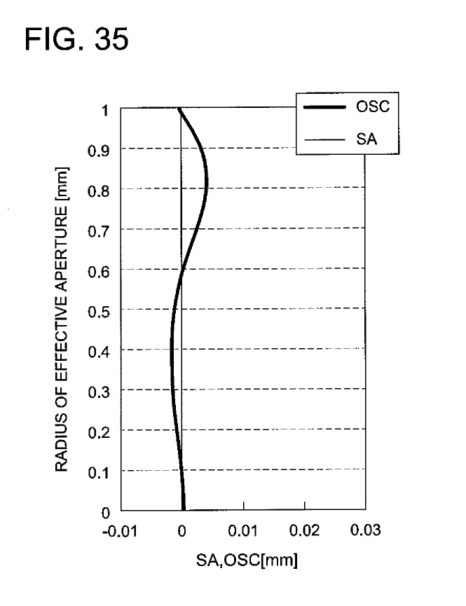

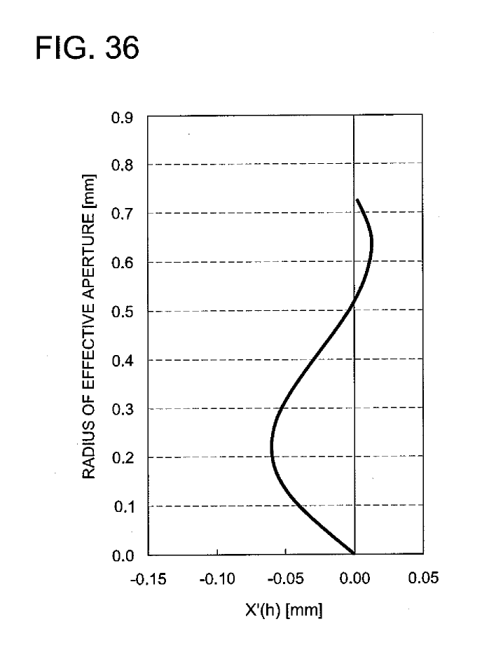

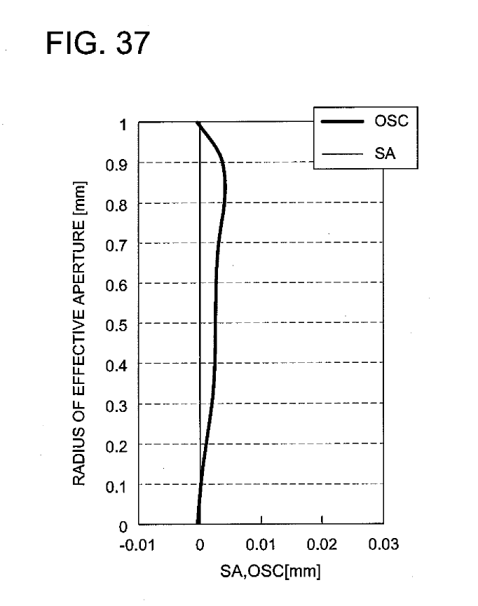

Table 16 shows lens data of Example 15. The present example provides an objective lens made of glass for handling a multilayered BD having three or more information recording surfaces (T_{MAX}=0.1 mm, T_{MIN}=0.05 mm). The material is SK5 (production of OHARA INC.). It has been defined that T=0.08 mm holds (which corresponds to d4 in the base condition). FIG. 35 shows curves of the spherical aberration and the sine condition of Example 15, and FIG. 36 shows a curve of first-order derivative of an aspheric surface shape of the optical surface facing the optical disc of Example 15. As shown in FIG. 36, in the objective lens of Example 15, the offence against the sine condition OSC has the positive maximum value at the position of 85% of the radius of the effective aperture. On the other hand, the sine condition OSC does not have a negative maximum value.

TABLE 16
Example 15
Paraxial Quantities

| Surface | | | | | | |
|---|---|---|---|---|---|---|
| No. | r(mm) | d(mm) | Nd | N405 | νd | |
| 0 | | D0 | | | | Light source |
| | | | | | | (Object point) |
| 1 | ∞ | 0.00000 | | | | Stop |
| | | | | | | (Diameter: 2.4) |
| 2 | 0.87499 | 1.50000 | 1.58913 | N2 | 61.3 | Objective lens |
| 3 | −2.22686 | 0.39990 | | | | |
| 4 | ∞ | D4 | 1.58300 | 1.61858 | 30 | Cover glass |
| 5 | ∞ | | | | | |

Variables

| | | At maximum | At maximum trans- | At minimum |
|---|---|---|---|---|
| | Base | transparent | parent substrate | transparent |
| | condi- | substrate | thickness + | substrate |
| | tion | thickness | High temperature | thickness |
| Magnifi- | 0.0000 | −0.0071 | −0.0071 | 0.0121 |
| cation | | | | |
| Temper- | 25 | 25 | 25 | 25 |
| ature | | | | |
| d0 | ∞ | 180.00000 | 180.00000 | −104.00000 |
| d4 | 0.080 | 0.100 | 0.100 | 0.050 |
| N2 | 1.604862 | 1.604862 | 1.604862 | 1.604862 |

Aspheric coefficients

| | Second surface | Third surface |
|---|---|---|
| κ | −4.88485E−01 | −4.01096E+01 |
| A4 | 6.79951E−03 | 7.04342E−01 |
| A6 | −9.10893E−03 | −2.25414E+00 |
| A8 | 5.93690E−02 | 4.90447E+00 |
| A10 | −1.00446E−01 | −7.33385E+00 |
| A12 | −1.41236E−02 | 6.31245E+00 |
| A14 | 3.89275E−01 | −2.31165E+00 |
| A16 | −6.84263E−01 | 0.00000E+00 |
| A18 | 5.12369E−01 | 0.00000E+00 |
| A20 | −1.48772E−01 | 0.00000E+00 |

### Example 16

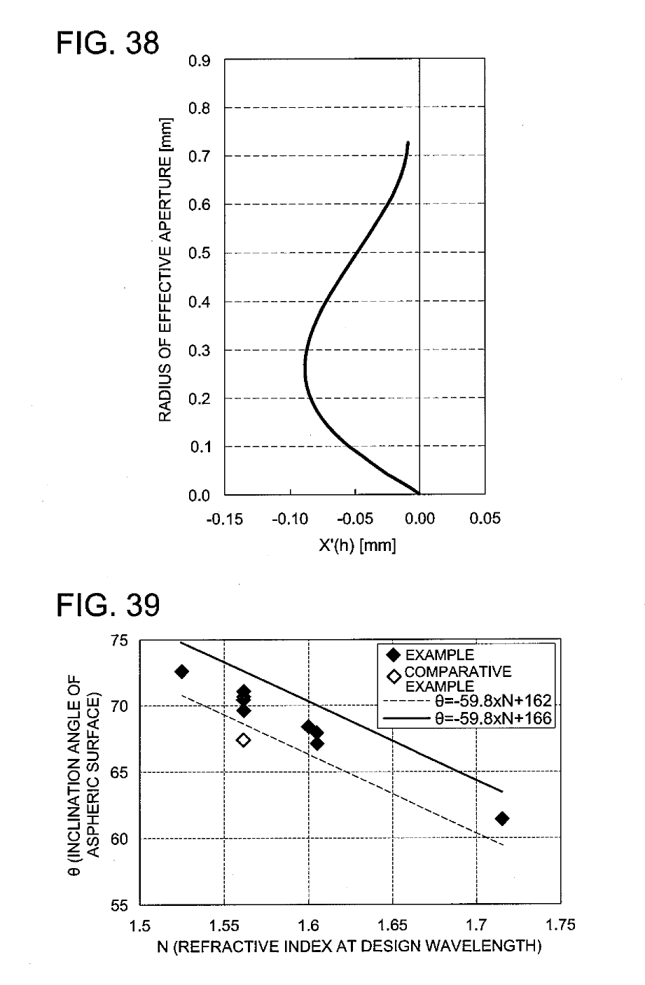

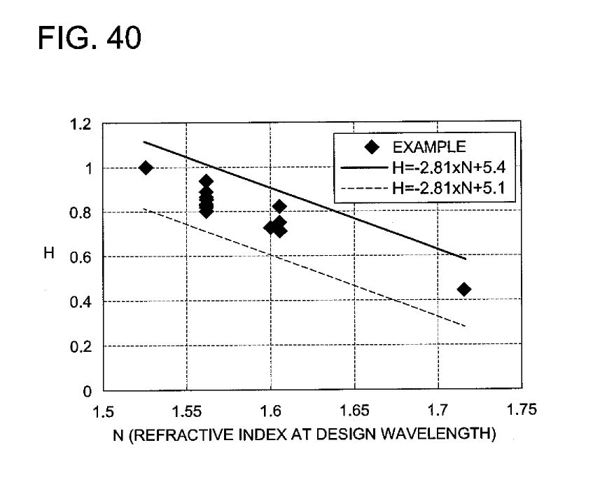

Table 17 shows lens data of Example 16. The present example provides an objective lens made of plastic for handling a multilayered BD having three or more information recording surfaces (T_{MAX}=0.1 min, T_{MIN}=0.05 mm). It has been defined that T=0.09 mm holds (which corresponds to d4 in the base condition). FIG. 38 shows curves of the spherical aberration and the sine condition of Example 16, and FIG. 39 shows a curve of first-order derivative of an aspheric surface shape of the optical surface facing the optical disc of Example 16. As shown in FIG. 38, in the objective lens of Example 16, the offence against the sine condition OSC has the positive maximum value at the position of 85% of the radius of the effective aperture. On the other hand, the sine condition OSC does not have a negative maximum value.

TABLE 17
Example 16
Paraxial Quantities

| Surface | | | | | | |
|---|---|---|---|---|---|---|
| No. | r(mm) | d(mm) | Nd | N405 | νd | |
| 0 | | d0 | | | | Light source |
| | | | | | | (Object point) |
| 1 | ∞ | 0.00000 | | | | Stop |
| | | | | | | (Diameter: 2.4) |
| 2 | 0.94438 | 1.75000 | 1.54500 | N2 | 56 | Objective lens |
| 3 | −1.64729 | 0.41495 | | | | |
| 4 | ∞ | d4 | 1.58546 | 1.62230 | 30 | Cover glass |
| 5 | ∞ | | | | | |

Variables

| | | At maximum | At maximum trans- | At minimum |
|---|---|---|---|---|
| | Base | transparent | parent substrate | transparent |
| | condi- | substrate | thickness + | substrate |
| | tion | thickness | High temperature | thickness |
| Magnif- | 0.0000 | −0.0033 | −0.0064 | 0.0145 |
| cation | | | | |
| Temper- | 25 | 25 | 25 | 25 |
| ature | | | | |
| d0 | ∞ | 431.00000 | 223.00000 | −96.30000 |
| d4 | 0.090 | 0.100 | 0.100 | 0.050 |
| N2 | 1.561516 | 1.561516 | 1.558517 | 1.561516 |

Aspheric coefficients

| | Second surface | Third surface |
|---|---|---|
| κ | −5.69211E−01 | −4.78627E+01 |
| A4 | 2.12921E−02 | 3.15805E−01 |
| A6 | −1.89157E−02 | −6.07681E−01 |
| A8 | 7.81286E−02 | 9.63352E−01 |
| A10 | −1.15731E−01 | −1.42206E+00 |
| A12 | 6.32906E−02 | 1.43285E+00 |
| A14 | 7.60996E−02 | −7.79599E−01 |
| A16 | −1.43058E−01 | 1.67445E−01 |
| A18 | 8.80102E−02 | 0.00000E+00 |
| A20 | −1.98355E−02 | 0.00000E+00 |

Table 18A through Table 18C show the list of characteristic values of Comparative example and Examples 1 to 5, Table 19A through Table 19C show the list of characteristic values of Examples 6 to 11, and Table 20A through Table 20C show the list of characteristic values of Examples 12 to 16. Further, Table 21, Table 22 and Table 23 show values of the conditional expressions written in Claims. Tables 21 to 23 show the values under the normal temperature (25±3° C.). The unit of T, TMAX, T_{MAX}-T_{MIN}, and H is mm. The unit of ΔSA3/ΔM, CM3, and CM5 is λrms. The unit of θ is degree (°). It can be found that, by employing respective examples, in comparison with Comparative example, the high-order spherical aberration generated when the focus jumps (see the values of Fifth-order coma at the Maximum cover glass thickness in Table 18 through Table 20) is restricted, and the ratio of the change amount of third-order spherical aberration to product of the magnification change and the focal length (see the values of ΔSA3/(ΔM×f) in Table 21 through Table 23) is increased. Further, the difference of the high-order spherical aberration caused when the focus jumps in Patent Literature 2 is 0.02 λrms or more in an absolute value, but the difference of the high-order spherical aberration in the most of the present Examples is 0 or 0.001 λrms, and at the most is about 0.01. λrms. It shows that the objective lenses of the present invention have advantage in reduction of the high-order spherical aberration generated when the focus jumps.

TABLE 18A

| | | Comparative | | | | | |
|---|---|---|---|---|---|---|---|
| | | example | Example 1 | Example 2 | Example 3 | Example 4 | Example 5 |
| Design specifications | | | | | | | |
| Design wavelength: λ | (nm) | 405 | 405 | 405 | 405 | 405 | 405 |
| Numerical aperture: NA | | 0.85 | 0.85 | 0.85 | 0.85 | 0.85 | 0.85 |
| Focal length: f | (mm) | 1.412 | 1.412 | 1.412 | 1.411 | 1.406 | 1.409 |
| Lens material | | Plastic | Plastic | Plastic | Plastic | Plastic | Plastic |
| Dependence of refractive index | at every temperature | −10 × 10⁻⁵ | −10 × 10⁻⁵ | −10 × 10⁻⁵ | −10 × 10⁻⁵ | −10 × 10⁻⁵ | −10 × 10⁻⁵ |
| on temperature | change of 1° C. | | | | | | |
| Aspheric-surface inclination angle | (Degree) | 67.4 | 70.4 | 70.4 | 70.3 | 70.9 | 71.0 |
| of the object-side optical surface θ | | | | | | | |
| Base condition | | | | | | | |
| Magnification: M | | 0.0000 | 0.0000 | 0.0000 | 0.0000 | 0.0000 | 0.0000 |
| Temperature | (Degree) | 25 | 25 | 25 | 25 | 25 | 25 |
| Cover glass thickness: T | (mm) | 0.0875 | 0.0750 | 0.0800 | 0.0850 | 0.0900 | 0.0950 |
| On-axis aberration | ** | 0.000 | 0.000 | 0.000 | 0.000 | 0.000 | 0.000 |
| | *** | 0.000 | 0.000 | 0.000 | 0.000 | 0.001 | 0.000 |
| Off-axis aberration | **** | −0.001 | −0.003 | −0.001 | −0.001 | −0.001 | −0.001 |
| | ***** | 0.000 | −0.016 | −0.013 | −0.016 | −0.015 | −0.012 |
| Lens tilt by 0.5 degree | **** | −0.047 | −0.038 | −0.042 | −0.045 | −0.047 | −0.050 |
| | ***** | −0.006 | 0.010 | 0.007 | 0.009 | 0.008 | 0.005 |
| Disc tilt by 0.5 degree | **** | 0.047 | 0.040 | 0.043 | 0.046 | 0.048 | 0.051 |
| | ***** | 0.007 | 0.006 | 0.006 | 0.007 | 0.007 | 0.007 |
| Refractive index: N | | 1.561516 | 1.561516 | 1.561516 | 1.561516 | 1.561516 | 1.561516 |
| Positive maximum value of | (mm) | 0.00186 | 0.00727 | 0.00617 | 0.00788 | 0.01325 | 0.00957 |
| the offence against the sine | | | | | | | |
| condition: OSC_{MAX} | | | | | | | |
| *1 | (mm) | 1.00 | 0.84 | 0.85 | 0.85 | 0.85 | 0.86 |
| *2 | (mm) | — | 0.855 | 0.860 | 0.860 | 0.885 | 0.825 |
| Radius of the effective aperture | (mm) | 0.803 | 0.783 | 0.783 | 0.783 | 0.724 | 0.777 |
| of the image-side optical surface | | | | | | | |

*1 Radius at which the offence against the sine condition has the value of OSC_{MAX} (under the assumption that the radius of the effective aperture is 1),
*2 Height of the radius at which the value of X′(h) switches from positive to negative (under the assumption that the radius of the effective aperture is 1): H,
** 3rd-order spherical aberration (λrms),
*** 5th-order spherical aberration (λrms),
**** 3rd-order coma (λrms),
***** 5th-order coma (λrms)

TABLE 18B

| | | Comparative | | | | | |
|---|---|---|---|---|---|---|---|
| | | example | Example 1 | Example 2 | Example 3 | Example 4 | Example 5 |
| Maximum cover glass thickness | | | | | | | |
| Magnification: M1 | | −0.0042 | −0.0079 | −0.0064 | −0.0048 | −0.0032 | −0.0016 |
| Temperature | (Degree) | 25 | 25 | 25 | 25 | 25 | 25 |
| Cover glass thickness: T_{MAX} | (mm) | 0.1000 | 0.1000 | 0.1000 | 0.1000 | 0.1000 | 0.1000 |
| On-axis aberration | ** | 0.000 | 0.000 | 0.000 | 0.000 | 0.000 | 0.000 |
| | *** | 0.005 | −0.001 | 0.000 | −0.001 | 0.001 | 0.000 |
| Off-axis aberration | **** | −0.018 | −0.039 | −0.030 | −0.023 | −0.016 | −0.008 |
| | ***** | −0.004 | −0.026 | −0.021 | −0.022 | −0.019 | −0.014 |
| Lens tilt by 0.5 degree | **** | −0.036 | −0.016 | −0.025 | −0.031 | −0.038 | −0.046 |
| | ***** | −0.003 | 0.017 | 0.012 | 0.014 | 0.011 | 0.006 |
| Disc tilt by 0.5 degree | **** | 0.054 | 0.054 | 0.054 | 0.054 | 0.054 | 0.054 |
| | ***** | 0.008 | 0.009 | 0.008 | 0.008 | 0.008 | 0.008 |
| Maximum cover glass thickness + | | | | | | | |
| High temperature | | | | | | | |
| Magnification | | −0.0074 | −0.0107 | −0.0094 | −0.0078 | −0.0063 | −0.0048 |
| Temperature | (Degree) | 55 | 55 | 55 | 55 | 55 | 55 |
| Cover glass thickness: T_{MAX} | (mm) | 0.1000 | 0.1000 | 0.1000 | 0.1000 | 0.1000 | 0.1000 |
| On-axis aberration | ** | 0.000 | 0.000 | −0.001 | 0.000 | −0.001 | −0.001 |
| | *** | 0.014 | −0.003 | −0.001 | −0.003 | 0.002 | 0.002 |
| Off-axis aberration | **** | −0.034 | −0.057 | −0.048 | −0.041 | −0.034 | −0.027 |
| | ***** | −0.010 | −0.034 | −0.029 | −0.030 | −0.027 | −0.023 |
| Lens tilt by 0.5 degree | **** | −0.020 | 0.003 | −0.006 | −0.013 | −0.019 | −0.027 |
| | ***** | 0.002 | 0.025 | 0.020 | 0.022 | 0.019 | 0.015 |
| Disc tilt by 0.5 degree | **** | 0.054 | 0.054 | 0.054 | 0.054 | 0.054 | 0.054 |
| | ***** | 0.008 | 0.009 | 0.009 | 0.008 | 0.008 | 0.008 |

** 3rd-order spherical aberration (λrms),
*** 5th-order spherical aberration (λrms),
**** 3rd-order coma (λrms),
***** 5th-order coma (λrms)

TABLE 18C

| | | Comparative | | | | | |
|---|---|---|---|---|---|---|---|
| | | example | Example 1 | Example 2 | Example 3 | Example 4 | Example 5 |
| Minimum cover glass thickness | | | | | | | |
| Magnification: M2 | | 0.0044 | 0.0086 | 0.0106 | 0.0123 | 0.0142 | 0.0164 |
| Temperature | (Degree) | 25 | 25 | 25 | 25 | 25 | 25 |
| Cover glass thickness: T_{MIN} | (mm) | 0.0750 | 0.0500 | 0.0500 | 0.0500 | 0.0500 | 0.0500 |
| On-axis aberration | ** | −0.001 | 0.000 | 0.000 | −0.001 | 0.000 | −0.001 |
| | *** | −0.004 | 0.002 | 0.000 | 0.002 | −0.003 | −0.004 |
| Off-axis aberration | **** | 0.017 | 0.035 | 0.045 | 0.052 | 0.059 | 0.068 |
| | ***** | 0.004 | −0.005 | 0.000 | −0.001 | 0.003 | 0.008 |
| Lens tilt by 0.5 degree | **** | −0.057 | −0.061 | −0.071 | −0.079 | −0.086 | −0.095 |
| | ***** | −0.009 | 0.002 | −0.004 | −0.003 | −0.006 | −0.011 |
| Disc tilt by 0.5 degree | **** | 0.041 | 0.027 | 0.027 | 0.027 | 0.027 | 0.027 |
| | ***** | 0.005 | 0.004 | 0.003 | 0.003 | 0.003 | 0.003 |
| Lens shift by 0.3 mm | **** | 0.002 | 0.007 | 0.012 | 0.000 | 0.021 | 0.028 |
| | ***** | 0.000 | −0.001 | 0.000 | 0.017 | 0.001 | 0.003 |
| High temperature | | | | | | | |
| Magnification | | 0.0000 | 0.0000 | 0.0000 | 0.0000 | 0.0000 | 0.0000 |
| Temperature | (Degree) | 55 | 55 | 55 | 55 | 55 | 55 |
| Cover glass thickness: T | (mm) | 0.0875 | 0.0750 | 0.0800 | 0.0850 | 0.0900 | 0.0950 |
| On-axis aberration | ** | 0.098 | 0.098 | 0.099 | 0.097 | 0.098 | 0.098 |
| | *** | 0.025 | 0.020 | 0.021 | 0.020 | 0.022 | 0.022 |

** 3rd-order spherical aberration (λrms),
*** 5th-order spherical aberration (λrms),
**** 3rd-order coma (λrms),
***** 5th-order coma (λrms)

TABLE 19A

| | | Example 6 | Example 7 | Example 8 | Example 9 | Example 10 | Example 11 |
|---|---|---|---|---|---|---|---|
| Design specifications | | | | | | | |
| Design wavelength: λ | (nm) | 405 | 405 | 405 | 405 | 405 | 405 |
| Numerical aperture: NA | | 0.85 | 0.85 | 0.85 | 0.85 | 0.85 | 0.85 |
| Focal length: f | (mm) | 1.399 | 1.408 | 1.412 | 1.412 | 1.412 | 1.412 |
| Lens material | | Plastic | Plastic | Plastic | Plastic | Glass | Glass |
| Dependence of refractive index | at every temperature | −10 × 10⁻⁵ | −10 × 10⁻⁵ | −10 × 10⁻⁵ | −10 × 10⁻⁵ | 0 | 0 |
| on temperature | change of 1° C. | | | | | | |
| Aspheric-surface inclination angle | (Degree) | 71.0 | 70.4 | 70.6 | 72.6 | 67.9 | 68.3 |
| of the object-side optical surface θ | | | | | | | |
| Base condition | | | | | | | |
| Magnification: M | | 0.0000 | 0.0000 | 0.0000 | 0.0000 | 0.0000 | 0.0000 |
| Temperature | (Degree) | 25 | 25 | 25 | 25 | 25 | 25 |
| Cover glass thickness: T | (mm) | 0.1000 | 0.1100 | 0.0900 | 0.0900 | 0.0750 | 0.0800 |
| On-axis aberration | ** | 0.002 | −0.001 | 0.000 | 0.000 | 0.000 | −0.001 |
| | *** | 0.000 | 0.000 | 0.000 | 0.000 | 0.000 | 0.000 |
| Off-axis aberration | **** | −0.001 | −0.001 | −0.015 | −0.023 | −0.001 | −0.001 |
| | ***** | −0.024 | −0.018 | −0.020 | −0.025 | −0.013 | −0.014 |
| Lens tilt by 0.5 degree | **** | −0.053 | −0.058 | −0.033 | −0.025 | −0.040 | −0.042 |
| | ***** | −0.008 | 0.009 | 0.013 | 0.018 | 0.007 | 0.007 |
| Disc tilt by 0.5 degree | **** | 0.052 | 0.059 | 0.048 | 0.048 | 0.040 | 0.043 |
| | ***** | −0.017 | 0.009 | 0.007 | 0.007 | 0.006 | 0.006 |
| Refractive index: N | | 1.561516 | 1.561516 | 1.561516 | 1.525455 | 1.605245 | 1.599656 |
| Positive maximum value of | (mm) | 0.02409 | 0.01118 | 0.00982 | 0.01268 | 0.00631 | 0.00643 |
| the offence against the sine | | | | | | | |
| condition: OSC_{MAX} | | | | | | | |
| *1 | (mm) | 0.83 | 0.84 | 0.79 | 0.72 | 0.85 | 0.85 |
| *2 | (mm) | 0.820 | 0.935 | 0.830 | 1.000 | 0.710 | 0.725 |
| Radius of the effective aperture | (mm) | 0.775 | 0.722 | 0.785 | 0.828 | 0.739 | 0.743 |
| of the image-side optical surface | | | | | | | |

*1 Radius at which the offence against the sine condition has the value of OSC_{MAX} (under the assumption that the radius of the effective aperture is 1),
*2 Height of the radius at which the value of X′(h) switches from positive to negative (under the assumption that the radius of the effective aperture is 1): H,
** 3rd-order spherical aberration (λrms),
*** 5th-order spherical aberration (λrms),
**** 3rd-order coma (λrms),
***** 5th-order coma (λrms)

TABLE 19B

| | | Example 6 | Example 7 | Example 8 | Example 9 | Example 10 | Example 11 |
|---|---|---|---|---|---|---|---|
| Maximum cover glass thickness | | | | | | | |
| Magnification: M1 | | 0.0000 | 0.0034 | −0.0031 | −0.0030 | −0.0080 | −0.0064 |
| Temperature | (Degree) | 25 | 25 | 25 | 25 | 25 | 25 |
| Cover glass thickness: T_{MAX} | (mm) | 0.1000 | 0.1000 | 0.1000 | 0.1000 | 0.1000 | 0.1000 |
| On-axis aberration | ** | 0.002 | 0.000 | 0.000 | 0.000 | 0.000 | 0.000 |
| | *** | 0.005 | −0.001 | 0.000 | −0.001 | 0.001 | 0.000 |
| Off-axis aberration | **** | −0.001 | 0.014 | −0.030 | −0.037 | −0.036 | −0.029 |
| | ***** | −0.024 | −0.013 | −0.024 | −0.030 | −0.023 | −0.021 |
| Lens tilt by 0.5 degree | **** | −0.052 | −0.067 | −0.024 | −0.017 | −0.018 | −0.025 |
| | ***** | 0.017 | 0.006 | 0.016 | 0.021 | 0.014 | 0.013 |
| Disc tilt by 0.5 degree | **** | 0.053 | 0.054 | 0.054 | 0.054 | 0.054 | 0.054 |
| | ***** | 0.008 | 0.007 | 0.008 | 0.008 | 0.009 | 0.008 |
| Maximum cover glass thickness + | | | | | | | |
| High temperature | | | | | | | |
| Magnification | | −0.0031 | 0.0001 | −0.0059 | −0.0064 | −0.0080 | −0.0064 |
| Temperature | (Degree) | 55 | 55 | 55 | 55 | 55 | 55 |
| Cover glass thickness: T_{MAX} | (mm) | 0.1000 | 0.1000 | 0.1000 | 0.1000 | 0.1000 | 0.1000 |
| On-axis aberration | ** | 0.000 | 0.001 | −0.001 | 0.000 | 0.000 | 0.000 |
| | *** | −0.001 | 0.001 | 0.000 | 0.000 | 0.000 | 0.000 |
| Off-axis aberration | **** | −0.020 | −0.005 | −0.047 | −0.058 | −0.036 | −0.029 |
| | ***** | −0.033 | −0.022 | −0.032 | −0.038 | −0.023 | −0.021 |
| Lens tilt by 0.5 degree | **** | −0.033 | −0.049 | −0.006 | 0.004 | −0.018 | −0.025 |
| | ***** | 0.025 | 0.014 | 0.023 | 0.030 | 0.014 | 0.013 |
| Disc tilt by 0.5 degree | **** | 0.053 | 0.053 | 0.054 | 0.054 | 0.054 | 0.054 |
| | ***** | 0.008 | 0.008 | 0.008 | 0.009 | 0.009 | 0.008 |

** 3rd-order spherical aberration (λrms),
*** 5th-order spherical aberration (λrms),
**** 3rd-order coma (λrms),
***** 5th-order coma (λrms)

TABLE 19C

| | | Example 6 | Example 7 | Example 8 | Example 9 | Example 10 | Example 11 |
|---|---|---|---|---|---|---|---|
| Minimum cover glass thickness | | | | | | | |
| Magnification: M2 | | 0.0175 | 0.0223 | 0.0137 | 0.0132 | 0.0087 | 0.0105 |
| Temperature | (Degree) | 25 | 25 | 25 | 25 | 25 | 25 |
| Cover glass thickness: T_{MIN} | (mm) | 0.0500 | 0.0500 | 0.0500 | 0.0500 | 0.0500 | 0.0500 |
| On-axis aberration | ** | 0.000 | 0.000 | 0.001 | 0.001 | 0.000 | −0.001 |
| | *** | 0.001 | 0.001 | 0.000 | 0.001 | 0.001 | 0.001 |
| Off-axis aberration | **** | 0.074 | 0.091 | 0.044 | 0.036 | 0.037 | 0.044 |
| | ***** | −0.003 | 0.010 | −0.004 | −0.008 | −0.003 | −0.001 |
| Lens tilt by 0.5 degree | **** | −0.100 | −0.118 | −0.070 | −0.062 | −0.064 | −0.071 |
| | ***** | 0.000 | −0.013 | 0.000 | 0.005 | 0.000 | −0.002 |
| Disc tilt by 0.5 degree | **** | 0.026 | 0.026 | 0.027 | 0.026 | 0.027 | 0.027 |
| | ***** | 0.003 | 0.003 | 0.003 | 0.004 | 0.004 | 0.003 |
| Lens shift by 0.3 mm | **** | 0.032 | 0.051 | 0.015 | 0.012 | 0.008 | 0.012 |
| | ***** | −0.001 | 0.005 | −0.001 | −0.003 | −0.001 | 0.000 |
| High temperature | | | | | | | |
| Magnification | | 0.0000 | 0.0000 | 0.0000 | 0.0000 | 0.0000 | 0.0000 |
| Temperature | (Degree) | 55 | 55 | 55 | 55 | 55 | 55 |
| Cover glass thickness: T | (mm) | 0.1000 | 0.1100 | 0.0900 | 0.0900 | 0.0750 | 0.0800 |
| On-axis aberration | ** | 0.096 | 0.095 | 0.089 | 0.110 | 0.000 | −0.001 |
| | *** | 0.020 | 0.020 | 0.019 | 0.025 | 0.000 | 0.000 |

** 3rd-order spherical aberration (λrms),
*** 5th-order spherical aberration (λrms),
**** 3rd-order coma (λrms),
***** 5th-order coma (λrms)

TABLE 20A

| | | Example 12 | Example 13 | Example 14 | Example 15 | Example 16 |
|---|---|---|---|---|---|---|
| Design specifications | | | | | | |
| Design wavelength: λ | (nm) | 405 | 405 | 405 | 407.5 | 405 |
| Numerical aperture: NA | | 0.85 | 0.85 | 0.85 | 0.85 | 0.85 |
| Focal length: f | (mm) | 1.412 | 1.412 | 1.412 | 1.270 | 1.412 |
| Lens material | | Glass | Glass | Plastic | Glass | Plastic |
| Dependence of refractive index | at every temperature | 0 | 0 | −10 × 10⁻⁵ | 0 | −10 × 10⁻⁵ |
| on temperature | change of 1° C. | | | | | |
| Aspheric-surface inclination angle | (Degree) | 61.4 | 67.9 | 70.6 | 67.1 | 69.6 |
| of the object-side optical surface θ | | | | | | |
| Base condition | | | | | | |
| Magnification: M | | 0.0000 | 0.0000 | 0.0000 | 0.0000 | 0.0000 |
| Temperature | (Degree) | 25 | 25 | 25 | 25 | 25 |
| Cover glass thickness: T | (mm) | 0.0950 | 0.1000 | 0.0900 | 0.0800 | 0.0900 |
| On-axis aberration | ** | −0.001 | 0.000 | −0.001 | −0.004 | −0.001 |
| | *** | −0.001 | 0.000 | 0.000 | −0.001 | 0.000 |
| Off-axis aberration | **** | 0.000 | −0.001 | −0.040 | 0.005 | −0.004 |
| | ***** | −0.011 | −0.014 | −0.032 | −0.012 | −0.009 |
| Lens tilt by 0.5 degree | **** | −0.051 | −0.053 | −0.008 | −0.048 | −0.045 |
| | ***** | 0.004 | 0.006 | 0.025 | 0.006 | 0.002 |
| Disc tilt by 0.5 degree | **** | 0.051 | 0.054 | 0.048 | 0.043 | 0.049 |
| | ***** | 0.007 | 0.008 | 0.008 | 0.006 | 0.007 |
| Refractive index: N | | 1.715566 | 1.605245 | 1.561516 | 1.604862 | 1.561516 |
| Positive maximum value of the offence | (mm) | 0.00696 | 0.00666 | 0.01804 | 0.01282 | 0.00741 |
| against the sine condition: OSC_{MAX} | | | | | | |
| *1 | (mm) | 0.87 | 0.85 | 0.85 | 0.85 | 0.85 |
| *2 | (mm) | 0.440 | 0.750 | 0.800 | 0.820 | 0.850 |
| Radius of the effective aperture of the | (mm) | 0.675 | 0.709 | 0.781 | 0.723 | 0.725 |
| image-side optical surface | | | | | | |

*1 Radius at which the offence against the sine condition has the value of OSC_{MAX} (under the assumption that the radius of the effective aperture is 1),
*2 Height of the radius at which the value of X′(h) switches from positive to negative (under the assumption that the radius of the effective aperture is 1): H,
** 3rd-order spherical aberration (λrms),
*** 5th-order spherical aberration (λrms),
**** 3rd-order coma (λrms),
***** 5th-order coma (λrms)

TABLE 20B

| | | Example 12 | Example 13 | Example 14 | Example 15 | Example 16 |
|---|---|---|---|---|---|---|
| Maximum cover glass thickness | | | | | | |
| Magnification: M1 | | −0.0016 | 0.0000 | −0.0029 | −0.0071 | −0.0033 |
| Temperature | (Degree) | 25 | 25 | 25 | 25 | 25 |
| Cover glass thickness: T_{MAX} | (mm) | 0.1000 | 0.1000 | 0.1000 | 0.1000 | 0.1000 |
| On-axis aberration | ** | 0.000 | 0.000 | 0.000 | 0.000 | 0.000 |
| | *** | 0.000 | 0.000 | 0.001 | 0.000 | 0.002 |
| Off-axis aberration | **** | −0.008 | −0.001 | −0.054 | −0.023 | −0.018 |
| | ***** | −0.013 | −0.014 | −0.036 | −0.018 | −0.012 |
| Lens tilt by 0.5 degree | **** | −0.046 | −0.053 | 0.000 | −0.031 | −0.037 |
| | ***** | 0.005 | 0.006 | 0.027 | 0.010 | 0.004 |
| Disc tilt by 0.5 degree | **** | 0.054 | 0.054 | 0.054 | 0.054 | 0.054 |
| | ***** | 0.008 | 0.008 | 0.009 | 0.008 | 0.008 |
| Maximum cover glass thickness + | | | | | | |
| High temperature | | | | | | |
| Magnification | | −0.0016 | 0.0000 | −0.0052 | −0.0071 | −0.0064 |
| Temperature | (Degree) | 55 | 55 | 55 | 55 | 55 |
| Cover glass thickness: T_{MAX} | (mm) | 0.1000 | 0.1000 | 0.1000 | 0.1000 | 0.1000 |
| On-axis aberration | ** | 0.000 | 0.000 | 0.000 | 0.000 | 0.000 |
| | *** | 0.000 | 0.000 | 0.000 | 0.000 | 0.005 |
| Off-axis aberration | **** | −0.008 | −0.001 | −0.070 | −0.023 | −0.035 |
| | ***** | −0.013 | −0.014 | −0.042 | −0.018 | −0.019 |
| Lens tilt by 0.5 degree | **** | −0.046 | −0.053 | 0.017 | −0.031 | −0.019 |
| | ***** | 0.005 | 0.006 | 0.034 | 0.010 | 0.011 |
| Disc tilt by 0.5 degree | **** | 0.054 | 0.054 | 0.054 | 0.054 | 0.054 |
| | ***** | 0.008 | 0.008 | 0.009 | 0.008 | 0.008 |

** 3rd-order spherical aberration (λrms),
*** 5th-order spherical aberration (λrms),
**** 3rd-order coma (λrms),
***** 5th-order coma (λrms)

TABLE 20C

| | | Example 12 | Example 13 | Example 14 | Example 15 | Example 16 |
|---|---|---|---|---|---|---|
| Minimum cover glass thickness | | | | | | |
| Magnification: M2 | | 0.0164 | 0.0183 | 0.0125 | 0.0121 | 0.0145 |
| Temperature | (Degree) | 25 | 25 | 25 | 25 | 25 |
| Cover glass thickness: T_{MIN} | (mm) | 0.0500 | 0.0500 | 0.0500 | 0.0500 | 0.0500 |
| On-axis aberration | ** | 0.000 | 0.000 | 0.000 | 0.000 | 0.000 |
| | *** | −0.001 | 0.001 | 0.000 | 0.000 | −0.006 |
| Off-axis aberration | **** | 0.069 | 0.075 | 0.017 | 0.051 | 0.056 |
| | ***** | 0.005 | 0.007 | −0.018 | −0.003 | 0.008 |
| Lens tilt by 0.5 degree | **** | −0.096 | −0.102 | −0.043 | −0.077 | −0.083 |
| | ***** | −0.008 | −0.010 | 0.014 | −0.001 | −0.011 |
| Disc tilt by 0.5 degree | **** | 0.027 | 0.027 | 0.027 | 0.027 | 0.027 |
| | ***** | 0.003 | 0.003 | 0.004 | 0.003 | 0.003 |
| Lens shift by 0.3 mm | **** | 0.028 | 0.034 | 0.005 | 0.017 | 0.020 |
| | ***** | 0.002 | 0.003 | −0.005 | −0.001 | 0.003 |
| High temperature | | | | | | |
| Magnification | | 0.0000 | 0.0000 | 0.0000 | 0.0000 | 0.0000 |
| Temperature | (Degree) | 55 | 55 | 55 | 55 | 55 |
| Cover glass thickness: T | (mm) | 0.0950 | 0.1000 | 0.0900 | 0.0800 | 0.0900 |
| On-axis aberration | ** | −0.001 | 0.000 | 0.083 | −0.004 | 0.097 |
| | *** | −0.001 | 0.000 | 0.018 | −0.001 | 0.023 |

** 3rd-order spherical aberration (λrms),
*** 5th-order spherical aberration (λrms),
**** 3rd-order coma (λrms),
***** 5th-order coma (λrms)

TABLE 21

| | | Comparative | Example | Example | Example | Example | Example |
|---|---|---|---|---|---|---|---|
| Expression | | example | 1 | 2 | 3 | 4 | 5 |
| (1) | T | 0.0875 | 0.0750 | 0.0800 | 0.0850 | 0.0900 | 0.0950 |
| (3) | T_{MAX} × 0.75 | 0.0750 | 0.0750 | 0.0750 | 0.0750 | 0.0750 | 0.0750 |
| (4) | T_{MAX} × 0.85 | 0.0850 | 0.0850 | 0.0850 | 0.0850 | 0.0850 | 0.0850 |
| (5) | T_{MAX} × 0.95 | 0.0950 | 0.0950 | 0.0950 | 0.0950 | 0.0950 | 0.0950 |
| | T_{MAX} × 1.0 | 0.1000 | 0.1000 | 0.1000 | 0.1000 | 0.1000 | 0.1000 |
| | T_{MAX} × 1.1 | 0.1100 | 0.1100 | 0.1100 | 0.1100 | 0.1100 | 0.1100 |
| (2) | M | 0.0000 | 0.0000 | 0.0000 | 0.0000 | 0.0000 | 0.0000 |
| (6) | \|ΔSA3/(ΔM × f)\| | 20.89 | 22.02 | 21.73 | 21.96 | 21.85 | 21.75 |
| (7) | ΔSA3/ΔSA5 | 6.19 | 4.52 | 4.64 | 4.52 | 4.83 | 4.80 |
| (11) | OSC_{MAX}/f | 0.0013 | 0.0051 | 0.0044 | 0.0056 | 0.0094 | 0.0068 |
| (12) | \|CM(LT)/CM(DT)\| | 0.363 | 0.050 | 0.111 | 0.242 | 0.359 | 0.499 |
| (13) | M1/M2 | 0.955 | 0.919 | 0.604 | 0.390 | 0.225 | 0.098 |
| (8) | \|CM5\| | 0.001 | 0.032 | 0.025 | 0.032 | 0.030 | 0.024 |
| (9) | \|CM3\| | 0.002 | 0.006 | 0.002 | 0.002 | 0.002 | 0.002 |
| (14) | θ | 67.39 | 70.44 | 70.39 | 70.33 | 70.86 | 71.03 |
| | −59.8 × N + 162 | 68.62 | 68.62 | 68.62 | 68.62 | 68.62 | 68.62 |
| | −59.8 × N + 166 | 72.62 | 72.62 | 72.62 | 72.62 | 72.62 | 72.62 |
| (15) | T_{MAX} − T_{MIN} | 0.025 | 0.050 | 0.050 | 0.050 | 0.050 | 0.050 |
| (16) | H | — | 0.855 | 0.860 | 0.860 | 0.885 | 0.825 |
| | −2.8 × N + 5.1 | — | 0.712 | 0.712 | 0.712 | 0.712 | 0.712 |
| | −2.8 × N + 5.4 | — | 1.012 | 1.012 | 1.012 | 1.012 | 1.012 |

| | | | | | | |
|---|---|---|---|---|---|---|
| Negative maximum of office | None | None | None | None | None | None |
| against the sine condition | | | | | | |

TABLE 22

| | | Example | Example | Example | Example | Example | Example |
|---|---|---|---|---|---|---|---|
| Expression | | 6 | 7 | 8 | 9 | 10 | 11 |
| (1) | T | 0.1000 | 0.1100 | 0.0900 | 0.0900 | 0.0750 | 0.0800 |
| (3) | T_{MAX} × 0.75 | 0.0750 | 0.0750 | 0.0750 | 0.0750 | 0.0750 | 0.0750 |
| (4) | T_{MAX} × 0.85 | 0.0850 | 0.0850 | 0.0850 | 0.0850 | 0.0850 | 0.0850 |
| (5) | T_{MAX} × 0.95 | 0.0950 | 0.0950 | 0.0950 | 0.0950 | 0.0950 | 0.0950 |
| | T_{MAX} × 1.0 | 0.1000 | 0.1000 | 0.1000 | 0.1000 | 0.1000 | 0.1000 |
| | T_{MAX} × 1.1 | 0.1100 | 0.1100 | 0.1100 | 0.1100 | 0.1100 | 0.1100 |
| (2) | M | 0.0000 | 0.0000 | 0.0000 | 0.0000 | 0.0000 | 0.0000 |
| (6) | \|ΔSA3/(ΔM × f)\| | 22.04 | 22.10 | 22.73 | 23.34 | 21.79 | 21.82 |
| (7) | ΔSA3/ΔSA5 | 4.50 | 4.54 | 4.58 | 4.36 | 4.66 | 4.63 |
| (11) | OSC_{MAX}/f | 0.0172 | 0.0079 | 0.0070 | 0.0090 | 0.0045 | 0.0046 |
| (12) | \|CM(LT)/CM(DT)\| | 0.631 | 0.914 | 0.119 | 0.080 | 0.330 | 0.460 |
| (13) | M1/M2 | 0.000 | 0.152 | 0.226 | 0.227 | 0.920 | 0.610 |
| (8) | \|CM5\| | 0.049 | 0.035 | 0.040 | 0.051 | 0.026 | 0.027 |
| (9) | \|CM3\| | 0.002 | 0.002 | 0.031 | 0.046 | 0.001 | 0.001 |
| (14) | θ | 70.97 | 70.43 | 70.61 | 72.57 | 67.91 | 68.33 |
| | −59.8 × N + 162 | 68.62 | 68.62 | 68.62 | 70.78 | 66.01 | 66.34 |
| | −59.8 × N + 166 | 72.62 | 72.62 | 72.62 | 74.78 | 70.01 | 70.34 |
| (15) | T_{MAX} − T_{MIN} | 0.050 | 0.050 | 0.050 | 0.050 | 0.050 | 0.050 |
| (16) | H | 0.820 | 0.935 | 0.830 | 1.000 | 0.710 | 0.725 |
| | −2.8 × N + 5.1 | 0.712 | 0.712 | 0.712 | 0.813 | 0.589 | 0.605 |
| | −2.8 × N + 5.4 | 1.012 | 1.012 | 1.012 | 1.113 | 0.889 | 0.905 |

| | | | | | | |
|---|---|---|---|---|---|---|
| Negative maximum of office | None | None | None | None | None | None |
| against the sine condition | | | | | | |

TABLE 23

| Expression | | Example 12 | Example 13 | Example 14 | Example 15 | Example 16 |
|---|---|---|---|---|---|---|
| (1) | T | 0.0950 | 0.1000 | 0.0900 | 0.0800 | 0.0900 |
| (3) | T_{MAX} × 0.75 | 0.0750 | 0.0750 | 0.0750 | 0.0750 | 0.0750 |
| (4) | T_{MAX} × 0.85 | 0.0850 | 0.0850 | 0.0850 | 0.0850 | 0.0850 |
| (5) | T_{MAX} × 0.95 | 0.0950 | 0.0950 | 0.0950 | 0.0950 | 0.0950 |
| | T_{MAX} × 1.0 | 0.1000 | 0.1000 | 0.1000 | 0.1000 | 0.1000 |
| | T_{MAX} × 1.1 | 0.1100 | 0.1100 | 0.1100 | 0.1100 | 0.1100 |
| (2) | M | 0.0000 | 0.0000 | 0.0000 | 0.0000 | 0.0000 |
| (6) | \|ΔSA3/(ΔM × f)\| | 21.69 | 21.76 | 24.49 | 22.23 | 21.64 |
| (7) | ΔSA3/ΔSA5 | 4.63 | 4.61 | 4.43 | 4.82 | 5.11 |
| (11) | OSC_{MAX}/f | 0.0049 | 0.0047 | 0.0212 | 0.0151 | 0.0087 |
| (12) | \|CM(LT)/CM(DT)\| | 0.858 | 0.987 | 0.308 | 0.572 | 0.348 |
| (13) | M1/M2 | 0.098 | 0.000 | 0.232 | 0.587 | 0.228 |
| (8) | \|CM5\| | 0.022 | 0.028 | 0.065 | 0.025 | 0.017 |
| (9) | \|CM3\| | 0.001 | 0.002 | 0.080 | 0.009 | 0.007 |
| (14) | θ | 61.37 | 67.87 | 70.56 | 67.10 | 69.57 |
| | −59.8 × N + 162 | 59.41 | 66.01 | 68.62 | 66.03 | 68.62 |
| | −59.8 × N + 166 | 63.41 | 70.01 | 72.62 | 70.03 | 72.62 |
| (15) | T_{MAX} − T_{MIN} | 0.050 | 0.050 | 0.050 | 0.050 | 0.050 |
| (16) | H | 0.440 | 0.750 | 0.800 | 0.820 | 0.850 |
| | −2.8 × N + 5.1 | 0.279 | 0.589 | 0.712 | 0.590 | 0.712 |
| | −2.8 × N + 5.4 | 0.579 | 0.889 | 1.012 | 0.890 | 1.012 |

| | | | | | |
|---|---|---|---|---|---|
| Negative maximum of office | None | None | None | Observed | None |
| against the sine condition | | | | | |

The present invention is not limited to the examples described in the present specification. It is to be understood that various changes and modifications will be apparent to those skilled in the art, based on the examples and ideas described in the specification. The descriptions and examples of the present specification are provided for illustrative purposes and the scope of the present invention will be defined by claims which will be described later.

### REFERENCE SIGNS LIST

OBJ Objective lens
PU1 Optical pickup device
LD Blue-violet semiconductor laser AC1 One-axis actuator
AC2 Three-axis actuator
PBS Polarization prism
CL Coupling lens
L2 Positive lens group
L3 Negative lens group
PL1 Protective substrate
PL2 Protective substrate
PL3 Protective substrate
RL1 Information recording surface
RL2 Information recording surface
RL3 Information recording surface
QWP Quarter wavelength plate

1. An objective lens for an optical pickup device including a light source for emitting a light flux with a wavelength λ1 (390 nm<λ1<415 nm) and an objective lens, the optical pickup device recording and/or reproducing information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other,
wherein the objective lens is a single lens, has a numerical aperture (NA) at an image side which is 0.8 or more and is 0.95 or less, and is formed of a plastic material,
wherein a magnification M which is a magnification under a condition that a spherical aberration (λrms) is minimized at a normal temperature (25±3C.°) and at a cover glass thickness T (mm) satisfying the expression (1), satisfies the expression (2), where T_{MAX} (mm) is a maximum transparent substrate thickness among the transparent substrate thicknesses:
T_{MAX}×0.85≦T≦T_{MAX}×1.1 (1),
−0.003≦M≦0.003 (2),
wherein, at the magnification M, an offence against a sine condition has a positive maximum value at a position in an area between 70% and 90% of a radius of an effective aperture.

2. The objective lens of claim 1, wherein the cover glass thickness T (mm) satisfies the following conditional expression (3):
T_{MAX}×0.85≦T≦T_{MAX}×1.0 (3).

3. An objective lens for an optical pickup device including a light source for emitting a light flux with a wavelength λ1 (390 nm<λ1<415 nm) and an objective lens, the optical pickup device recording and/or reproducing information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other,
wherein the objective lens is a single lens, has a numerical aperture (NA) at an image side which is 0.8 or more and is 0.95 or less, and is formed of a glass material,
wherein a magnification M which is a magnification under a condition that a spherical aberration (λrms) is minimized at a normal temperature (25±3C.°) and at a cover glass thickness T (mm) satisfying the expression (4), satisfies the expression (2), where T_{MAX} (mm) is a maximum transparent substrate thickness among the transparent substrate thicknesses:
T_{MAX}×0.75≦T≦T_{MAX}×1.0 (4),
−0.003≦M≦0.003 (2),
wherein, at the magnification M, an offence against a sine condition has a positive maximum value at a position in an area between 70% and 90% of a radius of an effective aperture.

4. The objective lens of claim 3, wherein the cover glass thickness T (mm) satisfies the following expression (5):
T_{MAX}×0.8≦T≦T_{MAX}×0.95 (5).

5. An objective lens for an optical pickup device including a light source for emitting a light flux with a wavelength λ1 (390 nm<λ1<415 nm) and an objective lens, the optical pickup device recording and/or reproducing information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other,
wherein the objective lens is a single lens, and has a numerical aperture (NA) at an image side which is 0.8 or more and is 0.95 or less,
wherein a value of ΔSA3/(ΔM×f) (λrms/mm) which is a change rate of a third-order spherical aberration to a product of a focal length f of the objective lens and a magnification change ΔM at normal temperature (25±3C.°) and at a transparent substrate thickness T, satisfies the expression (6), where T (mm) is a cover glass thickness under a condition that a spherical aberration (λrms) is minimized at a normal temperature (25±3C.°) and at a magnification M satisfying the expression (2), and f (mm) is a focal length for the wavelength λ1 at the normal temperature (25±3C.°):
−0.003≦M≦0.003 (2),
21≦|ΔSA3/(ΔM×f)|<25 (6).

6. An objective lens for an optical pickup device including a light source for emitting a light flux with a wavelength λ1 (390 nm<λ1<415 nm) and an objective lens, the optical pickup device recording and/or reproducing information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other,
wherein the objective lens is a single lens, and has a numerical aperture at an image side (NA) which is 0.8 or more and is 0.95 or less,
wherein a third-order spherical aberration ΔSA3 and a fifth-order spherical aberration ΔSA5 which are generated when a magnification of the objective lens is changed at a normal temperature (25±3C.°) and at a cover glass thickness T, satisfy the expression (7), where T (mm) is a cover glass thickness under a condition that a spherical aberration (λrms) is minimized at the normal temperature (25±3C.°) and at a magnification M satisfying the expression (2):
−0.003≦M≦0.003 (2),
4.2≦ΔSA3/ΔSA5<5.2 (7).

7. The objective lens of claim 1, wherein, at the magnification M, an offence against a sine condition has a positive maximum value at a position in an area between 70% and 90% of a radius of an effective aperture, and does not have a negative maximum value within the radius of the effective aperture.

8. The objective lens of claim 1, wherein, at the magnification M, an offence against a sine condition which has a positive maximum value at a position in an area between 70% and 90% of a radius of an effective aperture, and has a negative maximum value at a position closer to an optical axis than the position of the positive maximum value.

9. The objective lens of claim 6, wherein a fifth-order coma CM5 (λrms) which is generated when an oblique light flux whose half angle of view is 1 degree enters the objective lens at a normal temperature (25±3C.°), the cover glass thickness T and the magnification M, satisfies the expression (8):
0.02<|CM5|<0.05 (8).

10. The objective lens of claim 9, wherein a third-order coma CM3 (λrms) which is generated when an oblique light flux whose half angle of view is 1 degree enters the objective lens at a normal temperature (25±3C.°), the cover glass thickness T and the magnification M satisfies the expression (9):
0≦|CM3|<0.02 (9).

11. An objective lens for an optical pickup device including a light source for emitting a light flux with a wavelength λ1 (390 nm<λ1<415 nm) and an objective lens, the optical pickup device recording and/or reproducing information for an optical disc by selecting any one of information recording surfaces of the optical disc and converging a light flux with the wavelength λ1 emitted from the light source onto the selected information recording surface, where the optical disc includes three or more information recording surfaces arranged in a thickness direction thereof and transparent substrate thicknesses of the information recording surfaces are different from each other,
wherein the objective lens is a single lens, and has numerical aperture at an image side (NA) which is 0.8 or more and is 0.95 or less,
wherein a fifth-order coma CM5 (λrms) which is generated when an oblique light flux whose half angle of view is 1 degree enters the objective lens at a normal temperature (25±3C.°), a cover glass thickness T and a magnification M satisfying the expression (2), satisfies the expression (8), where T (mm) is a cover glass thickness under a condition that a spherical aberration (λrms) is minimized at the normal temperature (25±3C.°) and at the magnification M satisfying the expression (2):
−0.003≦M≦0.003 (2),
0.02<|CM5|<0.05 (8).

12. The objective lens of claim 11, wherein a third-order coma CM3 (λrms) which is generated when an oblique light flux whose half angle of view is 1 degree enters the objective lens at the normal temperature (25±3C.°), the cover glass thickness T and the magnification M, satisfies the expression (9):
0≦|CM3|<0.02 (9).

13. The objective lens of claim 6, wherein the objective lens is formed of a plastic material.

14. The objective lens of claim 13, wherein, the cover glass thickness T satisfies the expression (1), where T_{MAX} (mm) is a maximum transparent substrate thickness among the transparent substrate thicknesses:
T_{MAX}×0.85≦T≦T_{MAX}×1.1 (1).

15. The objective lens of claim 14, wherein the cover glass thickness T and the magnification M satisfy the expression (3) and the expression (10):
T_{MAX}×0.85<T≦T_{MAX}×1.0 (3),
M=0 (10).

16. The objective lens of claim 6, wherein the objective lens is formed of a glass material.

17. The objective lens of claim 16, wherein the cover glass thickness T satisfies the expression (4), where T_{MAX} (mm) is a maximum transparent substrate thickness among the transparent substrate thicknesses:
T_{MAX}×0.75≦T≦T_{MAX}×1.0 (4).

18. The objective lens of claim 17, wherein the cover glass thickness T and the magnification M satisfy the expression (5) and the expression (10):
T_{MAX}×0.8≦T≦T_{MAX}×0.95 (5),
M=0 (10).

19. The objective lens of claim 1, wherein the objective lens satisfies the expression (11), where OSC_{MAX} (mm) is the positive maximum value of the offence against the sine condition, and f(mm) is a focal length for the wavelength λ1 at the normal temperature (25±3C.°):
0.003<OSC_{MAX}/f<0.022 (11).

20. The objective lens of claim 6,
wherein under a condition that a non-parallel light flux enters the objective lens such that a third-order spherical aberration of a spot converged by the objective lens is corrected at a high temperature (55±3C.°) and at a cover glass thickness which is equal to the maximum transparent substrate thickness T_{MAX}, a third-order coma CM(LT) (λrms) which is generated when the objective lens is tilted and a third-order coma CM (DT) (λrms) which is generated when a cover glass is tilted at the same angle as that of the objective lens for the third-order coma CM(LT) satisfy the expression (12):
0.3≦|CM(LT)/CM(DT)|≦0.8 (12).

21. The objective lens of claim 6
wherein a magnification M1 and a magnification M2 satisfy the expression (13), where the magnification M1 is a magnification under a condition that a non-parallel light flux enters the objective lens such that a third-order spherical aberration of a spot converged by the objective lens is corrected at the normal temperature (25±3C.°) and at a cover glass thickness which is equal to the maximum transparent substrate thickness T_{MAX}, and the magnification M2 is a magnification under a condition that a non-parallel light flux enters the objective lens such that a third-order spherical aberration of a spot converged by the objective lens is corrected at the normal temperature (25±3C.°) and at a cover glass thickness which is equal to a minimum transparent substrate thickness T_{MIN} among the transparent substrate thicknesses:
0≦M1/M2<0.92 (13).

22. The objective lens of claim 6
wherein a refractive index N of the objective lens for the wavelength λ1 at the normal temperature (25±3C.°), and an inclination angle θ (degree) of at a most periphery of an effective aperture of an optical surface facing the light source satisfy the expression (14):
−59.8×N+162<θ<−59.8×N+166 (14).

23. The objective lens of claim 6
wherein the objective lens satisfies the expression (15), where T_{MIN} is a minimum transparent substrate thickness among the transparent substrate thicknesses and T_{MAX} is a maximum transparent substrate thickness among the transparent substrate thicknesses:
0.03 (mm)<T_{MAX}−T_{MIN}<0.06 (mm) (15).

24. The objective lens of claim 6,
wherein the objective lens satisfies the expression (16), where N is a refractive index of the objective lens for the wavelength λ1 at the normal temperature (25±3C.°) and H (mm) is a radius height at which a first-order derivative X′ (h) of a deformation amount of an aspheric surface X(h) of an optical surface facing the optical disc changes from a negative value to a positive value:
−2.8×N+5.1<H<−2.8×N+5.4 (16),
wherein the deformation amount of an aspheric surface X(h) is defined by a distance in a direction of an optical axis from a plane tangent to a top of the optical surface facing the optical disc to the aspheric surface, and is assumed to have a negative value when the aspheric surface deforms from the plane toward the light source and have a positive value when the aspheric surface deforms from the plane toward the optical disc, and
H is a relative value under an assumption that a radius of an effective aperture is defined as 1.

25. An optical pickup device comprising: the objective lens of claim 6 and a coupling lens which is movable in an optical axis direction, wherein any one of information recording surfaces of an optical disc is selected by moving the coupling lens in the optical axis direction.

26. (canceled)

27. (canceled)
